(19) United States
(12) Patent Application Publication
(10) Pub. No.: US 2006/0063624 A1
(43) Pub. Date: Mar. 23, 2006

(54) Transmission systems and methods

(76) Inventor: Darrell Voss, Vancouver, WA (US)

Correspondence Address: Law Office of Jim Zegeer, Suite 108, 801 North Pitt Street, Alexandria, VA, 22314, US

(21) Appl. No.: 11/228,474

(22) Filed: Sep. 19, 2005

Related U.S. Application Data
(60) Provisional application No. 60/610,944, filed on Sep. 20, 2004.
(60) Provisional application No. 60/622,846, filed on Oct. 29, 2004.

(51) Int. Cl. F16H 59/00; F16H 61/00

(52) U.S. Cl. 474/78

(57) ABSTRACT

A transmission includes a pair of conical transmission element carriers with one being a drive carrier and one being a driven carrier. The drive carrier has a plurality of fixed drive elements attached. The driven carrier has a plurality of fixed driven elements attached. An endless connecting element rotationally couples a drive carrier element to a driven carrier element to provide a transmission output ratio. Also, a shift element means transfers the endless connecting element between a selected drive element to a corresponding driven element to establish a change in the rotational ratio between the drive carrier and the driven carrier.

### REFERENCE TO RELATED APPLICATIONS

The present application claims the priority of provisional application No. 60/610,944 filed Sep. 20, 2004 entitled BICYCLE SYSTEMS AND METHOD.

The present application is related to pending application Ser. No. 10/113,931, filed Apr. 2, 2002 entitled VEHICLES AND METHODS USING CENTER OF GRAVITY AND MASS SHIFT CONTROL SYSTEM and to provisional application No. 60/622,846 filed Oct. 29, 2004 entitled METHODS FOR MANUFACTURING A GEAR and RESULTING GEAR PRODUCTS.

The present application is also related to an application filed Sep. 19, 2005 by the same inventor entitled IMPROVED VEHICLE SYSTEMS AND METHOD.

### BACKGROUND OF THE INVENTION

1. Field of the Invention

This invention generally relates to transmission systems and methods. The present invention relates to transmission systems and methods with a particular emphasis on systems involving high efficiency, low frictional loss, and/or torque loads at low revolutions per minute. An example of an application for this system is a bicycle. However, the invention is not limited to vehicles or this vehicle type.

2. Description of the Prior Art

Material transfer systems, power transfer systems, energy generation and storage systems, and vehicle drive systems make use of variable ratio transmission systems. Conventional variable ratio gear transmissions tend to be heavy and have high frictional losses. Transmissions incorporating multiple transmission carriers, an endless coupling loop, and a drive ratio change method have been developed that minimize weight, space, and frictional losses. Prior art transmission designs comprised of two opposing carriers, one acting as a drive and one acting as a driven, coupled together by an endless loop element, such as a chain, are commonly applied in the aforementioned systems.

Prior art transmission systems of this type have compromised transmission load transfer design and coupling methods to meet the demands of high force loads at low rotational speeds. Transmission components with limited contact surface areas have increased difficulty in making changes in the drive ratio under high force loads. Prior art of transmission carriers that are engaged by endless loop coupling elements has focused on carrier gear profile modifications to develop reliable drive ratio change methods. Endless loop coupling elements that are under high loads and operating at low revolutions per minute resist lateral movement and load transfers between transmission carrier diameters. Load stress is transferred through small contact areas because designs of the transmission carriers limit the contact surfaces to allow drive change shifts. In prior art, this reduction of the surface contact area to improve shift methods has resulted in the increased wear of the transmission components.

In prior art sprocket and chain systems, the sprocket has two lateral faces and an outer diameter that is a radiused involute drive tooth profile designed to receive a round drive pin. Basic sprocket chain construction is comprised of eight pieces: 2 outer links, 2 inner links, 2 connecting pins, and 2 round bushings assembled in a repeating pattern to create an endless loop. The inner and outer links are joined in an alternating pattern by pins. The connecting pin and the round bushings keep the pairs of links at the same distance apart along the length of the chain assembly. A round bushing around the outer diameter of the connecting pin is the contact surface to the toothed profile of the sprocket. During sprocket rotation, the tooth of the sprocket pierces the empty space between the round bushings of the chain linkage assembly then a radial side of the sprocket tooth engages with the round bushing outer diameter to transfer loads to and from the chain assembly. The contact surfaces are limited by the width of the sprocket tooth and radial clearances on the tooth form.

Prior art transmission carriers have limitations in the ability of the chain to engage the carrier elements that are at opposite ends of the carrier. Transmission carriers that have the chain aligned across elements at opposite ends of each carrier results in an undesirable angle of the chain centerline in relation to the centerline of the connected elements. This condition is often referred to as the crossover angle. Excessive crossover angles in prior art systems have resulted in high frictional losses and increased component wear. Prior art solutions to decrease the negative effects of crossover angles has been to limit the available drive ratio changes of the system or to require sufficient distances between the transmission carriers to minimize the angle.

Prior art has focused on the transmission as an integral part of either the drive mechanisms or the driven mechanisms. Examples being the internal transmissions located in the rear hubs of vehicles, the external transmissions used in vehicle designs, and the transmissions enclosed in the bottom bracket area of bicycles.

Prior art transmissions that are an integrated part of the driven mechanism such as the internal rear wheel hubs on vehicles are separated from the initial drive force mechanism by connecting elements that must endure many variations in drive force stresses. The application of the transmission within the rear hub creates a separation in location from the initial drive force and limits the flexibility in location of the drive force transfer mechanisms.

Prior art external transmissions currently have a wide separation of the drive and driven elements. The external design results in the requirement for multiple shifting mechanisms and tensioning elements. The location of the prior art external transmissions limits the flexibility of the transmission location and requires limitations in methods and mounting designs to meet the transmission component tolerance limitations required to function properly. Rear wheel hub internal transmissions have a limited scope of ratio range, because the restrictions in diameter and width reduce the available ratios.

Prior art internal transmissions that are an integral part of the bottom bracket of a bicycle have consisted of transmission mechanisms that are large and heavy, are difficult to manufacture, and consist of numerous complex elements. The bottom bracket internal transmissions have created complications in bicycle frame design and limit the flexibility of the transmission location.

Prior art internal transmissions that are an integral part of the rear wheel hub of a vehicle have consisted of transmission mechanisms that are large and bulky, are difficult to manufacture, and consist of numerous complex elements. The rear wheel hub internal transmissions have created complications in vehicle frame design and limit the flexibility of the transmission location. The additional weight of the internal rear wheel hub transmission adversely affects the performance of the vehicle in regards to the rear wheel weight and the overall vehicle balance.

In view of the limitations and shortcomings of the prior art devices, as well as other disadvantages not specifically mentioned above, it should be apparent for the need of an improved transmission method.

It is therefore a primary object of this invention to provide a transmission system that surpasses the limitations and shortcomings of the prior art. Such a transmission system and method is applicable to vehicle and non-vehicle applications where performance is defined by efficient transfer of energy, use of design structure, ease of manufacture, and flexibility of location.

### SUMMARY OF THE INVENTION

Briefly described, these and other objects of the invention are accomplished according to the present invention by providing at least a pair of oppositely oriented drive and driven transmission carriers. The present invention utilizes a set of transmission carriers, preferably conical, with fixably mounted drive/driven elements wherein the carrier's central axis are essentially parallel. The carriers are preferably identical, but this need not be the case. In other words, one carrier can be larger or smaller in diameter than the other and also vary in length. The carriers may consist of an equal or unequal quantity of fixably attached drive and driven elements. Fixably attached drive and driven elements have an outer diameter that has a drivable profile form or shape. Gear, sprocket, serration, square, and v-shape profiles are all examples of driveable forms.

The use of oppositely oriented transmission element carriers allows for a compactable and minimal element design, improved transmission drive ratio shifts, and a reduction of materials and components required for the device.

The invention features a transmission system comprising at least a pair of oppositely oriented drive and driven transmission carriers, each transmission carrier having mounted thereon ratioed drive and driven elements and wherein the carriers' central axes are essentially parallel, an endless drive transfer loop coupling said drive elements on said drive transmission carrier to the driven elements on said driven transmission carrier, a shifter for relatively shifting said endless loop laterally of said transmission carriers so as to provide different drive ratios between said drive elements and said drive elements.

The invention also features a transmission method comprising, providing a pair of oppositely oriented drive and driven transmission carriers, each transmission carrier having mounted thereon ratioed drive and driven elements and wherein the carriers' central axes are essentially parallel, an endless drive transfer chain coupling said drive elements on said drive transmission carrier to the driven elements on said driven transmission carrier, and sequentially shifting said endless loop laterally of said transmission carriers so as to provide different drive ratios between said drive elements and said drive elements such that changes in said transmission ratios are substantially uniform and that there are no gaps in said transmission ratios.

The invention provides for optimized use of materials resulting in material savings and a reduction of the components required for transmission. The transmission carrier may consist of a single piece construction. The carrier may comprise a multiple piece assembly. The fixably mounted elements may comprise a single fixably mounted piece. The fixably mounted elements may comprise a multiple piece assembly. The carrier may also be comprised of a single piece construction without separated fixably mounted elements. The carrier may comprise stepped profiled circumferences without spacing between the stepped circumferences. The carrier stepped profiles may comprise clearances, undercut surfaces, protruding pins, holes through for lightening purposes, as shown in prior art regarding traditional gear and sprocket shapes and shifting aides. A transmission carrier with stepped profiles is considered a stepped gear cluster.

In the case of the transmission carrier with stepped profiles, the endless loop coupling element engages the profiled surface of each step and support from the lateral face of the adjacent step. This carrier design allows for additional novel shifting means to enable drive ratio changes. The optimized construction makes for an improved and efficient transfer of the transmission force loads. A major benefit is the extended contact engagement area on the transmission carriers for the load transfer coupling element. The invention provides for a transmission design which allows the use of a novel endless loop design technology. The preferred embodiment of the transmission system implements the use of a novel chain construction and shape. The chain has an enlarged engagement surface area for transferring the loads through the chain links to the endless loop carriers. The novel chain link design uses a row of endless loop element links that engage on top of the profiled shape, use the side wall of the adjoining element to block path in the larger circumference direction, and use a profile or guide element to transfer path in the smaller circumference or larger circumference directions when a drive ratio change is desired. The endless loop design also allows for savings in part count and narrower profiles.

The invention enables flexibility in transmission drive ratio change methods. Drive ratio shifting methods may be from individual movements of endless loop guide mechanisms, transmission carrier shifts along their central axis, transmission carrier section movements, endless loop support pins, magnetic forces, and combinations of same that will become obvious. An example of a shift method is a shift of a transmission carrier along the carrier's central axis in conjunction with an endless loop control mechanism which enables a drive ratio change sequence. Another shift method is from a control mechanism that engages the endless connecting element in sequential shift steps as the transmission carriers remain stationary along their axis. An additional shift method is through combining a transmission carrier shift along the parallel axis and an integrated shift and tensioning mechanism movement. Another shift embodiment is using a series of movable pins extended through holes in the transmission carrier bodies. The pins shift out from the surface of the profile where the endless loop element engages the carrier and allow the endless loop to transfer to the next smallest diameter circumference. The pins also support the endless loop element during lateral shifts to the adjacent larger circumference. Additional methods of shift methods are available to enable a drive ratio change sequence.

Drive ratio change sequences can be initiated by mechanical means such as direct cable connection to the shift mechanisms or cam actuated mechanisms. Hydraulic and electrical devices may also be used such as solenoid actuated valves, stepper motors, and similar devices. As will be shown herein, the invention's design is not limited to one or two shift methods as prior art designs are.

The invention's compactability and optimized construction allows for increased flexibility of location related to the system or vehicle framework. In specific regards to vehicle applications, the compact size allows for locations within a vehicle frame, externally attached to vehicle frame, and within the components of a vehicle, such as inside an attached vehicle wheel assembly.

Additional benefits and advantages of the present invention will become apparent to those skilled in the art to which the present invention relates from the subsequent description of the preferred embodiment and the appended claims, taken in conjunction with the accompanying drawings.

### BRIEF DESCRIPTION OF THE DRAWINGS

The above and other objects, advantages, and features of the invention will become more apparent when considered with the following specification and accompanying drawings within:

FIG. 1 is an isometric view of a pair of oppositely oriented, conical transmission carriers in a parallel position,

FIG. 2-A is an isometric view of a stepped gear cluster,

FIG. 2-B is an isometric view of a pair of stepped gear clusters in an oppositely oriented parallel position

FIG. 3 is an isometric view of conical transmission carriers in a parallel position with a connecting endless element,

FIG. 4-A is an end section view of a stepped gear cluster,

FIG. 4-B is an end section view of a narrow stepped gear cluster,

FIG. 4-C is an end section view of a conical transmission carrier,

FIG. 5 is a top view cutaway of a stepped gear cluster and a conical transmission carrier in a parallel position,

FIG. 6-A is a side elevation view of transmission large drive element to small driven element with shift mechanism elements,

FIG. 6-B is a side elevation view of transmission small drive element to large drive element with shift mechanism elements,

FIG. 7-A is a side elevation view of transmission carriers in a parallel position with a single connecting loop,

FIG. 7-B is a side elevation view of transmission carriers connected by an endless connecting belt element and shift mechanism,

FIG. 8-A is a side elevation view of large drive element connected by an endless loop to a small driven element,

FIG. 8-B is a side elevation view of a small drive element connected by an endless loop to a large driven element,

FIG. 9-A is an isometric view of transmission large drive element to small driven element with shift mechanism elements,

FIG. 9-B is an isometric view of transmission small drive element to large driven element with shift mechanism elements,

FIG. 10-A is a side elevation view of transmission large drive element to small driven element with shift mechanism elements,

FIG. 10-B is a side elevation view of transmission small drive element to large drive element with shift mechanism elements,

FIG. 11-A is a side elevation view of a stepped gear cluster with drive profiles formed to drive endless loop connecting pins,

FIG. 11-B is a top view of the stepped gear cluster of FIG. 11-A and the drive pin interface,

FIG. 12-A is a side elevation view of a stepped gear cluster with a moveable portion and cam device,

FIG. 12-B is an end cutaway view of the stepped gear cluster of FIG. 12-A,

FIG.13-A is a side elevation view of a stepped gear cluster with a moveable section,

FIG. 13-B is a side elevation view of the stepped gear cluster of FIG. 13-A with the section in position,

FIG. 14-A is an isometric view of an endless loop configuration,

FIG. 14-B is an isometric view of an endless loop configuration,

FIG. 14-C is an isometric view of an endless loop configuration,

FIG. 14-D is an isometric view of an endless loop configuration,

FIG. 14-E is an isometric view of an endless loop configuration,

FIG. 14-F is an isometric view of an endless loop configuration,

FIG. 14-G is an isometric view of an endless loop configuration,

FIG. 14-H is an isometric view of an endless loop configuration,

FIG. 14-I is an isometric view of an endless loop configuration,

FIG. 14-J is an isometric view of an endless loop configuration,

FIG. 14-K is an isometric view of an endless loop configuration,

FIG. 14-L is an isometric view of an endless loop configuration,

FIG. 15-A is a side elevation view of ratio change control zones for ratio change methods,

FIG. 15-B is a cross sectional top view of the carriers depicting carrier shift vectors,

FIG. 16-A is a side elevation view of a drive carrier with stepped profiles depicting the up shift of the endless loop between the carrier's stepped profiles,

FIG. 16-B is an isometric view of the drive carrier with stepped profiles of FIG. 16-A depicting the up shift of the endless loop between the carrier's stepped profiles,

FIG. 17-A is a side elevation view of a stepped profile ramping and endless loop down shift on the stepped carrier,

FIG. 17-B is an isometric view of the stepped carrier of FIG. 17-A and the endless loop down shift from the outermost profile to the next smaller circumference,

FIG. 18-A is a top view cutaway of conical carriers at start of drive ratio change sequence,

FIG. 18-B is a top view cutaway of conical carriers and a carrier shift sequence,

FIG. 18-C is a top view cutaway of conical carriers, a carrier shift combined with a connecting element shift sequence,

FIG. 19-A is a top view cutaway of conical carriers at beginning of drive ratio change sequence,

FIG. 19-B is a top view cutaway of conical carriers and a carrier shift sequence,

FIG. 19-C is a top view cutaway of conical carriers, a carrier shift combined with a connecting element shift sequence,

FIG. 20-A is a top view cutaway of complementary conical carriers at beginning of a drive ratio change sequence,

FIG. 20-B is a top view cutaway of complementary conical carriers and a connecting element shift sequence initial shift,

FIG. 20-C is a top view cutaway of complementary conical carriers and a connecting element shift sequence finish shift,

FIG. 21 is a cross sectional side elevation view of a stepped gear cluster depicting chain vectors,

FIG. 22 is an isometric view of transmission carriers combined with endless loop guides,

FIG. 23 is an isometric view of a drive ratio change means using shift mechanisms similar to prior art means commonly called “derailleurs”,

FIG. 24-A is a side elevation view of a stepped gear cluster with a series of pins used for the lateral movement an endless loop,

FIG. 24-B is a cutaway view of the carrier shown in FIG. 24-A along the pin line,

FIG. 25-A is a side elevation view of the carrier of FIG. 24-A rotated,

FIG. 25-B is a cutaway view of the carrier shown in FIG. 25-A along the pin line,

FIG. 25-C is a cutaway view of FIG. 25-A along the vertical to show the endless loop position,

FIG. 26-A is a side elevation view of a stepped gear cluster,

FIG. 26-B is a top view of the endless loop path on the carrier of FIG. 26-A,

FIG. 26-C is a cutaway view of FIG. 26-A along the pin pattern,

FIG. 27-A is a side elevation view of a stepped gear cluster,

FIG. 27-B is a top view of the endless loop path on the carrier of FIG. 27-A,

FIG. 27-C is a cutaway view of FIG. 27-A along the pin pattern,

FIG. 28-A is an isometric section view of the moveable portion of the carrier of FIG. 12-A,

FIG. 28-B is an isometric view of the moveable portion of FIG. 12-A shifted laterally to one side,

FIG. 28-C is an isometric view of the moveable portion of FIG. 12-A shifted laterally to the opposite side,

FIG. 29-A is a side elevation view of the stepped gear cluster of FIG. 12-A,

FIG. 29-B is an end cutaway view of the moveable portion shift vectors of the stepped gear cluster of FIG. 12-A,

FIG. 29-C is an end cutaway view of the moveable portion of the stepped gear cluster of FIG. 12-A shifted laterally,

FIG. 29-D is an end cutaway view of the moveable portion of the stepped gear cluster of FIG. 12-A shifted laterally,

FIG. 30-A is an end cutaway view of the moveable portion of the stepped gear cluster of FIG. 12-A shifted laterally combined with an endless loop guide movement,

FIG. 30-B is an end cutaway view of the moveable portion of the stepped gear cluster of FIG. 12-A shifted laterally combined with a stepped gear cluster shift,

FIG. 30-C is an end cutaway view of the moveable portion of the stepped gear cluster of FIG. 12-A shifted laterally combined with an endless loop guide movement and with a stepped gear cluster shift,

FIG. 30-C1 is an end cutaway view of an embodiment of the moveable portion of the stepped gear cluster of FIG. 12-A shifted laterally combined with an endless loop guide movement and with a stepped gear cluster shift,

FIG. 31-A is an end cutaway view of the moveable section of the stepped gear cluster of FIG. 13-A and the moveable section shift vectors,

FIG. 31-B is an end cutaway view of the moveable portion of the stepped gear cluster of FIG. 13-A shifted laterally combined with an endless loop guide movement,

FIG. 31-C is an end cutaway view of the moveable portion of the stepped gear cluster of FIG. 13-A shifted laterally combined with the stepped gear cluster shift,

FIG. 31-C1 is an end cutaway view of an embodiment of the moveable portion of the stepped gear cluster of FIG. 13-A shifted laterally combined with a stepped gear cluster shift,

FIG. 31-D is an end cutaway view of the moveable portion of the stepped gear cluster of FIG. 13-A shifted laterally combined with an endless loop guide movement and with the stepped gear cluster shift,

FIG. 32-A is an isometric view of the stepped gear clusters of FIG. 3 with a cam that enables stepped gear cluster shifts along the central axis of the cluster,

FIG. 32-B is a side elevational view of an embodiment similar to the stepped gear cluster of FIG. 3 wherein the stepped gear cluster has a cam assembly that enables stepped gear cluster shifts along the central axis of the cluster,

FIG. 32-C is a side elevational view of an embodiment similar to the stepped gear cluster of FIG. 3 wherein the stepped gear cluster has a cam assembly that shifts along the central axis of the cluster,

FIG. 33 is an isometric view of a stepped gear cluster with an endless element control device,

FIG. 34-A is a sectional view of the stepped gear cluster of FIG. 33 with the endless element control device vectors,

FIG. 34-B is a sectional view of the stepped gear cluster of FIG. 33 with an endless element control device vector,

FIG. 34-C is a sectional view of the stepped gear cluster of FIG. 33 with an endless element control device vector,

FIG. 35-A is a side elevation view of the stepped gear cluster of FIG. 33 with a rotatable endless element control device,

FIG. 35-B is an end cutaway view of the stepped gear cluster of FIG. 35-A with the rotatable endless element control device in a supportive position,

FIG. 35-C is an end cutaway view of the stepped gear cluster of FIG. 35-A with the rotatable endless element control device in a restrictive position,

FIG. 35-D is an end view of the endless element control device of FIG. 35-A,

FIG. 35-E is an end view of a modification to the profile of the endless element control device of FIG. 35-A,

FIG. 35-F is an end view of a modification to the endless element control device of FIG. 35-A,

FIG. 35-G is an end cutaway view of an embodiment similar to the stepped gear cluster of FIG. 33 with an index controlled rotatable endless element control device,

FIG. 36-A is a side elevation view of the stepped gear cluster of FIG. 33 with an endless element control device moveable along the carrier axis,

FIG. 36-B is an end cutaway view of the stepped gear cluster of FIG. 36-A with the endless element control device moveable vectors,

FIG. 37-A is a side elevation view of the stepped gear cluster of FIG. 33 with an endless element control device moveable perpendicular to the carrier axis,

FIG. 37-B is an end cutaway view of the stepped gear cluster of FIG. 37-A with the endless element control device moveable vectors,

FIG. 38-A is a side elevation view of the stepped gear cluster of FIG. 33 with an endless element control device moveable linear and parallel to the conical taper,

FIG. 38-B is an end cutaway view of the stepped gear cluster of FIG. 38-A with the endless element control device moveable vectors,

FIG. 39-A is an end cutaway view of the stepped gear cluster of FIG. 21 and an endless loop guide system,

FIG. 39-B is an end cutaway view of the stepped gear cluster of FIG. 21 and an endless loop guide shift combined with a carrier shift,

FIG. 39-C is an end cutaway view of the stepped gear cluster of FIG. 21 and an endless loop guide shift combined with a carrier shift,

FIG. 40-A is an end cutaway section view of the stepped gear cluster of FIG. 24-A with pin shift device,

FIG. 40-B is an end cutaway section view of the stepped gear cluster of FIG. 24-A with pin shift device shifted,

FIG. 40-C is an end cutaway view of an embodiment similar to the stepped gear cluster of FIG. 40-A,

FIG. 41-A is an end cutaway section view of the stepped gear cluster of FIG. 40-A with the cam element removed,

FIG. 41-B is an end cutaway section view of the stepped gear cluster of FIG. 41-A with a combination of pin shift device shift and endless loop guide shift,

FIG. 41-C is an end cutaway section view of the stepped gear cluster of FIG. 41-A with a combination of pin shift device shift and stepped gear cluster shift,

FIG. 41-D is an end cutaway section view of the stepped gear cluster of FIG. 41-A with a combination of pin shift device shift, stepped gear cluster, and endless chain guide shift,

FIG. 42 is a block diagram showing varied carrier and chain shift combinations,

FIG. 43 is a block diagram listing of ratio change types and ratio change method means,

FIG. 44 is a block diagram listing of ratio change types and power supply means,

FIG. 45 is a block diagram representative of a carrier shifting sequence using a cam actuator,

FIG. 46 is a block diagram representative of a carrier shifting and section shifting sequence using a cam actuator,

FIG. 47 is a block diagram representation of the shifting sequence of FIG. 46 with a controller,

FIG. 48-A is an end cutaway view of a carrier with a positional sensor,

FIG. 48-B is a side elevational view of a stepped gear cluster with sensor locatable zones,

FIG. 49 is a side elevation view depicting an endless loop held in place on the carrier elements by magnetic force,

FIG. 50-A is a side elevation view of a stepped gear cluster and an endless element segment,

FIG. 50-B is a cross sectional view of the stepped gear cluster of FIG. 50-A and chain contact forms,

FIG. 51-A is a side sectional view of a tooth chamfer,

FIG. 51-B is a side sectional view of a sprocket modification,

FIG. 51-C is a side sectional view of a stepped carrier clearance,

FIG. 51-D is an isometric sectional view of a stepped carrier contact patches,

FIG. 51-E is a side sectional view of a mud clearance and chain clearance,

FIG. 51-F is a side sectional view of a mud clearance and another chain clearance,

FIG. 51-G is a side sectional view of a mud clearance on pin drive gear cluster,

FIG. 51-H is a side sectional view of a shift aide,

FIG. 51-I is an isometric sectional view of a tooth profile modification,

FIG. 51-J is an end cutaway sectional view of a element clearance profile cross section,

FIG. 51-K is an end cutaway sectional view of a element profile cross section,

FIG. 51-L is an end cutaway sectional view of a gear cluster cross section with clearance,

FIG. 52-A is an end cross sectional view of a stepped gear cluster with clearance holes in drive profiles,

FIG. 52-B is a side elevation view cross section of the clearance holes in FIG. 52-A,

FIG. 52-C is a side elevation view cross section of clearance modifications of FIG. 52-B,

FIG. 53-A is an end cross sectional view of a stepped gear cluster with recesses in the gear profile,

FIG. 53-B is a side elevation view cross section of the recesses of FIG. 53-A,

FIG. 54-A is a side elevation view of a carrier with a larger change in profile diameters and a chain path,

FIG. 54-B is a side elevation view of the carrier of FIG. 54-A showing the chain path and tooth modification relief,

FIG. 55-A is a side elevation view of a carrier with a larger change in profile diameters and a chain path,

FIG. 55-B is a side elevation view of the carrier of FIG. 55-A showing the chain path and pins on the side of the carrier element,

FIG. 56 is an exploded view of a structure for a transmission system assembly and showing its component parts (REFERENCE is FIG. 14; from Improvements in Bicycle Systems and Method Provisional Application No. 60/610,944; Inventor: Darrell W. Voss; Filed Sep. 20, 2004),

FIG. 57-A is an exploded view of a structure for a transmission system assembly showing its component parts without a force reduction device included,

FIG. 57-B is an exploded view of the clutch assembly similar to FIG. 57-A,

FIG. 58 is an exploded view of a transmission carrier with a planetary assembly,

FIG. 59-A is a top sectional view of a transmission assembly,

FIG. 59-B is an exploded view of a transmission assembly similar to FIG. 59-A,

FIG. 60 is a top sectional view of a transmission assembly with a planetary assembly,

FIG. 61 is an isometric view depicting a transmission housing assembly with a motor supply, a clutch system, and an output system attached,

FIG. 62 is an isometric view of a representative recumbent bicycle bike frame and a transmission system disclosed herein,

FIG. 63 is a side elevational view of a conventional mountain bike assembly with front shock suspension and a novel transmission system disclosed herein (REFERENCE is FIG. 1; from Improvements in Bicycle Systems and Method Provisional Application No. 60/610,944; Inventor: Darrell W. Voss; Filed Sep. 20, 2004),

FIG. 64 is a side elevational view of a bicycle assembly with four bar linkage rear suspension incorporating the novel transmission system of the present invention (REFERENCE is FIG. 2; from Improvements in Bicycle Systems and Method Provisional Application No. 60/610,944; Inventor: Darrell W. Voss; Filed Sep. 20, 2004),

FIG. 65 is a further embodiment of the invention with the rear suspension and novel transmission system of the present invention applied (REFERENCE is FIG. 3; from Improvements in Bicycle Systems and Method Provisional Application No. 60/610,944; Inventor: Darrell W. Voss; Filed Sep. 20, 2004),

FIG. 66 is a further side elevational view of a bicycle assembly with rear suspension and the novel transmission system of the present invention (REFERENCE is FIG. 4; from Improvements in Bicycle Systems and Method Provisional Application No. 60/610,944; Inventor: Darrell W. Voss; Filed Sep. 20, 2004),

FIG. 67 is a side elevational view of a bicycle assembly with rear suspension incorporating the novel transmission system as disclosed herein (REFERENCE is FIG. 5; from Improvements in Bicycle Systems and Method Provisional Application No. 60/610,944; Inventor: Darrell W. Voss; Filed Sep. 20, 2004),

FIG. 68 is another side elevational view of a bicycle assembly with a further embodiment of the invention incorporating the novel transmission system herein (REFERENCE is FIG. 6; from Improvements in Bicycle Systems and Method Provisional Application No. 60/610,944; Inventor: Darrell W. Voss; Filed Sep. 20, 2004),

FIG. 69 is a side elevational view of a bicycle assembly with an embodiment of the invention incorporating the novel transmission system,

FIG. 70 is a side elevational view of a bicycle assembly with an embodiment of the invention incorporating the novel transmission system,

FIG. 71 is a side elevational view of a bicycle assembly with an embodiment of the invention incorporating the novel transmission system,

FIG. 72 is a side elevational view of a bicycle assembly with an embodiment of the invention incorporating the novel transmission system,

FIG. 73 is a side elevational view of a bicycle assembly with an embodiment of the invention incorporating the novel transmission system,

FIG. 74 is a side elevational view of a bicycle assembly with an embodiment of the invention incorporating the novel transmission system,

FIG. 75 is a side elevational view of a bicycle assembly with an embodiment of the invention incorporating the novel transmission system,

FIG. 76 is a side elevational view of a bicycle assembly with an embodiment of the invention incorporating the novel transmission system,

FIG. 77 is a side elevational view of a bicycle assembly with an embodiment of the invention incorporating the novel transmission system,

FIG. 78 is a side elevational view of a bicycle assembly with an embodiment of the invention incorporating the novel transmission system,

FIG. 79 is a side elevational view of a bicycle assembly with an embodiment of the invention incorporating the novel transmission system,

FIG. 80 is a side elevational view of a bicycle utilizing a drive shaft output with an embodiment of the invention incorporating the novel transmission system,

FIG. 81 is an isometric view of a transmission system similar to FIG. 56 inside a wheel assembly for a vehicle,

FIG. 82 is an isometric view of a transmission system applied to a wind powered energy generator device,

FIG. 83-A is a graphical chart illustrating a set of transmission ratios from ratio changes with drive and driven carriers incorporating sixteen elements each,

FIG. 83-B is a graphical chart illustrating a set of transmission ratios from ratio changes with drive and driven carriers incorporating sixteen elements each,

FIG. 83-C1 is a graphical chart illustrating a drive carrier incorporating two elements and a driven carrier incorporating eleven elements,

FIG. 83-C2 is a graphical chart illustrating an example drive ratio range for the carriers of FIG. 83-C1,

FIG. 83-D is a graphical chart illustrating a drive carrier incorporating two elements and a driven carrier incorporating eleven elements,

FIG. 83-E is a graphical chart illustrating the drive and driven carriers of FIG. 83-D shifted,

FIG. 83-F1 is a graphical chart illustrating a drive and driven carrier shift pattern,

FIG. 83-F2 is a graphical chart illustrating a drive and driven carrier shift pattern,

FIG. 83-G1 is a graphical chart illustrating the a drive and driven carrier shift pattern,

FIG. 83-G2 is a graphical chart illustrating the drive and driven carrier shift pattern,

FIG. 83-H is a graphical chart illustrating the drive ratio differences for a rapid pass over shift on a drive and a driven carrier,

FIG. 83-I is a graphical chart illustrating drive ratio shift patterns for drive and driven carriers,

FIG. 84 is the data chart illustrating changes in length of travel per the transmission ratios of FIG. 83-A and 83-B,

FIG. 85 is a block diagram detailing a ratio change sequence for carrier elements from 1-1 to 1-2 to 2-2,

FIG. 86 is a block diagram detailing a ratio change sequence for carrier elements from 16-16 to 15-16 to 15-15,

FIG. 87 is a block diagram detailing a ratio change sequence for multiple carrier elements from 1-1 to 1-4 to 4-4,

FIG. 88 is a graphical chart illustration of the transmission system incorporating human power and motor power assist,

FIG. 89 is a simplified block diagram of a transmission control system,

FIG. 90 is a block diagram representation of a decision sequence chart,

FIG. 91 is a block diagram representative of a decision tree chart,

FIG. 92 is a block diagram of parameter inputs for a transmission control system,

FIG. 93 is a block diagram of parameter inputs for multiple vehicle devices,

FIG. 94 is a chart for examples of transmission locations on frames and suspension types,

FIG. 95 is a side elevational view of a bicycle with an embodiment of the invention incorporating the novel transmission system shown in FIG. 59,

FIG. 96 is a side elevational view of a bicycle with an embodiment of the invention incorporating the novel transmission system shown in FIG. 59,

FIG. 97 is a side elevational view of a bicycle with an embodiment of the invention incorporating the novel transmission system shown in FIG. 59,

FIG. 98 is a side elevational view of a bicycle with an embodiment of the invention incorporating the novel transmission system shown in FIG. 59,

FIG. 99 is a side elevational view of a moped with an embodiment of the invention incorporating the novel transmission system shown in FIG. 59,

FIG. 100 is a side elevational view of a motorcycle with an embodiment of the invention incorporating the novel transmission system shown in FIG. 59,

FIG. 101 is a side elevational view of a lightweight vehicle with an embodiment of the invention incorporating the novel transmission system shown in FIG. 59,

FIG. 102 is a side elevational view of a three-wheeled vehicle with an embodiment of the invention incorporating the novel transmission system shown in FIG. 59,

FIG. 103 is a perspective view of an air vehicle assembly with an embodiment of the invention incorporating the novel transmission system shown in FIG. 59, and

FIG. 104 is a side elevation view of an elliptical transmission carrier.

### DETAILED DESCRIPTION OF THE PREFERRED EMBODIMENT

Referring now to the drawings for the purpose of illustrating a preferred embodiment of the present invention only, and not for purposes of limiting the same:

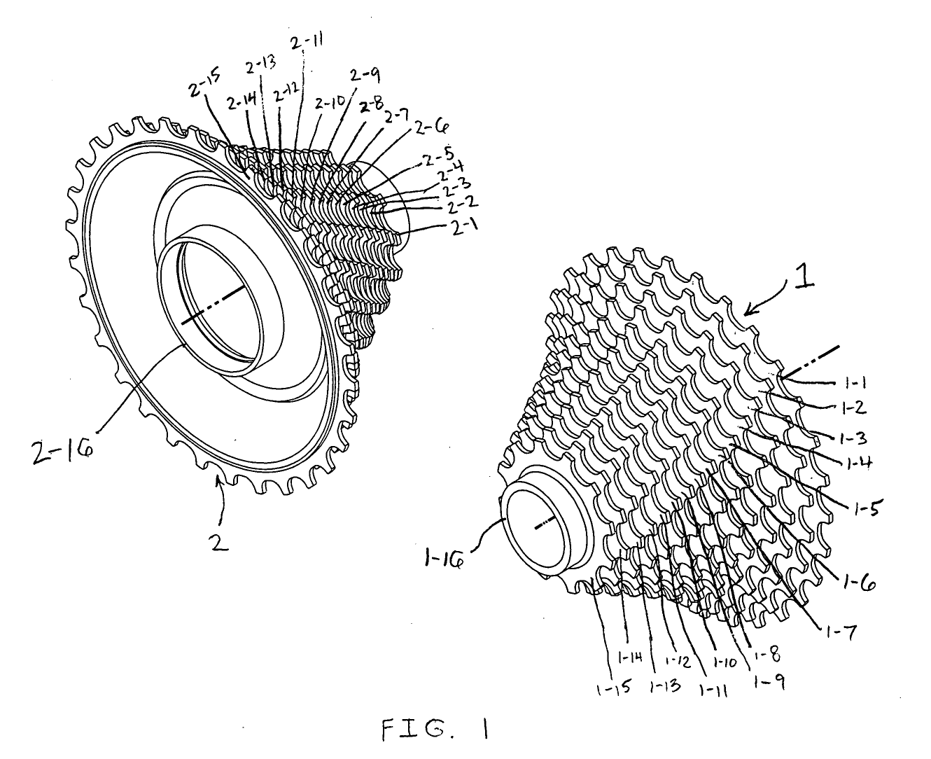

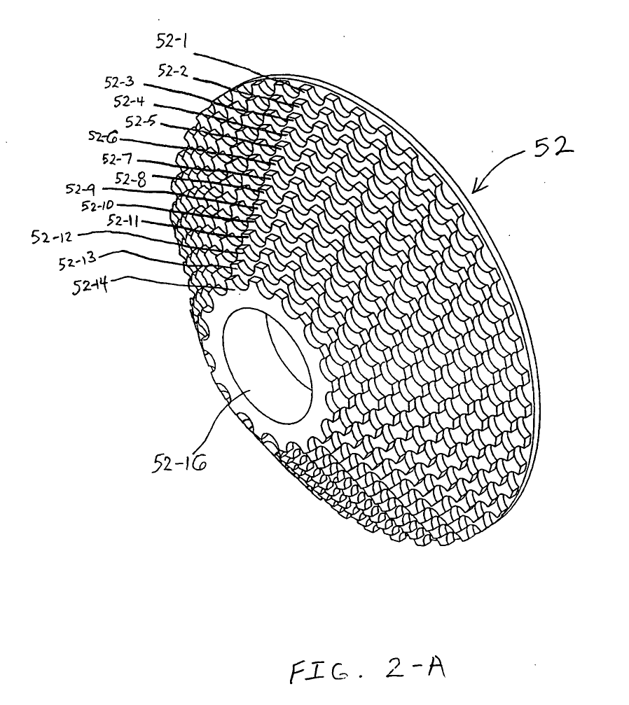

FIG. 1 is an embodiment of a transmission carrier 1 having a plurality of fixed and coaxial ratioed drive elements of decreasing diameters located essentially parallel to a transmission carrier 2 having a plurality of fixed coaxial driven elements of decreasing diameters facing the opposite direction of transmission carrier 1. Transmission drive carrier 1 has fixed drive elements 1-1, 1-2, 1-3, 1-4, 1-5, 1-6, 1-7, 1-8, 1-9, 1-10, 1-11, 1-12, 1-13, 1-14, and 1-15 and each evenly spaced drive element is a smaller diameter in order from fixed drive element 1-1 through 1-15. Transmission drive carrier 1 has an inner diameter hub 1-16 and is fixable to an axle for rotation of the carrier around the carrier's central axis. Transmission carrier 2 has fixed driven elements 2-1, 2-2, 2-3, 2-4, 2-5, 2-6, 2-7, 2-8, 2-9, 2-10, 2-11, 2-12, 2-13, 2-14, and 2-15 and each driven element is a larger diameter in order from fixed drive element 2-1 through 2-15. Transmission driven carrier 2 has an inner diameter hub 2-16 and is fixable to an axle for rotation of the carrier around the carrier's central axis.

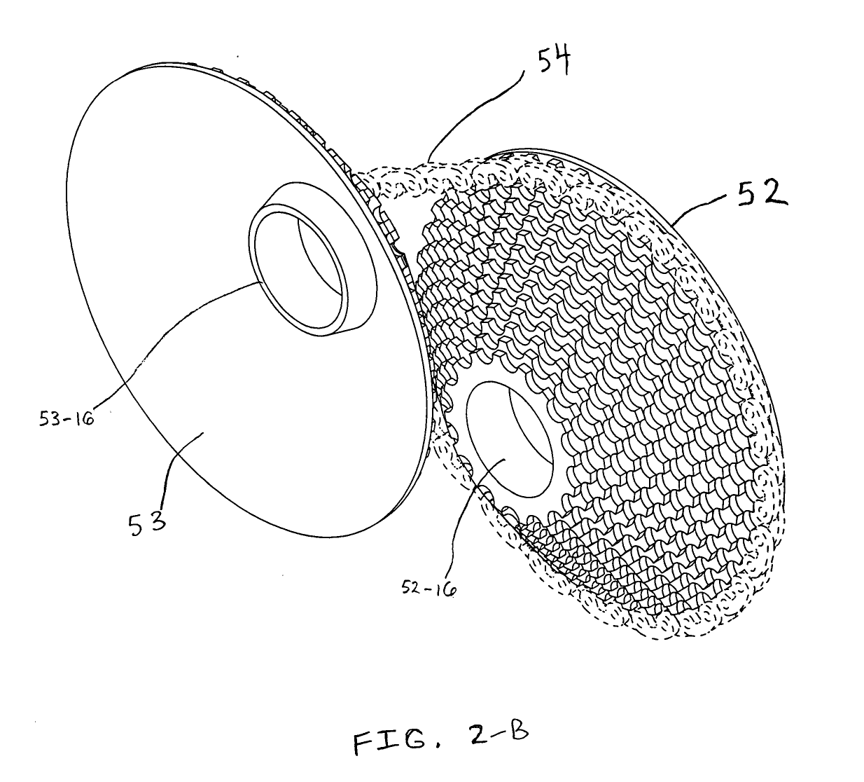

In FIG. 2-A, a transmission drive carrier 52, as shown, is a stepped gear cluster comprising fourteen fixed drive ring elements 51-1, 52-2, 52-3, 52-4, 52-5, 52-6, 52-7, 52-8, 52-9, 52-10, 52-11, 52-12, 52-13, and 52-14. Transmission drive carrier 52 has an inner diameter hub 52-16 and is fixable to an axle for rotation of the carrier around the carrier's central axis. A stepped gear cluster is defined as a gear cluster wherein each of the fixable elements have no spacing between the other fixed drive elements, unlike the spacing between fixable elements as shown in FIG. 1. Typical gear clusters have spacing between the gear toothed elements to allow the endless loop element, such as a chain, to fit around both sides and the outer profile of the fixable element which results in three contact surfaces. The stepped gear cluster fixable elements only require one contact surface which is the outer profile. The fixable elements each have a circumferential profiled shape that is capable of transferring loads to an endless loop element. The circumferential profiled shapes may be made of, but are not limited by, the following forms: gear involute curve, sprocket curve, radiuses, splines, and other shapes that can engage an endless loop element having a matching or similar profile.

In FIG. 2-B, transmission drive carrier 52 is coupled by endless loop element 54 which is representative of an endless series of chain links to transmission drive carrier 53 which is also a stepped gear cluster. Transmission input force in the form of rotational energy is transferred from transmission drive carrier 52 by the coupling of the endless loop element 54 to the transmission driven carrier 53 which provides a transmission drive to driven ratio output. The stepped gear cluster incorporates profiled steps of varying circumferential length aligned along the central axis of the carrier. The profiled steps do not have spaces between the elements. The stepped gear cluster series of profiled steps have increasing or decreasing diameters in an approximately conical shape. The step profile circumferential center points may be offset or concentric to the carrier central axis. The step profiles are circular in form, but may be elliptical to the central axis and vary in their center point relationship to each other. The step profile heights may be irregular or equal in height. The step profiles may have irregular or have matching circumferential patterns. The step profile may include clearanced sections, undercuts, relief cutouts, holes through, chamfers, and notches as detailed in prior art references relating to bicycle sprockets and their shapes. The profiles around the circumference of the step engage the profiles of the endless loop element 54 individual links to transfer the input force of the transmission drive carrier 52 to the transmission driven carrier 53 in an efficient manner.

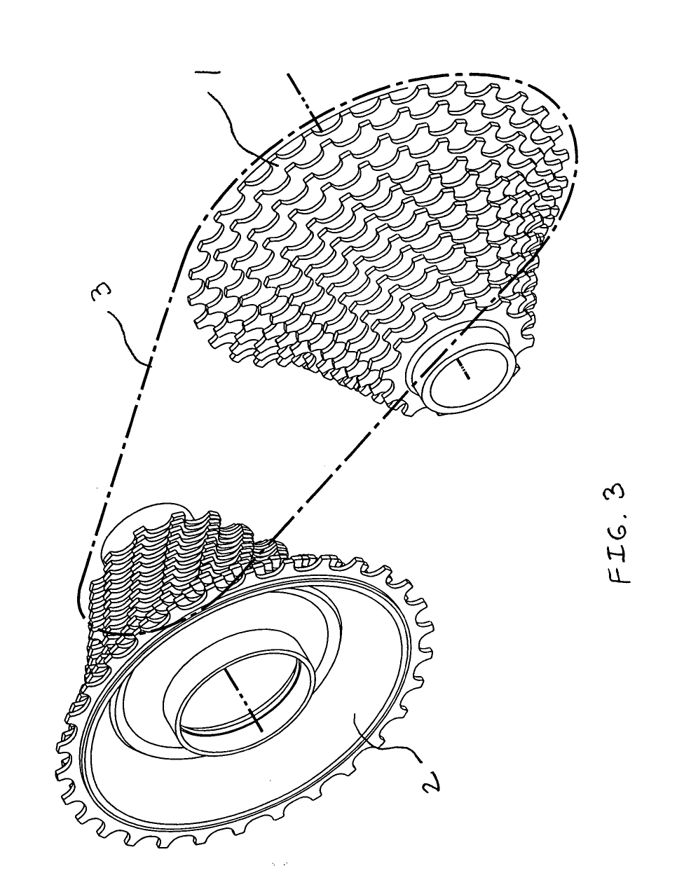

FIG. 3 depicts the transmission carriers of FIG. 1 wherein transmission carrier 1 is coupled by endless chain 3 to transmission carrier 2. Endless chain 3 is representative of an endless series of chain links. Transmission input force in the form of rotational energy transferred from transmission carrier 1 by the coupling of the endless loop element 3 to the transmission carrier 2 provides a transmission drive to driven ratio output.

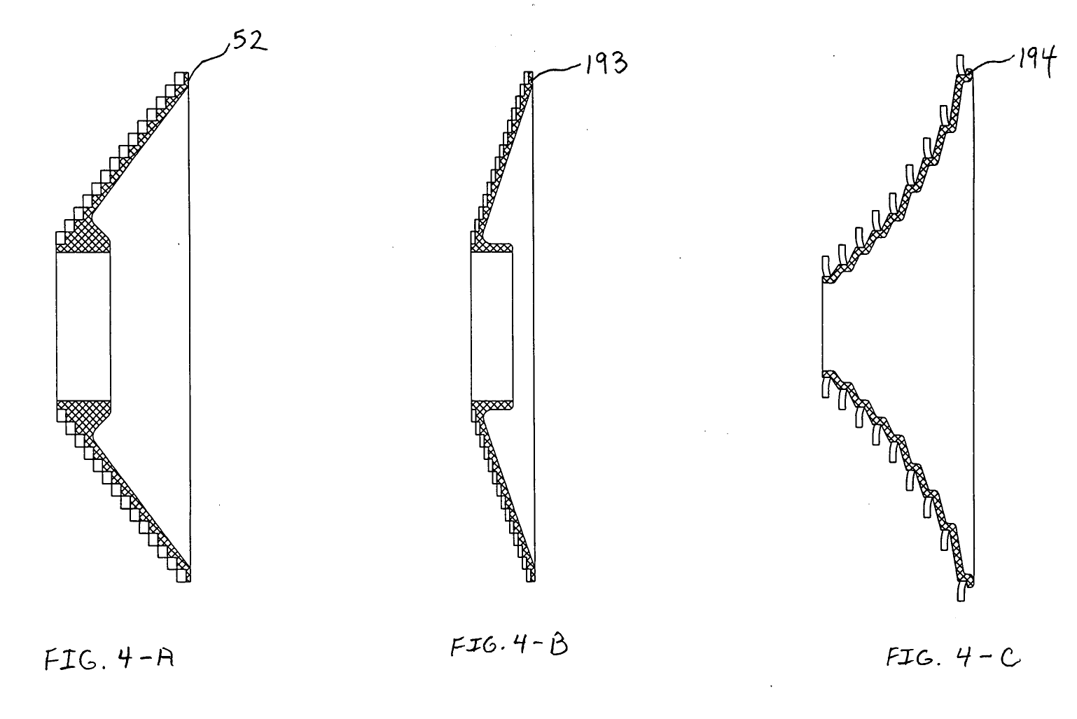

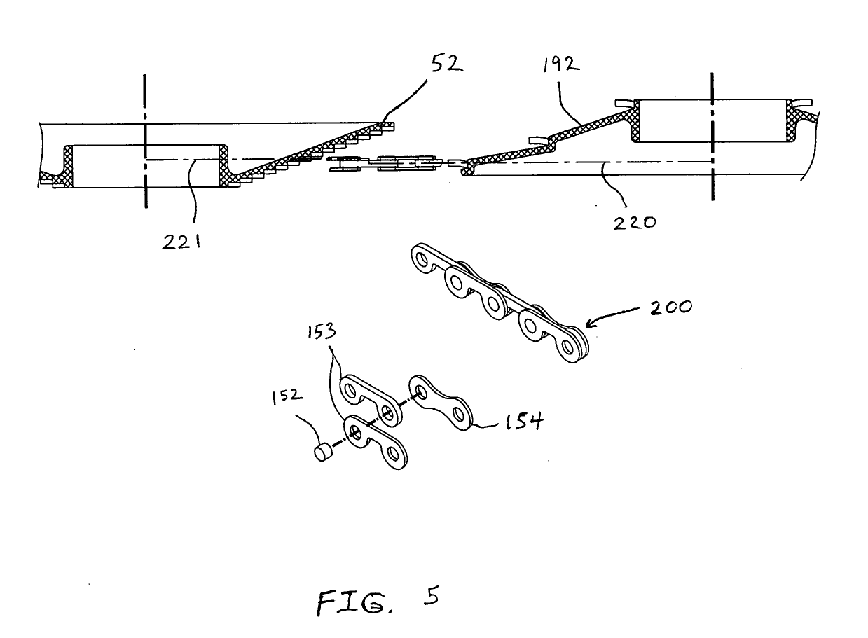

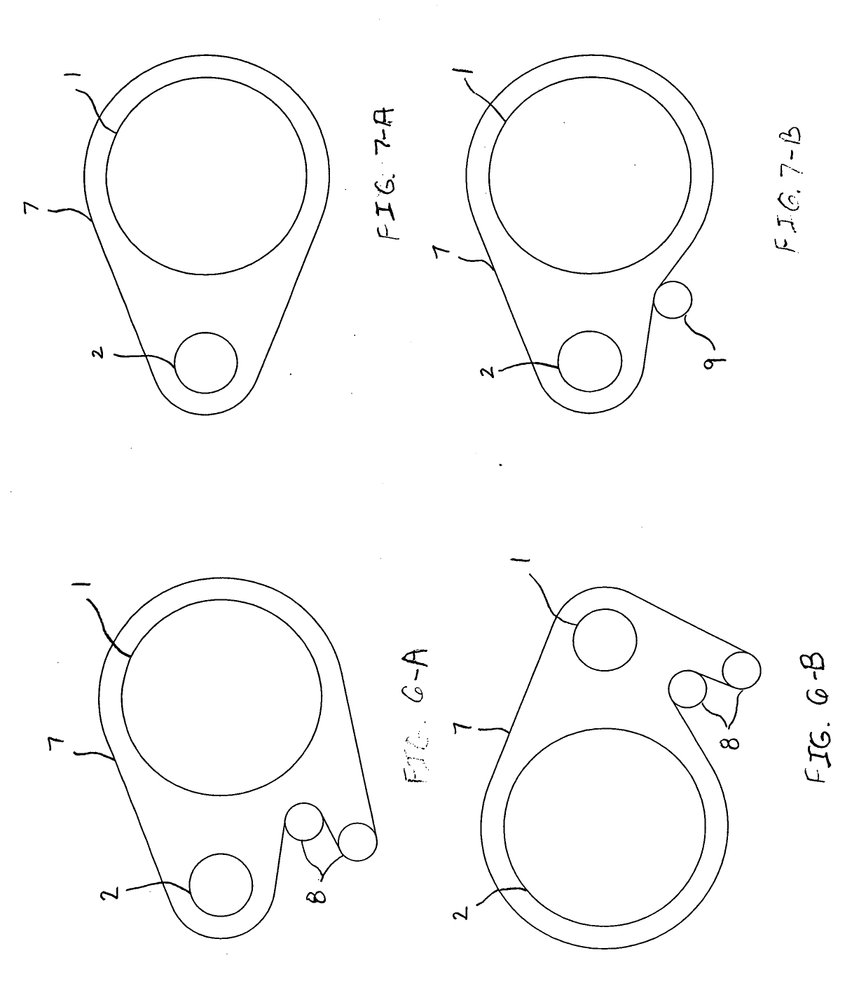

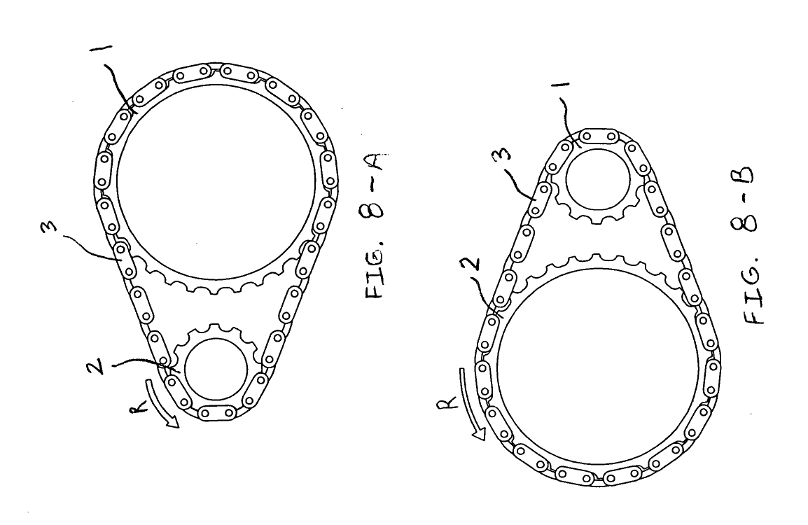

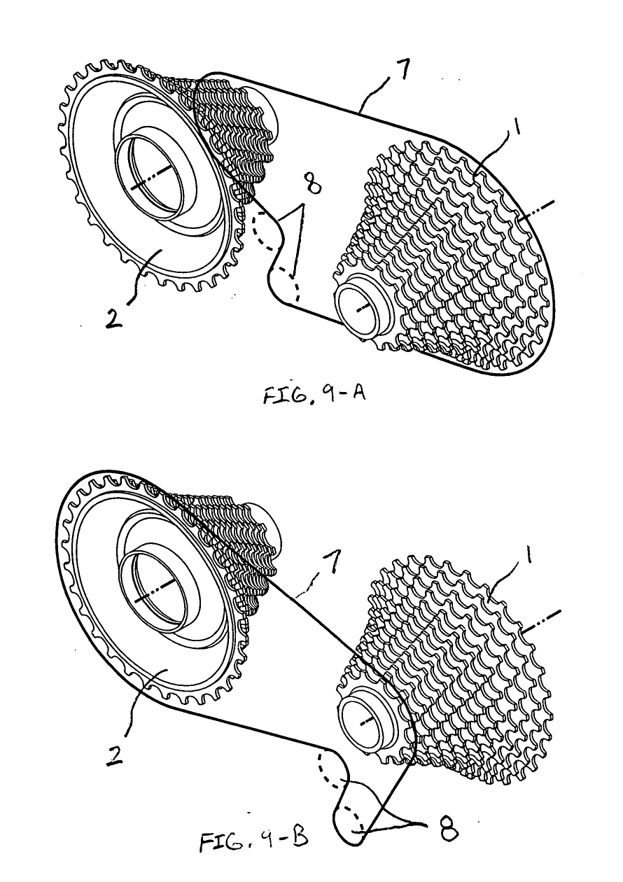

The flexibility of the invention is further shown in the transmission carrier shapes as shown in FIGS. 4-A, 4-B, and 4-C. Transmission carriers may be constructed in different shapes, sizes, diameters. As shown in FIG. 4-A, transmission drive carrier 52 has fourteen stepped profile diameters. FIG. 4-B displays a transmission carrier 193 which is a stepped gear cluster with fourteen stepped profiles and yet is much narrower in width than transmission drive carrier 52. FIG. 4-C displays a transmission carrier 194 with nine fixable elements with spacing between the elements. These transmission carrier shapes show the diversity and versatility of the invention's scope.

The capability of matching dissimilar carrier constructions is shown in FIG. 5. Transmission drive carrier 52 is in combination and parallel with transmission carrier 192 with three fixable elements. A chain configuration using pin 152 to connect two links 153 with a link 154 which has a peanut shaped profile around the receiving holes for the pin 152 is assembled into an endless loop as represented by endless loop section 200. Two links 153 are assembled together with one between the link 154 and the other link 153. One of the link 153's becomes the center link which is engaged by transmission carrier 192 along the link to carrier contact line representation 220. Transmission drive carrier 52 engages link 154 along the link to carrier contact line representation 221. Additional combinations can be arranged with obvious modifications of chain link profiles, stepped gear cluster shapes, and transmission carriers that have fixable elements with spacing.

An endless loop control mechanism is shown in FIGS. 6-A and 6-B.

In FIG. 6-A, the transmission carrier 1 is coupled by the continuous loop 7 with transmission carrier 2 with an endless control element guide 8 engaged with the continuous loop 7 as a tensioning element and pulley system. A larger diameter of carrier 1 is coupled to a smaller diameter element of carrier 2.

FIG. 6-B is a side elevation view of the same carriers of FIG. 6-A with endless control element guide 8 engaged with the continuous loop 7 as a tensioning element and pulley system engaging the smaller diameter of carrier 1 and a larger diameter element of carrier 2. The endless control element guide 8 is movable along an axis approximately parallel to the carrier conical shape to maintain the continuous loop 7 tension.

Another endless loop control mechanism is depicted in FIGS. 7-A and 7-B.

In FIG. 7-A, the transmission carrier 1 is coupled by the continuous loop 7 with transmission carrier 2.

FIG. 7-B is a side view of the same carriers of FIG. 7-A with an endless control element guide 9 engaged with the continuous loop 7 as a tensioning element.

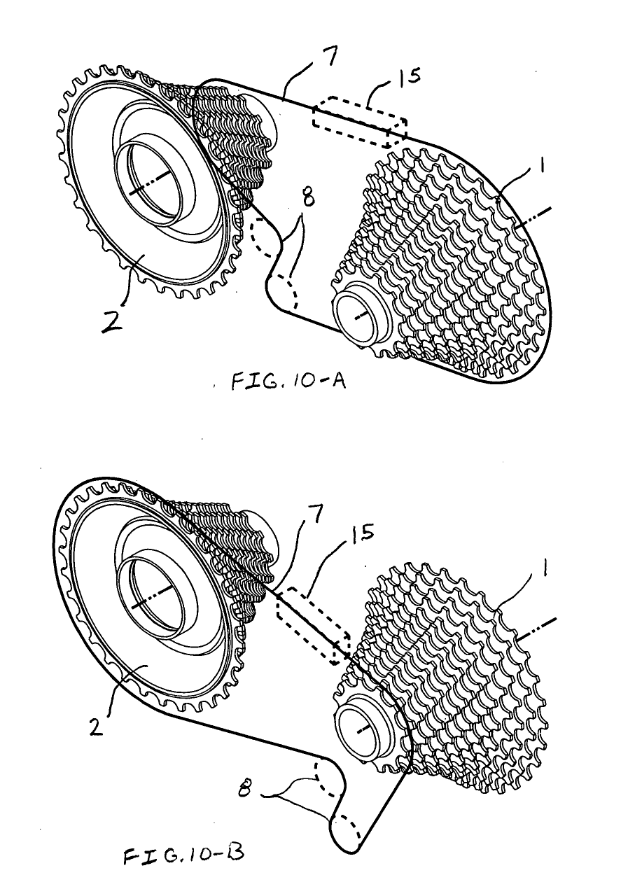

FIGS. 8-A and 8-B depict an endless chain 3 connecting the transmission carriers 1 and 2 of FIG. 1.

In FIG. 8-A, the largest drive element of transmission carrier 1 is coupled through the endless chain 3 to the smallest driven element of transmission carrier 2 to provide the highest driven output ratio.

In FIG. 8-B, the smallest drive element of transmission carrier 1 is coupled through the endless chain 3 to the largest driven element of transmission carrier 2 to provide the lowest driven output ratio.

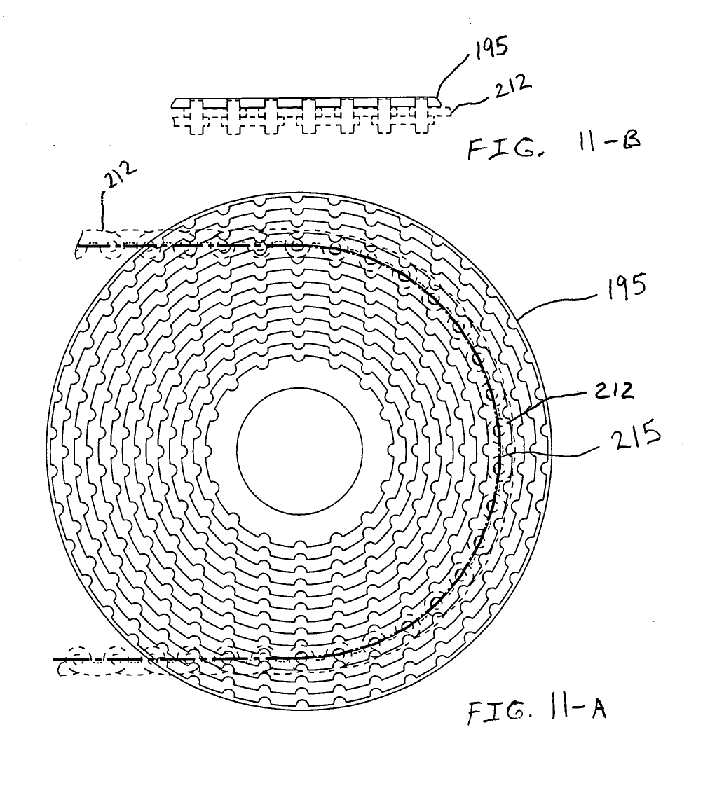

The invention's flexibility in the use of shift mechanisms is shown in FIGS. 9-A, 9-B, 10-A, and 10-B.

In FIGS. 9-A and 9-B, the transmission carrier 1 and transmission carrier 2 of FIG. 1 have a connecting continuous loop 7 and endless control element guide 8.

FIG. 9-A depicts the largest diameter drive element of transmission carrier 1 connecting through the continuous loop 7 to the smallest diameter driven element of transmission carrier 2 and the endless control element guide 8 position.

FIG. 9-B depicts the smallest diameter drive element of transmission carrier 1 connecting through the continuous loop 7 to the largest diameter drive element of transmission carrier 2 and a shifted position of the endless control element guide 8.

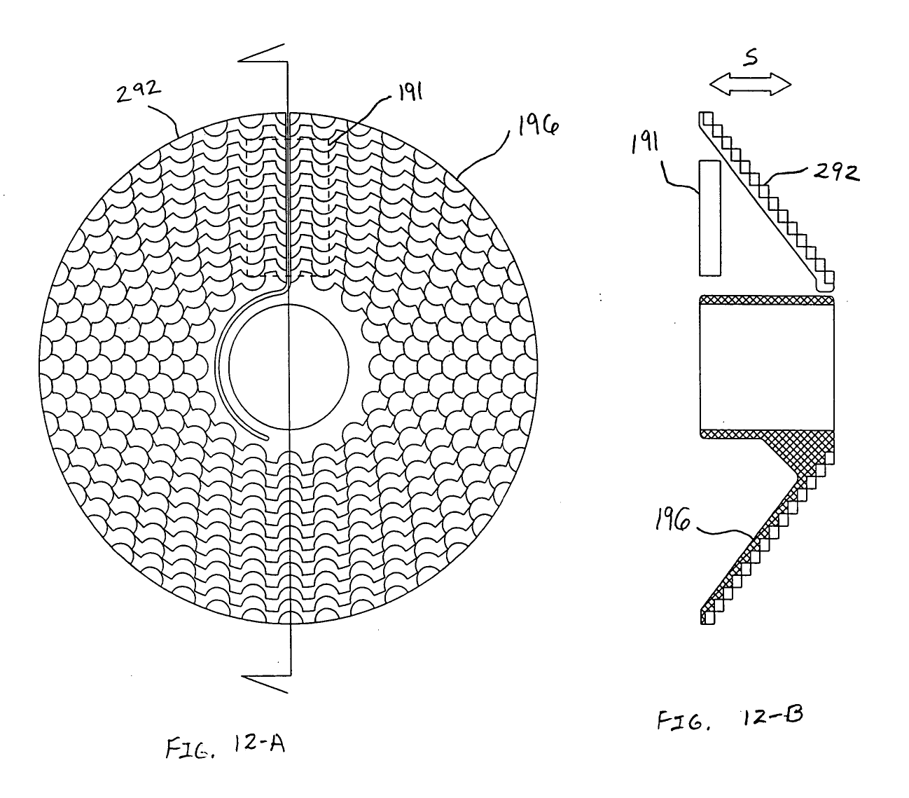

FIG. 10-A depicts the largest diameter drive element of transmission carrier 1 connecting through the continuous loop 7 to the smallest diameter driven element of transmission carrier 2 and the shift mechanism 15 and endless control element guide 8 positions.

FIG. 10-B depicts the smallest diameter drive element of transmission carrier 1 connecting through the continuous loop 7 to the largest diameter drive element of transmission carrier 2 and the adjusted positions of the shift mechanism 15 and endless control element guide 8.

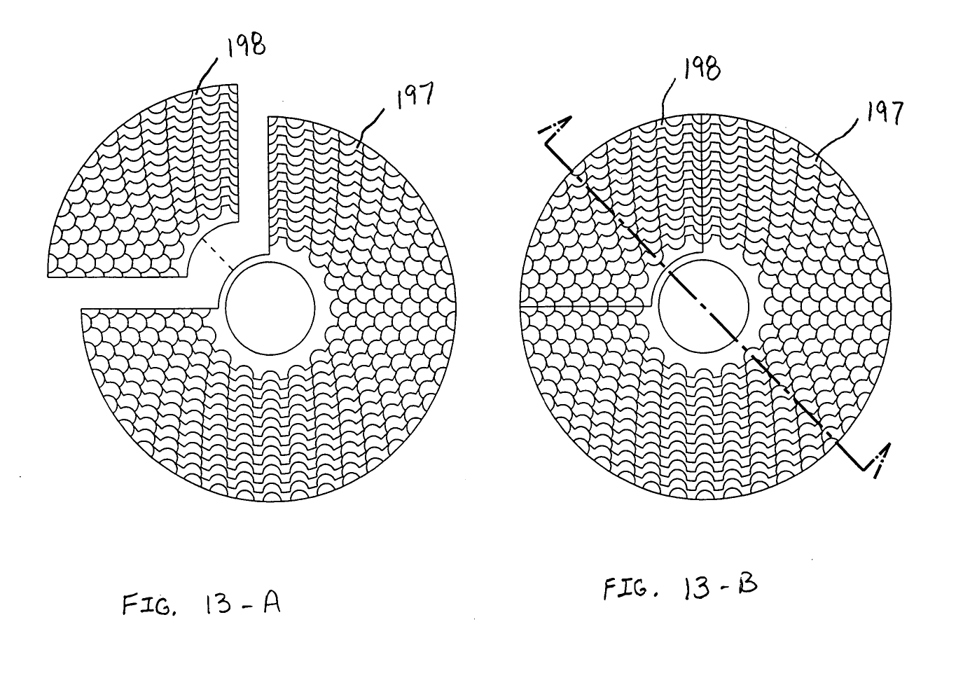

FIG. 11-A and FIG. 11-B depict another transmission carrier embodiment of a stepped gear cluster. The gear profiles are modified to accept the pin diameter of the endless loop configurations as shown in FIGS. 14-J, K, and L.

In FIG. 11-A, the endless loop 212 is engaged on the profiled surface of stepped gear cluster 195 which has stepped profiles with the matching shape and pitch of the endless loop 212 configuration. The chain representation 215 shows the length of engagement of endless loop 212 along the stepped gear cluster 195 profile. The length of engagement of the endless loop to the stepped gear cluster profile provide a high efficiency transfer of the input load. The high load frictional loss common in transmission systems with point loading of gear teeth profiles is lowered by transferring through an extended contact area along the stepped gear cluster profile.

FIG. 11-B shows the profile of engagement of the side of the endless loop 212 with the stepped gear cluster 195.

Additional embodiments of the stepped gear cluster design are also possible.

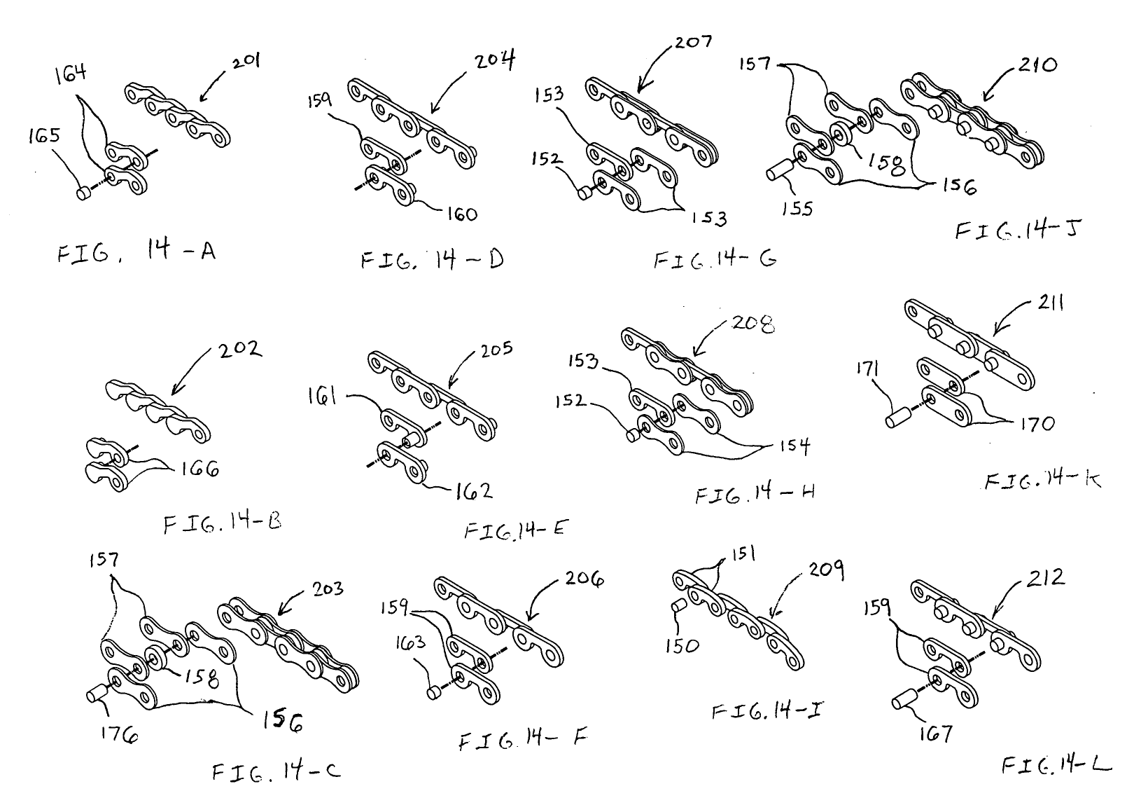

In FIG. 12-A, a modified form of a stepped gear cluster is introduced. Stepped gear cluster 196 has a moveable portion 292. Moveable portion 292 is created by slitting the stepped gear cluster 196 in a form to allow flexible movement of moveable portion 292. Cam actuator 191 moves the moveable portion 292. The stepped gear cluster 196 with a moveable portion 292 is constructed from material that allows lateral flex through the width while providing structural support in the radial direction from the axis center. Supporting structural material may be inserted into the slotted section of the stepped gear cluster to assist in supporting the radial load while still allowing lateral movements of the movable section.

In FIG. 12-B, the moveable portion 292 has a movement vector S and is controlled along the vector by the cam actuator 191. Cam actuator 191 may be controlled by a mechanical method such as a manual cable pull with spring return, by a hydraulic method such as a manually switched hydraulic actuator, or by an electrical method such as an electronically controlled solenoid actuator.

In FIG. 13-A, a stepped gear cluster 197 has a moveable section 198. The moveable section 198 is shown in place as one unit with stepped gear cluster 197 in FIG. 13-B.

FIGS. 14-A through 14-I are depictions of chain link configurations that are have varied engagement profiles and assembly construction. FIGS. 14-J through 14-L are chain link configurations applicable for the function of the transmission carrier type described in FIG. 11-A herein. The chain link configurations enable a reduction in component parts and weight in comparison to prior art configurations. Chain width is greatly reduced allowing for narrower stepped gear cluster profiles with no spacing and narrower spacing on a transmission carrier with fixable spaced elements. Chain link assembly methods are covered in prior art and the chain link configurations herein are not restricted to a specific method.

In FIG. 14-A, link connecting pin 165 joins two units of link 164 into a double link combination to form an endless loop represented by section 201. An endless loop configuration using only two elements is shown in FIG. 14-B. A link connecting pin is not required as each link 166 has an extended spud and a matching spud receiving hole. The advantage of this design is the reduction of part shapes required. Two links 166 are combined to form an endless loop section 202 as shown.

In FIG. 14-C, an assembly similar to a typical bicycle chain assembly is shown, whereby link connecting pin 176 joins outer links 156, inner links 157, and roller bushing 158 together in an alternating alignment pattern as shown to form endless loop section 203.

In FIG. 14-D, another embodiment of a two part design is shown. Link 159 with two receiving holes accepts the protruding spuds of link 160 in an alternating pattern to form an endless loop section 204.

Another embodiment using only two elements is shown in FIG. 14-E. Link 161 and link 162 each have one protruding spud and one receiving hole in opposite orientations to each other. This allows the two links to be combined in an alternating pattern to form an endless loop section 205.

In FIG. 14-F, two units of link 159 are combined using link connecting pin 163. Three pieces are used to form the endless loop section 206 and since the links are identical the reduction of part type count reduces manufacturing costs.

Another embodiment of the endless loop using a single link shape is shown in FIG. 14-G. Three units of link 153 have two receiving holes each and are connected with link connecting pin 152 to form an endless loop section 208. The link 153 is shaped to match drive profiles and pitch of a transmission carrier tooth profile. The link 153 shape has clearances underneath to aid in shifting between gear profile diameters.

In FIG. 14-H, the shape of link 154 shown is similar to that used in FIG. 14-C. Link 153 is sandwiched between two link 154's in an alternating pattern and connected together by link connecting pin 142 to form endless loop section 208.

In FIGS. 14-I through 14-L, the endless loop designs have a common feature. The connecting pin extends beyond the width of the links and is the extended section of the link pin is useable as a drive engagement surface. The connecting pins are shown as extending an equal distance beyond each endless loop section width, but the design of these configurations may also have the pins extend beyond only one side or the other to match with dissimilar transmission gear profiles. An endless loop section 209 is formed using link connecting pin 150 and two units of link 151 in an alternating pattern. The top profile of link 151 is curved upward to increase the cross section of the link which increases the load carrying capacity.

In FIG. 14-J, the endless loop section 210 has a similar construction to endless loop section 203 of FIG. 14-C. The major difference is the link connecting pin 155 extends beyond the outer faces of links 156 an equal distance. This enables an endless loop assembled in this manner to allow the pins to be used as engageable drive surfaces.

FIG. 14-K shows a similar endless link embodiment as FIG. 14-I, wherein link connecting pin 171 joins two units of link 170 in a repeating pattern to form endless loop section 211.

In FIG. 14-L, the connecting pin 167 inserts into one end hole of a link 159 and the opposite end hole of another link 159 to form endless loop 212. The connecting pin 167 extends past the outer faces of each link 159 an equal distance to be useable as an engageable load transfer surface.

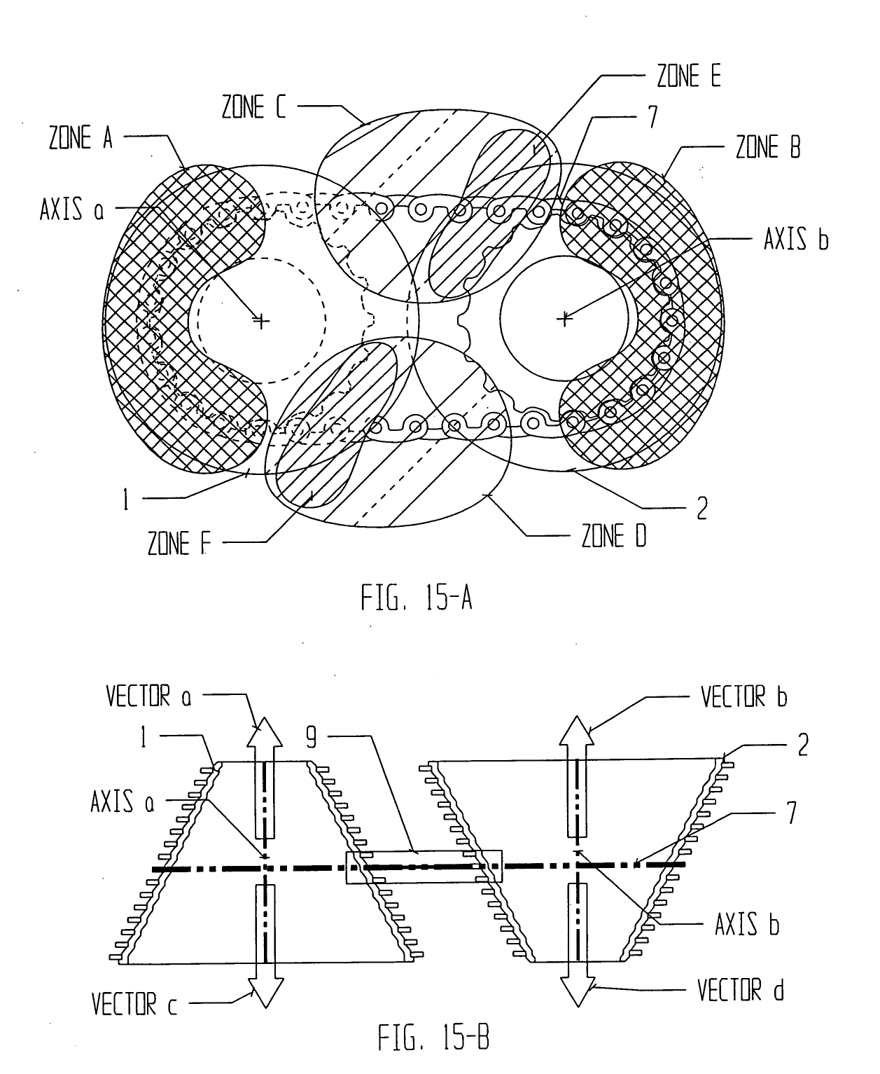

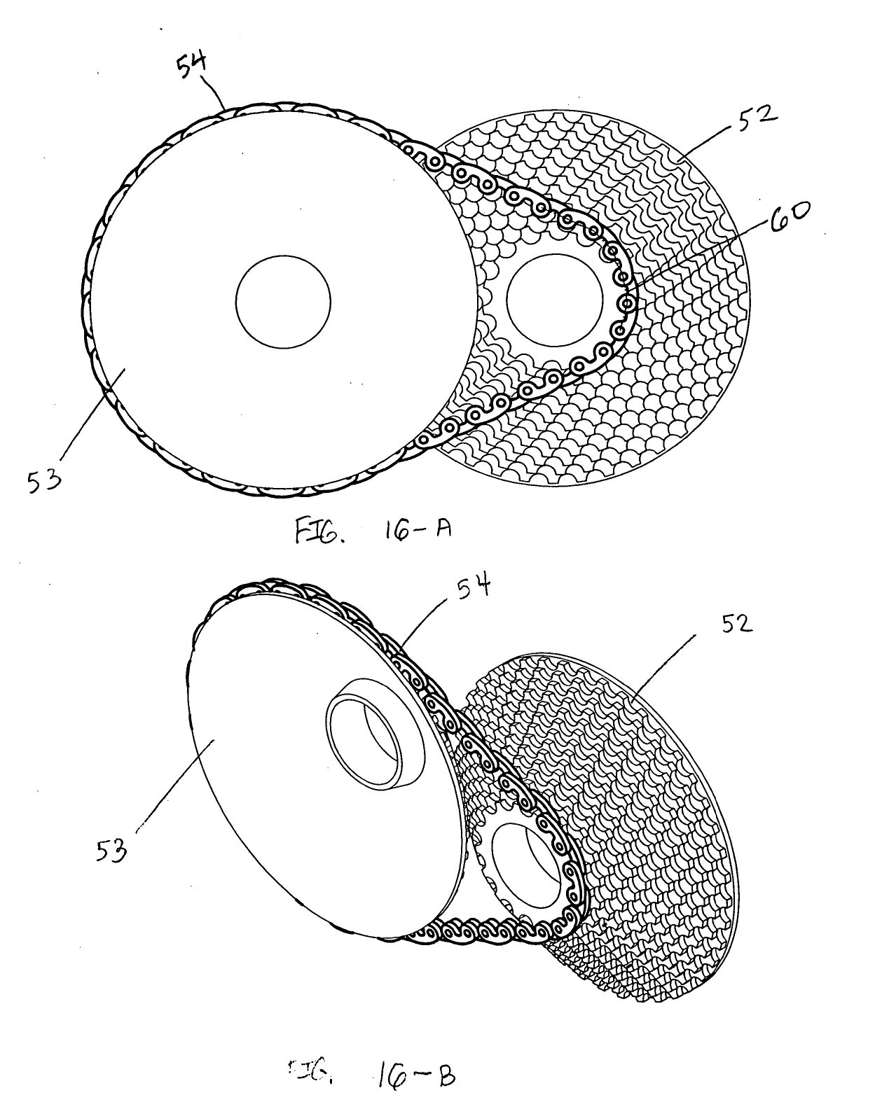

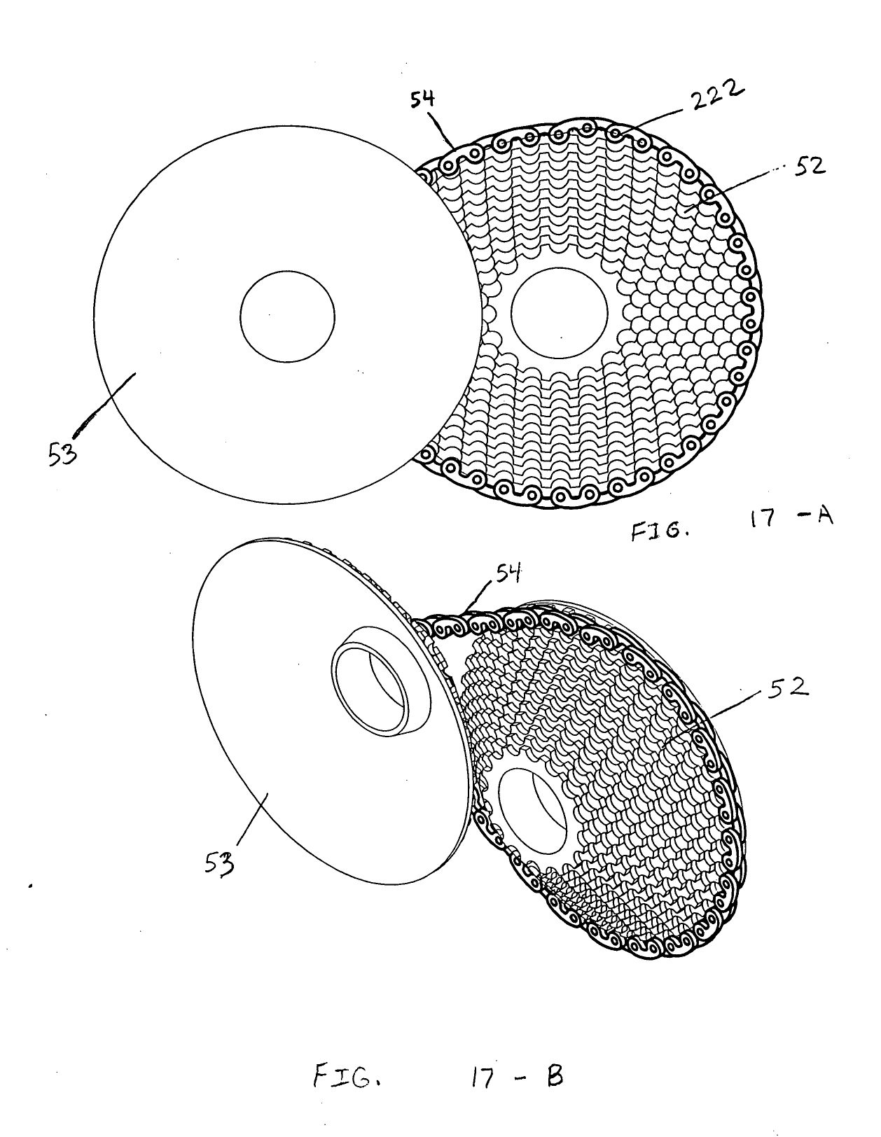

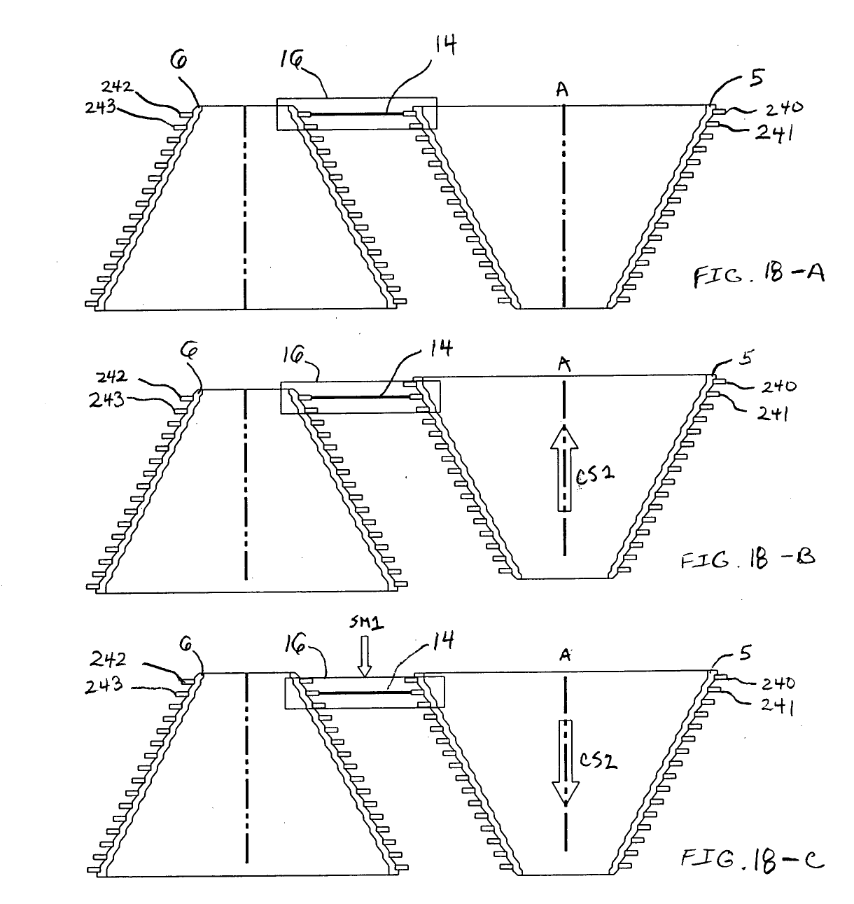

In FIG. 15-A, the transmission drive and driven carriers have ratio change control zones. Control zone A and control zone B are control areas where the endless loop element 7 is contacting the transmission drive carrier 1 and transmission driven carrier 2 respectively. The control zone C and control zone D are control regions where the endless loop element 7 is not in contact with transmission drive carrier 1 or transmission driven carrier 2 elements. Control zone E and control zone F are the specific control regions where the endless loop element 7 is guided onto elements of the transmission drive carrier 1 and transmission driven carrier 2.

In FIG. 15-B, transmission drive carriers 1 and transmission driven carrier 2 have axial shift vectors. Vectors ‘a’ and ‘c’ are directional vectors along transmission drive carrier 1 central Axis ‘a’. Vectors ‘b’ and ‘d’ are the directional vectors along transmission driven carrier 2 central Axis ‘b’. The combined coordinated movements of one or both transmission carriers along vectors ‘a’, ‘b’, ‘c’, or ‘d’ and guide element 9 control the alignment of endless loop element 7.

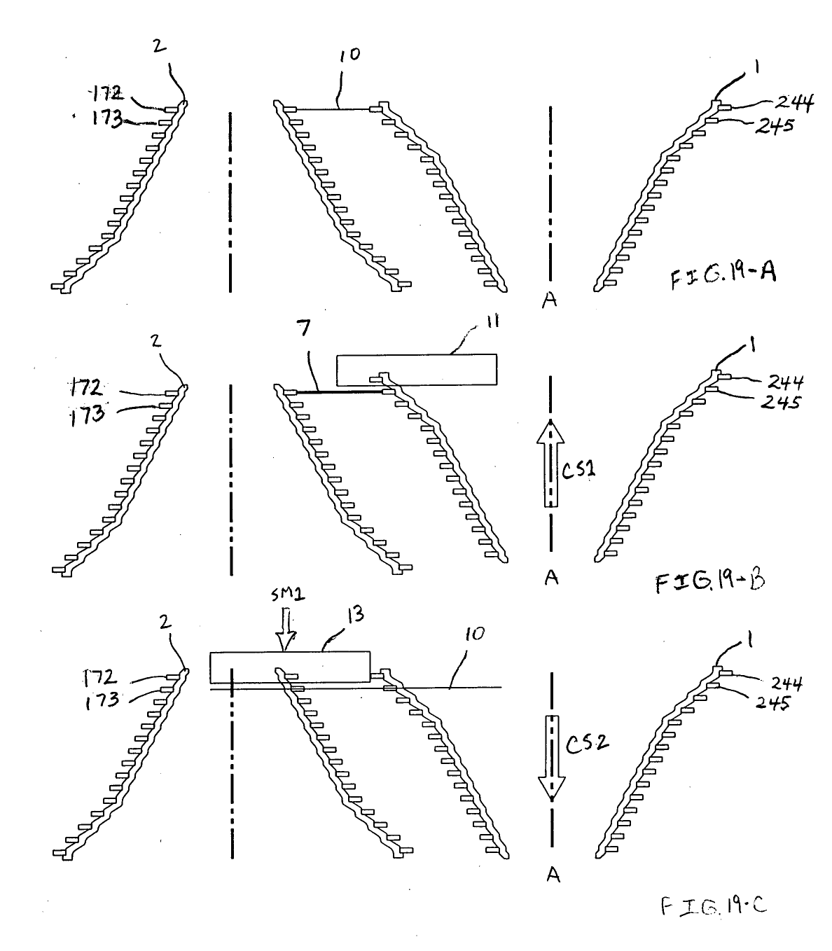

FIG. 16-A depicts a movement of the endless loop element 54 between two stepped profiles of drive carrier 52. Dotted line 60 represents the path of the endless loop element 54 around the profiles of drive carrier 52. The endless loop element 54 is able to transfer from the smallest diameter profile step to the next largest diameter profile step because the profiled patterns are lined up to match the pitch and profiles of the links of the endless loop element 54.

FIG. 16-B is depicting the same transfer of the endless loop element 54 between the stepped profiles of drive carrier 52.

FIG. 17-A depicts the transfer of the endless loop element 54 from the largest diameter stepped profile of drive carrier 52 to the next smallest diameter step profile. The transfer between diameters is enhanced by the matching of the endless loop element link profiles and pitch. The transfer of endless loop element 54 between elements on drive carrier 52 is also shown in FIG. 17-B.

FIGS. 18-A, 18-B, and 18-C depict an embodiment of a drive ratio change method whereby the transmission carrier 5 of FIG. 1 is moved along axis ‘A’ to initiate shift sequences in combination with an endless loop guide mechanism 16.

FIG. 18-A depicts the parallel positioning of the transmission carrier 5 and transmission carrier 6 and line section 14 representing the projected path of the endless chain 3 of FIG. 8-A located inside guide mechanism 16. The endless chain 3 is rotatably coupling the largest diameter of drive carrier 5 which is drive element 240 to the smallest diameter of driven carrier 6 which is driven element 242 and provides the largest drive ratio.

FIG. 18-B shows a drive carrier shift CS1 of transmission carrier 1 along axis ‘A’. As the carrier shift is initiated, the endless chain 3 represented by line section 14 is laterally displaced by guide mechanism 16 and the endless chain 3 is thereby transferred to drive element 241 of transmission carrier 5 while still aligned with the driven element 242 of transmission carrier 6. This new position results in a reduction of the initial transmission drive ratio.

In FIG. 18-C, the transmission carrier 5 has a drive carrier shift along vector CS2 of axis ‘A’ to the original carrier position of FIG. 18-A. As guide mechanism 16 laterally moves along vector SM1 the endless chain 3 is guided and transferred from driven element 242 to the driven element 243 of transmission carrier 6. This results in another reduction in the transmission drive ratio. Thirty one separate drive ratios are available from this shifting method for the transmission carriers depicted each with sixteen fixable elements. A longer carrier shift CS1 movement along the ‘A’ axis combined with a coordinated movement of the guide mechanism 16 is conceivable and would allow the endless chain 3 to transfer between more than one set of adjoining drive or driven elements.

The FIGS. 19-A, 19-B, 19-C depict an embodiment of a transmission ratio shift method whereby the transmission carrier 1 is moved along axis ‘A’ in conjunction with a pair of endless loop shift mechanisms to initiate a shift sequence.

FIG. 19-A depicts the essentially parallel positioning of the transmission carrier 1 and transmission carrier 2 and a line section 10 representing the projected path of the continuous loop 7 of FIG. 5-A. Line section 10 shows the alignment of the largest diameter of drive carrier 1 which is fixable element 244 and the smallest diameter of driven carrier 2 which is fixable element 172.

FIG. 19-B shows a carrier shift CS1 movement of the transmission carrier 1 along axis ‘A’ while the shift mechanism 11 laterally restrains the continuous loop 7 which is thereby transferred to the drive element 245 of transmission 1 while still coupled with the driven element 172 of transmission carrier 2. This shift sequence has resulted in a reduced drive ratio output.

In FIG. 19-C, the transmission carrier 1 is shifted back along ‘A’ to the initial carrier position of FIG. 19-A as the shift mechanism 13 moves along vector SM1 and engages the side of continuous loop 7 to move the loop from the driven element 172 to the driven element 173 of transmission carrier 2. The line section 10 now shows the new coupling of the drive element 245 and driven element 173 resulting in a further reduction of the original drive ratio output. The drive ratios available by continuing the process from one end of the carriers to the other would yield 29 separate ratio changes for the transmission carriers depicted each with fifteen fixable elements.

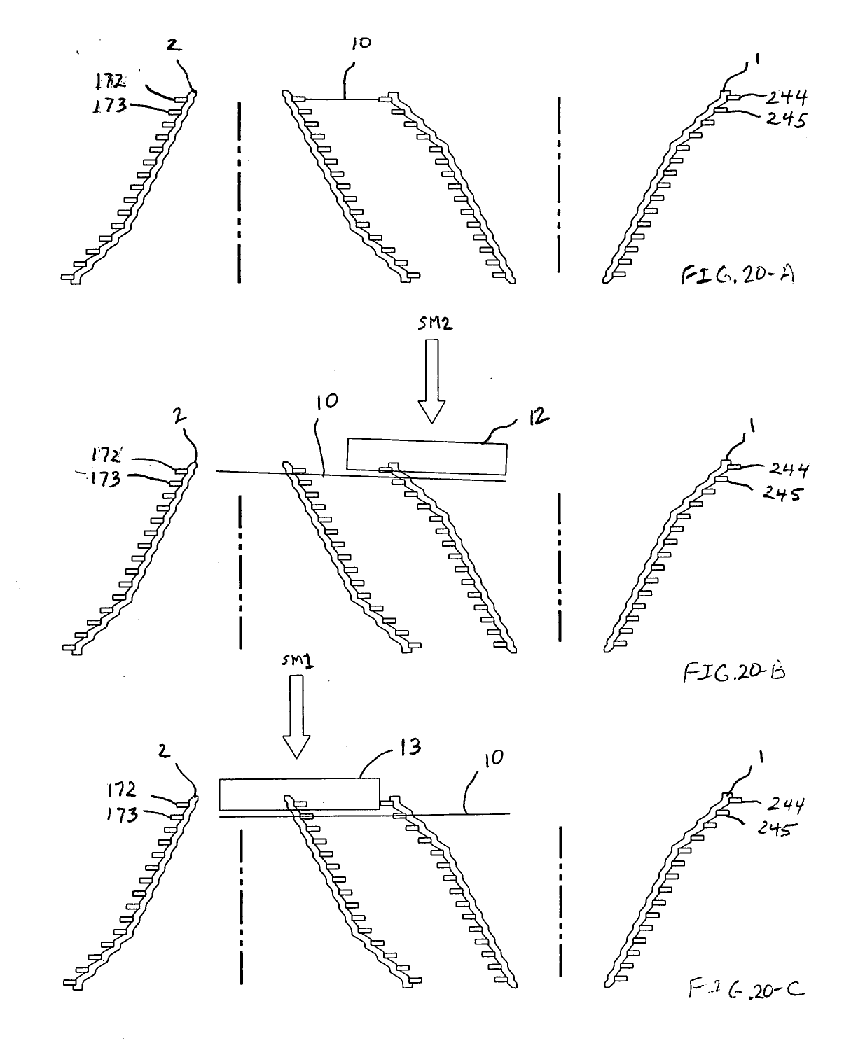

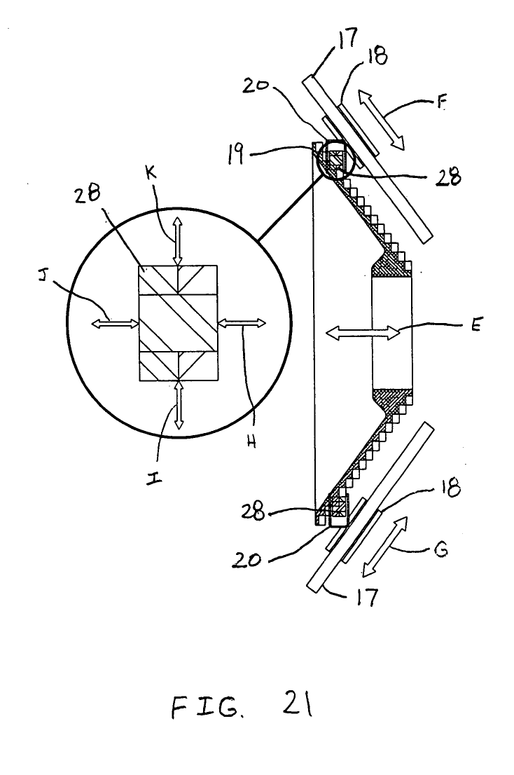

An additional example of a shift method is depicted by FIGS. 20-A, 20-B, and 20-C. This example is an embodiment of a shift method whereby the pair of shift mechanisms introduced in FIGS. 19-A, 19-B, and 19-C engage with the continuous loop 7 to accomplish the drive ratio changes without requiring a transmission carrier movement. Shift mechanisms 12 and 13 work in coordination to enable shifts of continuous loop 7 between the drive and driven elements.

FIG. 20-A depicts the essentially parallel positioning of transmission carrier 1 and transmission carrier 2 and a line section 10 representing the projected path of the continuous loop 7 of FIG. 5-A. Fixable drive elements 244 and 245 represent the largest and next to largest drive element diameters of drive carrier 1 respectively. Fixable driven elements 172 and 173 represent the smallest and next to smallest driven elements of driven carrier 2 respectively.

FIG. 20-B shows a movement of the shift mechanism 12 along vector SM2 and the initial transfer of the continuous loop 7 represented by line section 10 from drive element 244 to drive element 245 of transmission carrier 1 while still engaged with the driven element 172 of transmission carrier 2. A reduction of the initial drive ratio is now established.

In FIG. 20-C, the shift mechanism 13 moves along vector SM1 and engages and transferring the continuous loop 7 from driven element 172 to driven element 173 of transmission carrier 2.

The shift sequence has now completed two drive ratio changes and moved the continuous loop 7 from drive element 244 and driven element 172 to the drive element 245 and driven element 173. As earlier noted, longer movements along the vectors SM2 and SM1 would allow increased drive ratio adjustments whereby ratio changes would be greater than the shifts between adjacent fixable elements.

In FIG. 21, the shift vectors H, I, J, and K are representative of the force vectors that influence the endless loop cross section 28 position laterally and vertically. Transmission carrier 19 is shown combined with two separate shift mechanisms each comprised of a guide rod 17, a guide rod housing 18, and an endless loop guide 20. The guide housings 18 and endless loop guides 20 control the position of the endless loop 21 laterally by moving along guide housing rods 17 via shift vectors F and G. Vector E is the shift vector along the carrier 19 central axis.

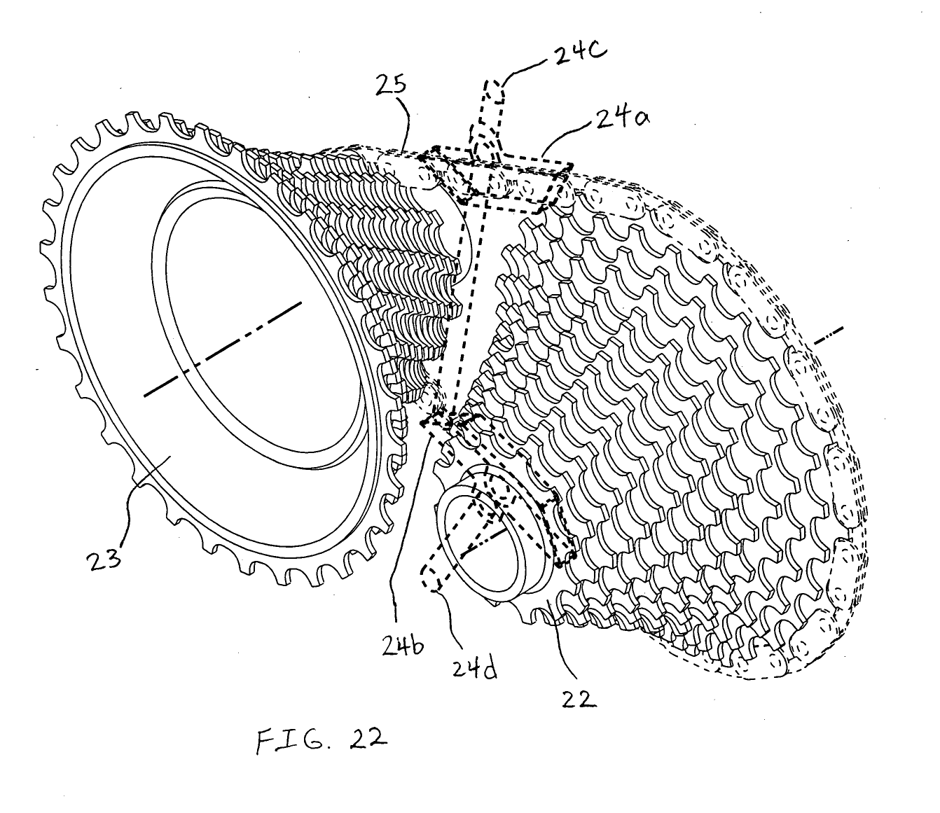

FIG. 22 depicts an embodiment of a transmission ratio change method using two endless loop guides 24a and 24b. Endless loop 25 couples to one of fifteen elements of drive carrier 22 and one of the fifteen elements of driven carrier 23. Endless loop guides 24a and 24b move along guide rods 24c and 24d respectively to laterally displace the endless loop 25 onto adjoining elements to establish changes in the drive ratio output.

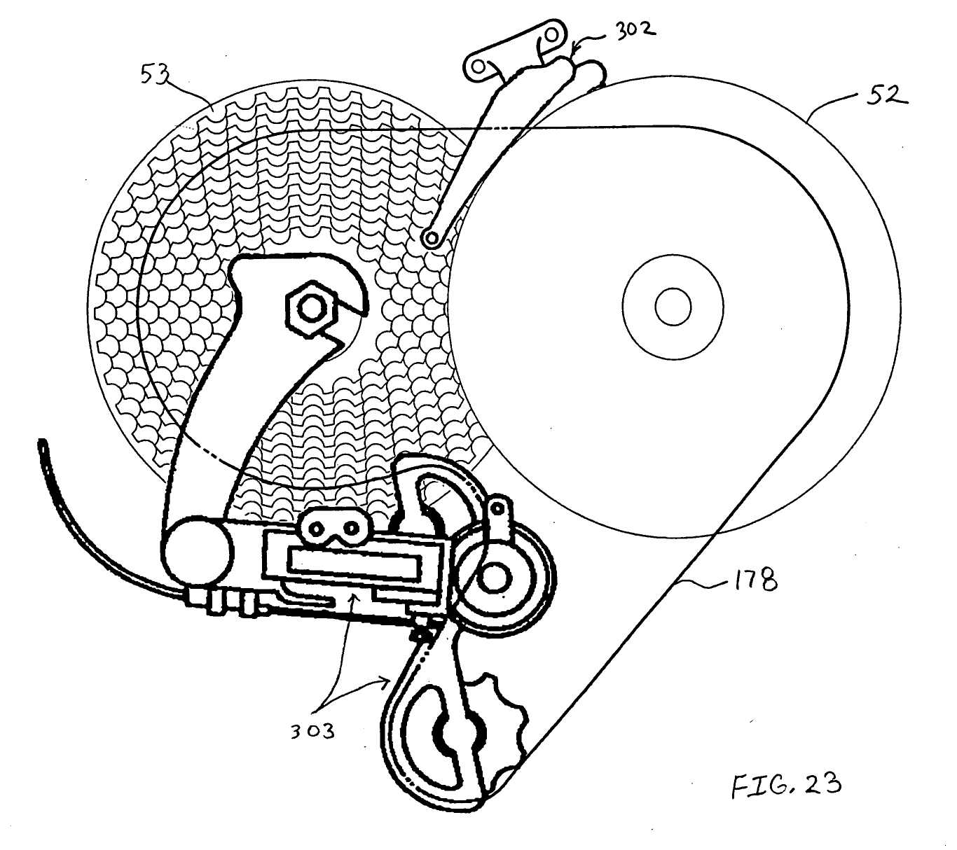

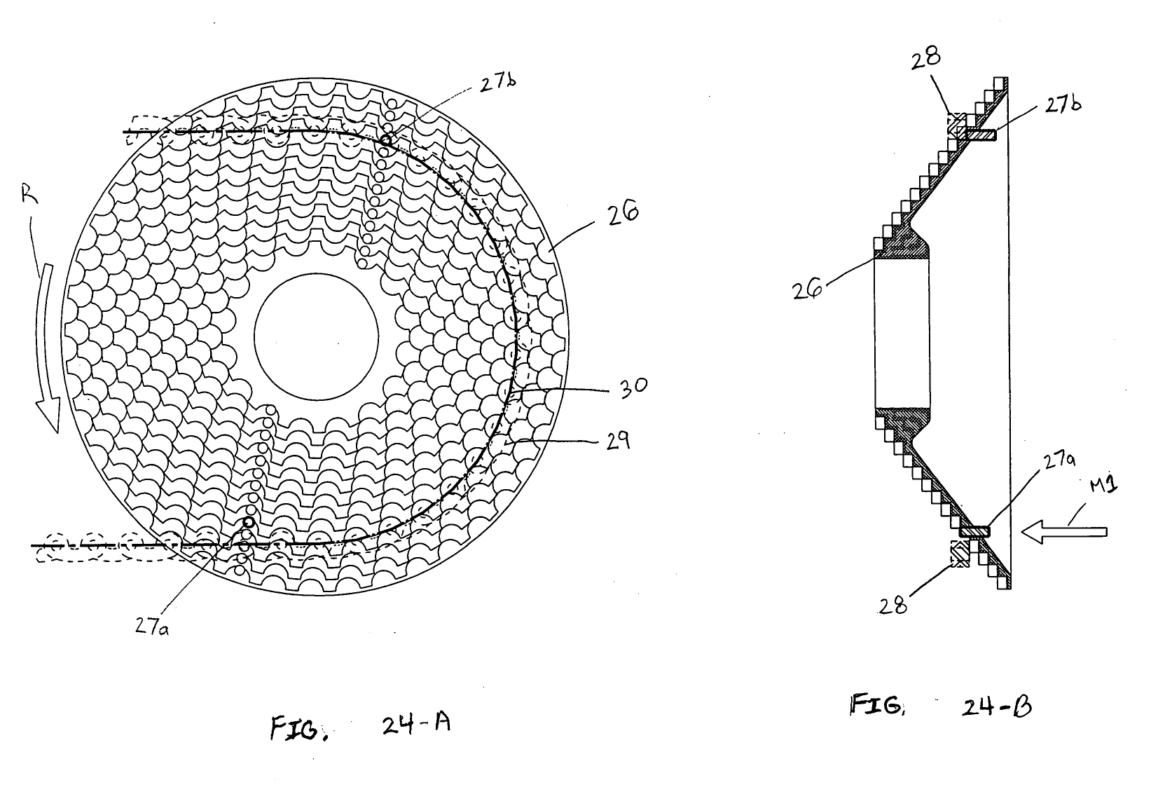

FIG. 23 depicts an embodiment of a ratio change means using endless chain guide systems commonly used on vehicle transmissions, most notably on bicycles. Transmission drive carrier 52 is rotatably coupled with driven carrier 53 by endless loop 178. Endless loop 178 is routed through the upper guide assembly 302 and the lower guide assembly 303. Lower guide assembly is representative of the chain guide and tensioning systems commonly called ‘rear derailleurs’ used on bicycles, referenced by U.S. Pat. No. 5,358,451, Lacombe et al among others. Upper guide assembly 302 is representative of chain guide and shift mechanisms commonly referred to as front derailleurs on bicycle drive systems as referenced by U.S. Pat. No. 5,037,355, Kobayashi among others. As in bicycles, cable or other index methods are used to create lateral movements of the chain guides which in effect transfers the endless loop 178 between selected carrier elements to achieve the desired drive ratio changes.

A series of pins in rows as represented by pins 27a and 27b is an embodiment of another endless loop element shifting means as shown in FIGS. 24-A, 24-B, 25-A, 25-B, 25-C, 26-A, 26-B, 26-C, 27-A, 27-B, and 27-C. The drive ratio shifting method described may apply to either drive or driven carriers or both and may also be used in combination with other shift methods.

In FIGS. 24-A and 24-B, a shift of the endless loop 29 from a carrier profile to the next largest diameter profile is depicted. Transmission carrier 26 with the form of stepped profiles which do not have spaces between the profiled steps as introduced in FIG. 2 has a series of pins aligned with the profiled steps and parallel with the carrier central axis. Although pictured aligned in a row from the outermost carrier profile diameter to the innermost carrier profile diameter matching with the stepped drive profiles, the pins do not have to be in a row as they may also be positioned at various points on each of the stepped profile circumferences. As carrier 26 rotates in vector R direction pin 27a is shifted along vector M to project past the carrier surface that the endless loop 29 profile engages with. Pin 27b is maintained in a retracted position as it is positioned behind the carrier surface that the endless loop 29 is engaged with. Chain path 30 is the representative path of endless loop 29.

In FIG. 24-B, pin 27a is shown extended outward of the stepped profile of carrier 26 in the vector direction M. The extended pin 27a will engage under the endless loop cross section 28 as the carrier continues to rotate the pin to the area where the pin would engage the endless loop 29 and is displayed as endless loop cross section 28.

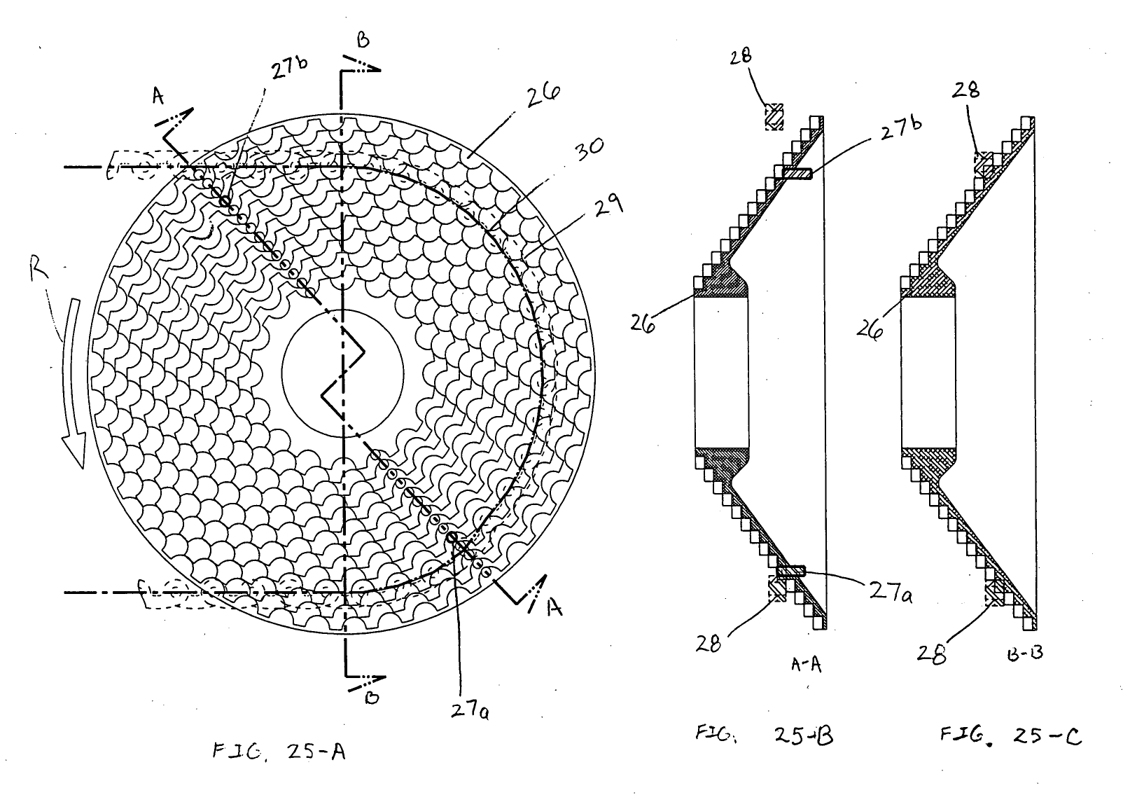

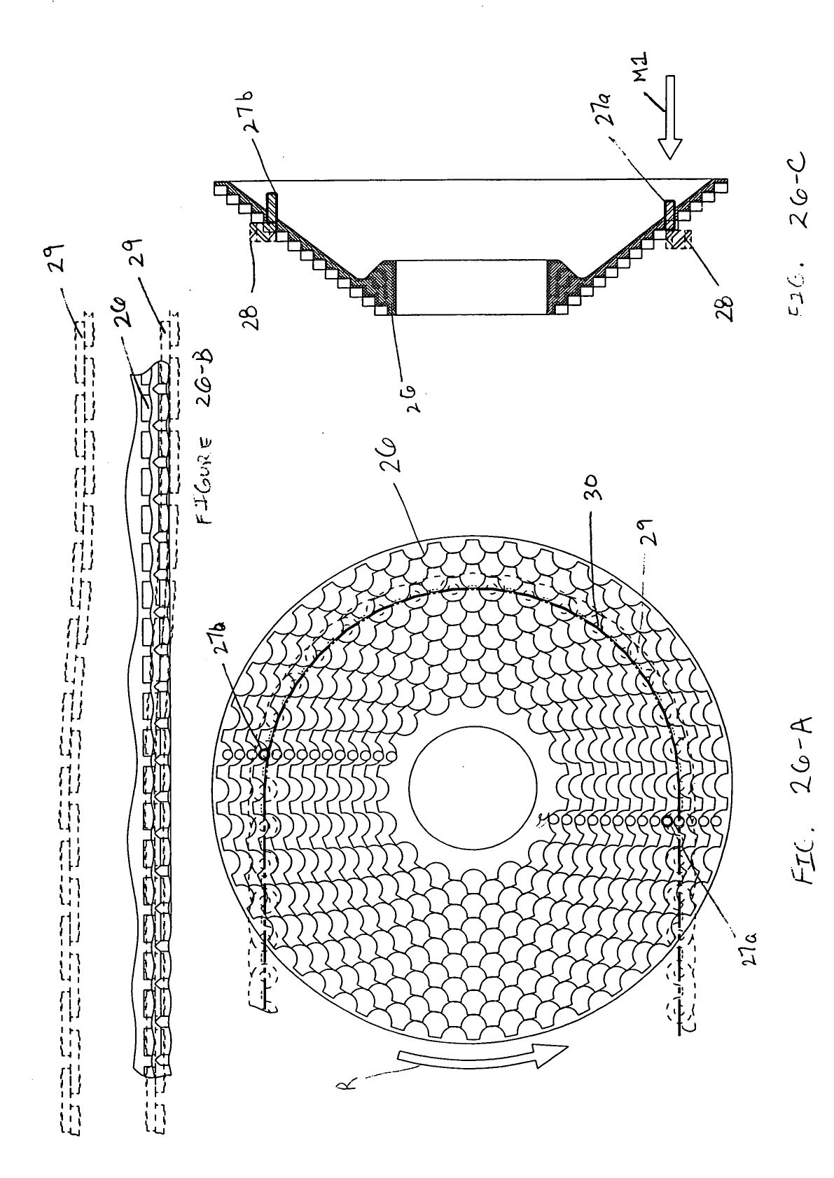

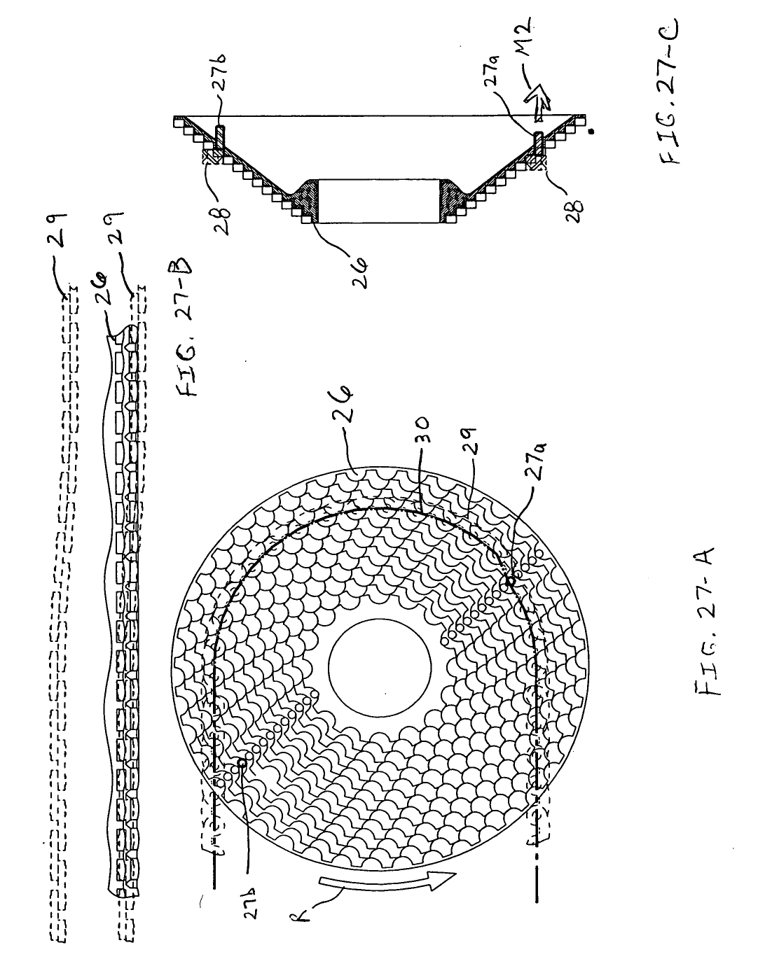

In FIG. 25-A, as the transmission carrier 26 rotates in the R direction, the extended pin 27a begins to support the underside profile of the chain 29 which is then lifted up to the next largest profile diameter. This shift is noted by the change in chain path 30.

In FIG. 25-B, as transmission carrier 26 rotates in the R direction, along the row of pins, pin 27a is shown engaged underneath the endless loop cross section 28. At this quadrant position of the carrier 26, the pin 27a is supporting the up shift of the endless loop cross section to the next largest profiled diameter on the stepped face. Pin 27b is shown retracted flush with the transmission carrier 26 stepped face as the pin row is now rotated past the endless loop cross section 28 contact with transmission carrier 26.

FIG. 25-C shows the endless loop cross section 28 in the lower quadrant of the transmission carrier 26 on one profile diameter and in the upper quadrant of the transmission carrier 26 the endless loop cross section 28 is still contacting the starting profile diameter.

FIGS. 26-A, 26-B, 26-C, 27-A, 27-B and 27-C depict a shift downward from a larger diameter to a smaller diameter on a transmission carrier.

In FIG. 26-A, a series of pins are located on transmission carrier 26 along the carrier stepped profiles as shown previously in FIG. 24-A. Endless loop 29 is engaged with a stepped profile on transmission carrier 26 for approximately half of the profile diameter and follows a chain path 30.

In FIG. 26-C, as the transmission carrier 26 rotates in the R direction, the row of pins including pin 27a is shown engaged behind endless loop cross section 28. At this quadrant position of the carrier 26, the pin 27a is moved along the M1 vector and is projected beyond the carrier's profiled surface. When pin 27a projects past the carrier surface the endless loop 29 is pushed out of the profiled step as shown in the representative chain path shown in FIG. 26-B. As the pin pushes out the chain 29 will be pushed away from the stepped profile surface of transmission carrier 26.

FIG. 27-A shows the row of pins which includes pin 27a in a position now rotated farther along vector R of transmission carrier 26. Endless chain 29 has now dropped down to the next largest diameter and is portrayed by chain path 30. At this position and as shown in FIG. 27-C, the pin is retracted along vector M2 to a position flush with the carrier profile surface. The new chain path is also shown in the lower quadrant by endless loop cross section 28 and the upper quadrant where the endless loop cross section 28 is still engaged with the starting profile diameter. After one half a revolution of the carrier it is evident the chain will be engaged fully with the new profile diameter and a change in the drive ratio will be accomplished.

FIG. 27-B shows a linear footprint of the endless loop 29 travel path around the transmission carrier 26 diameter.

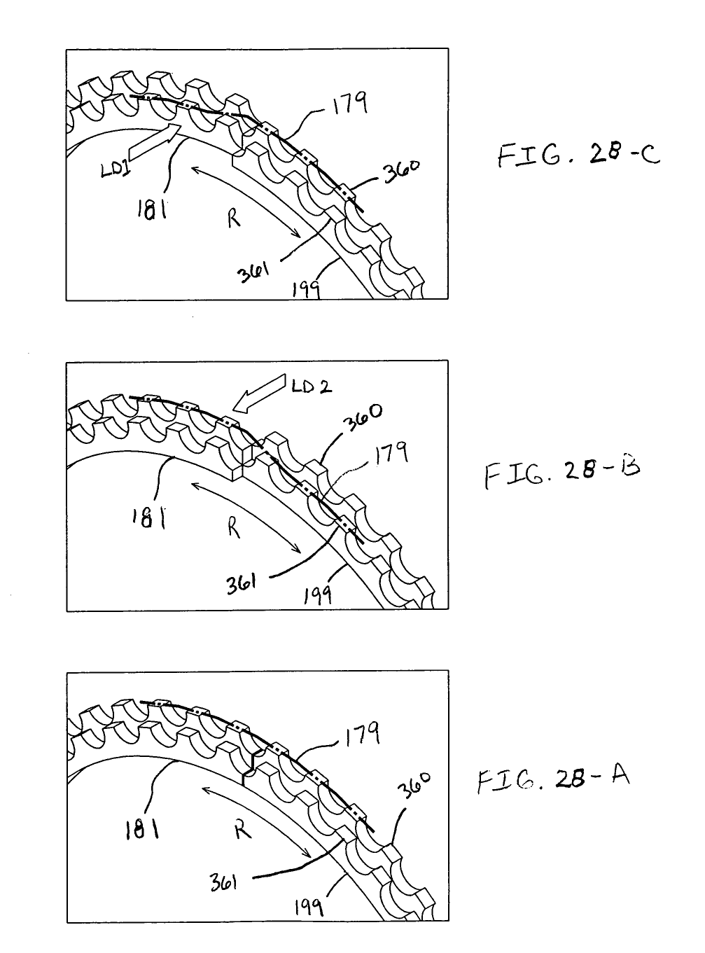

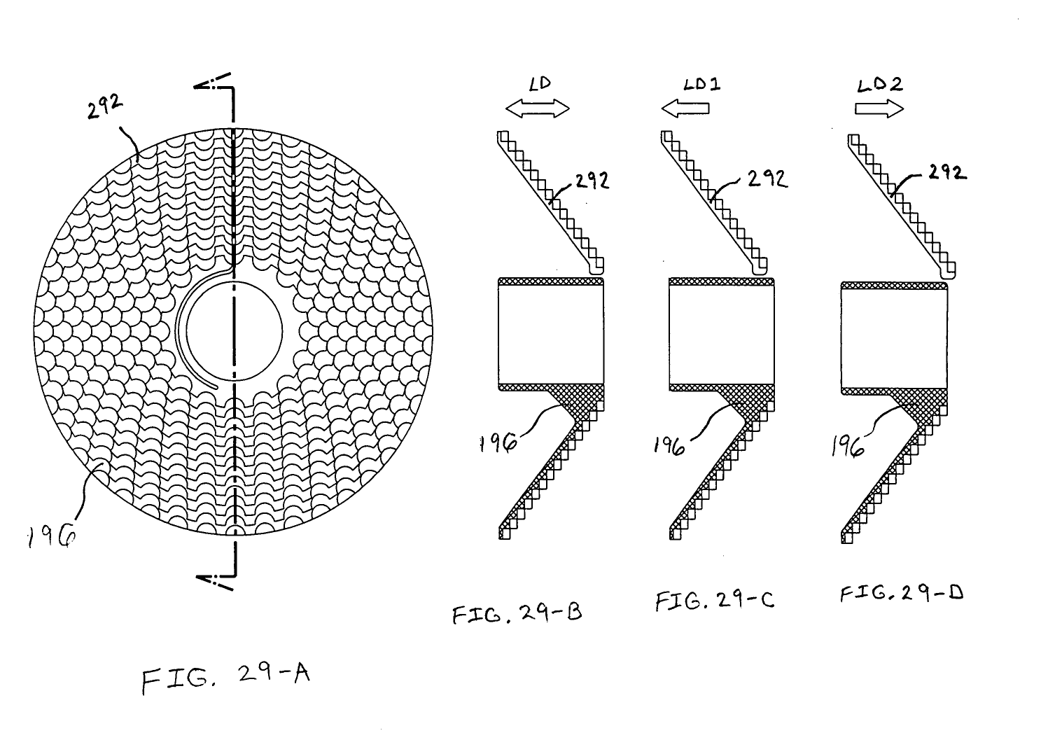

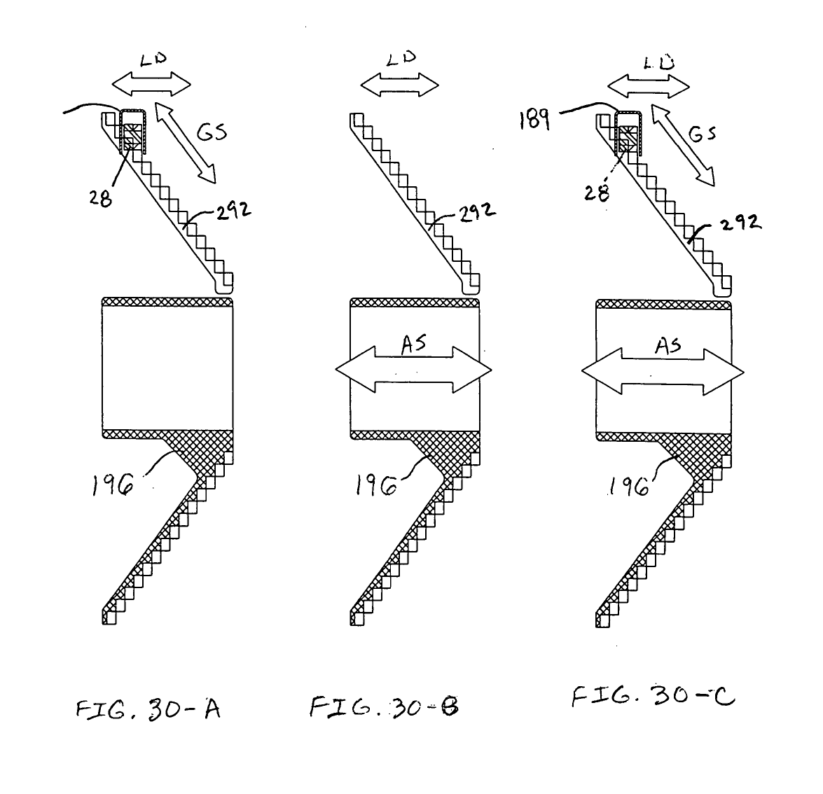

The following embodiment of a transmission carrier in FIGS. 28-A, 28-B, and 28-C incorporates transmission carrier 199 with a moveable portion 181 similar to U.S. Pat. No. 5,205,794 Browning, April 1993 has used moveable portions, but in the context of hinged portions that require multiple parts to connect the pieces. The benefit of using a moveable portion in a transmission carrier is the low friction of chain transfer between carrier diameters and the achievement of very low sidewall friction because of the low crossover angles involved.

FIG. 28-A depicts a moveable portion 181 of transmission carrier 199 similar to the embodiment shown in FIG. 12-A. Chainpath 179 is shown engaged with the profile of carrier element 360 along both the transmission carrier 199 and the moveable portion 181. Transmission carrier 199 may rotate in either direction as represented by vector R to allow the moveable portion and a chain transfer to be accomplished.

FIG. 28-B shows an adjusted chain path 179 as the moveable portion 181 is laterally moved along vector LD2. The chainpath 179 now shows a transfer between carrier element 360 and carrier element 361.

FIG. 28-C shows the moveable portion laterally displaced in the vector LD1 direction. Chainpath 179 is now transferring between carrier element 360 of carrier 199 and the carrier element 361 of the moveable portion 181. The ability to provide a lateral movement feature on the diameter of a moveable carrier portion improves the chain alignment and chain engagement efficiency of the transmission system. The other advantages are the decreased cost of the assembly by the use of fewer parts. Additional support may be included in the carrier body to provide increased load capacity of the moveable portion 181.

FIG. 29-A depicts a transmission carrier 196 that has a laterally moveable portion 292. Lateral movement of a portion of the carrier body is shown in FIG. 29-B along vector LD.

FIG. 29-C and FIG. 29-D show the lateral movement of the moveable portion 292 in the vector LD1 and vector LD2 directions respectively.

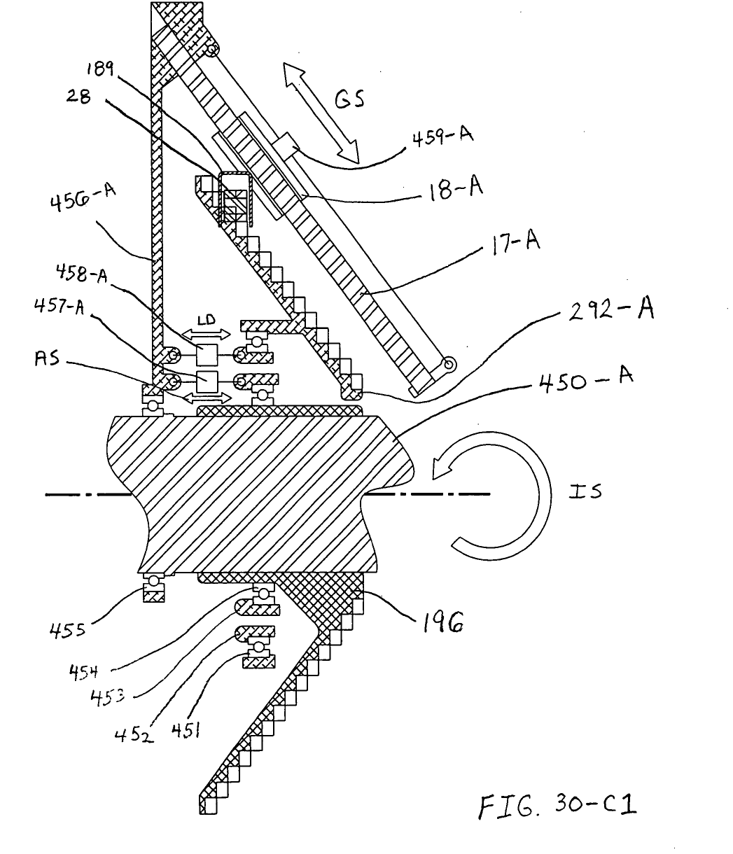

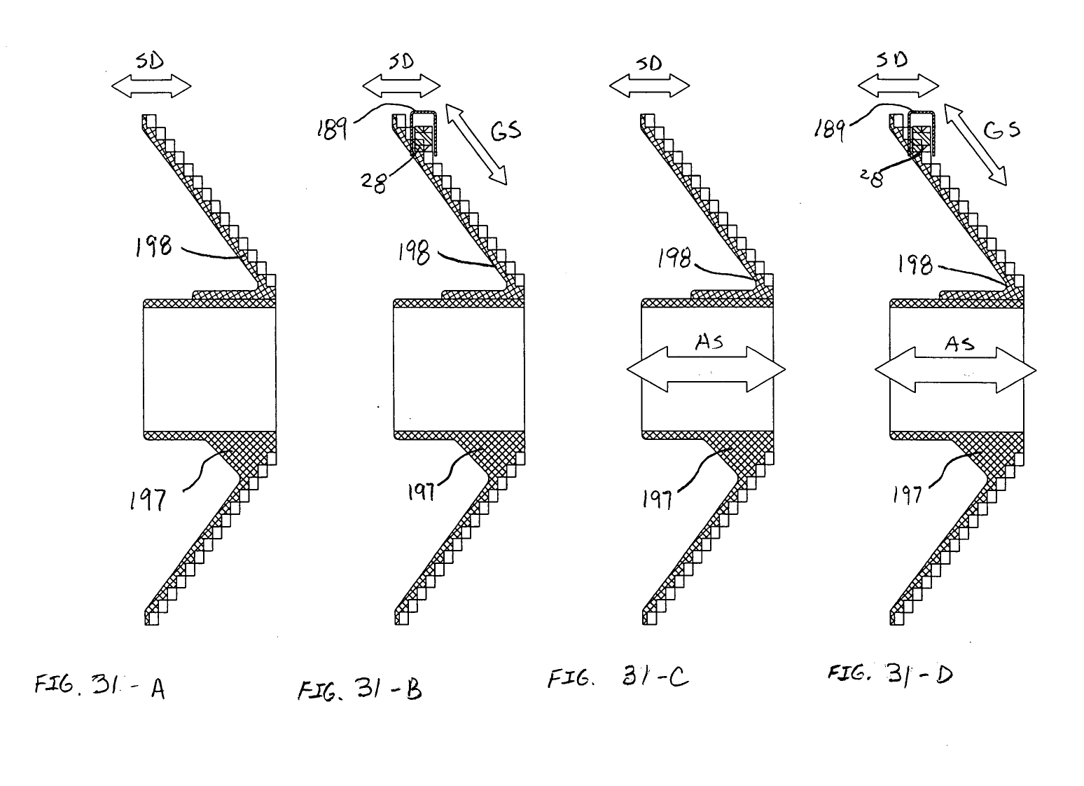

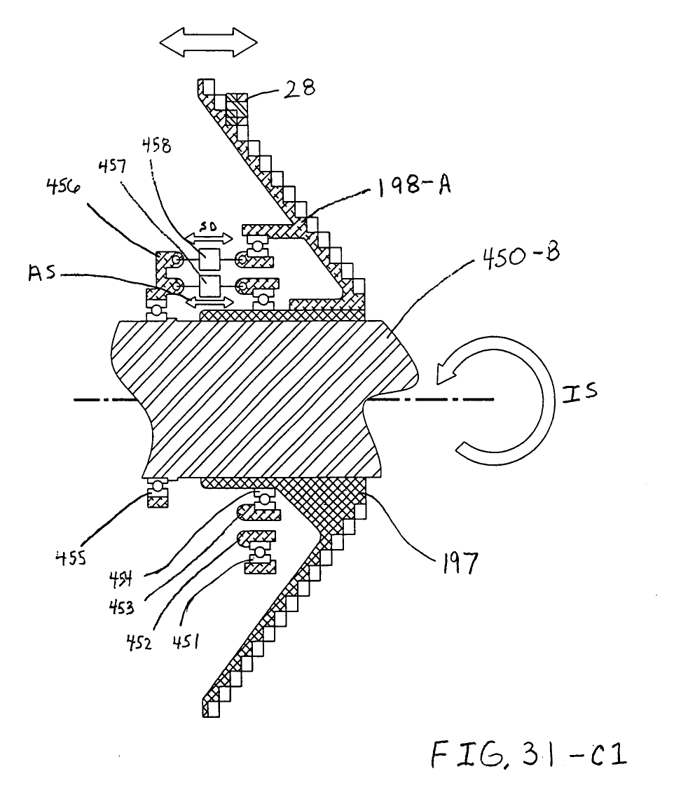

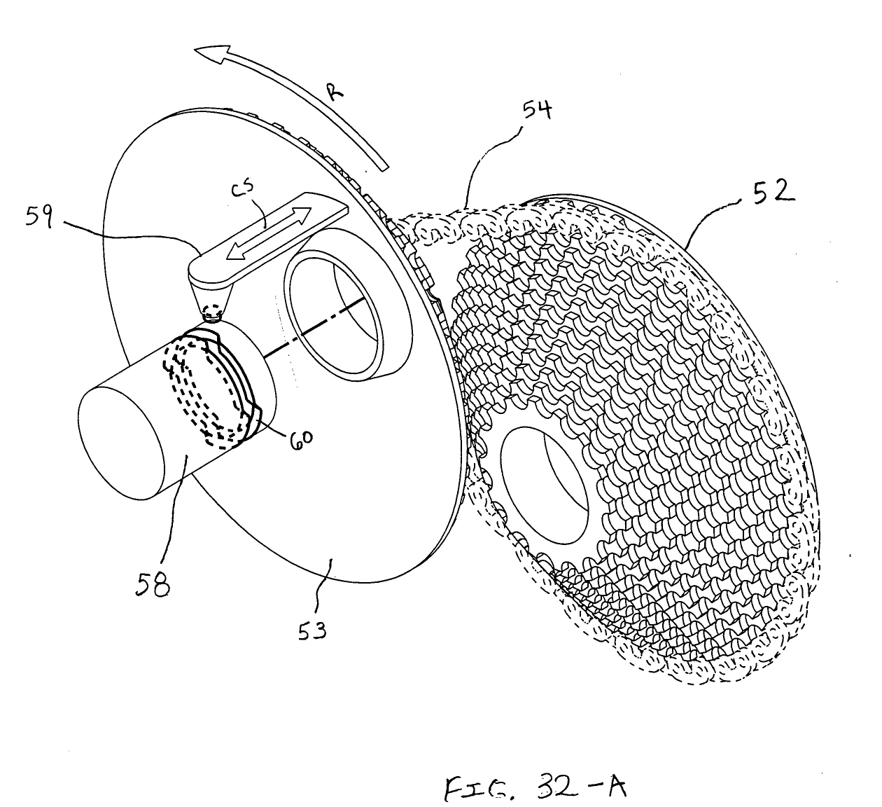

FIG. 30-A displays a combination of the lateral shift capability of the moveable portion 292 along vector LD and a chain guide section 189 movement along vector GS which is approximately parallel to the transmission carrier 196 conical outer diameter profiled steps to control the position of endless loop cross section 28. Another shift embodiment is the combination of the lateral shift of moveable portion 292 along vector LD combined with a lateral shift movement of transmission carrier 196 along the transmission carrier 196 centerline which is represented as vector AS in FIG. 30-B.

A further shift method embodiment is shown in FIG. 30-C as three shift vectors are combined to control the position of endless loop cross section 28. The lateral moveable portion 292 vector LD, the chain guide section 189 movement along vector GS, and the transmission carrier 196 movement along vector AS are all coordinated together to affect a change in the drive ratio of the transmission.

FIG. 30-C1 is an embodiment of the moveable portion of the stepped gear cluster of FIG. 30-C wherein moveable portion 292-A lateral shifts along vector SD are controlled by a cam device, combined with an endless loop guide shift along vector GS and a stepped gear cluster shift along vector AS to coordinate movement of all three vectors to allow a drive ratio shift of endless loop cross section 28 up or down on the stepped gear cluster 196-A. Shift control device 459-A controls the position of the endless loop cross section 28 via shifts along vector GS of guide 189 connected to guide housing 18-A which moves along guide rod 17-A. Cam control device 459-A is attached to cam support 456-A. Cam control device 457-A connects from cam support 456-A to cam connector mount 453 and cam control device 458-A connects from cam support 456-A to cam connector mount 452. Cam support 456-A is supported on shaft 450-A by bearing 455. Cam device 457-A enables shifts along vector AS of the stepped gear cluster main section 196 about the central axis of shaft 450-A. Cam device 458-A enables shift LD of the moveable portion 292-A. Rotation vector IS represents the rotation of shaft 450-A around a central axis. Bearing 454 is mounted on stepped gear cluster 196 and supports cam connector mount 453. Bearing 452 is mounted to laterally moveable portion 292-A and supports cam connector mount 452.

FIG. 31-A shows the stepped gear cluster laterally displaceable section 198 movement vector SD in relationship to the transmission carrier 197.

FIG. 31-B displays a combination of the lateral shift capability of the laterally displaceable section 198 along vector SD and a chain guide section 189 movement along vector GS which is approximately parallel to the transmission carrier 197 conical outer diameter profiled steps to control the position of endless loop cross section 28. Another shift combination is the lateral shift of laterally displaceable section 198 along vector SD combined with a lateral shift movement of transmission carrier 197 along the transmission carrier 197 centerline which is represented as vector AS in FIG. 31-C. A further shift method is shown in FIG. 31-C as three shift vectors are combined to control the position of endless loop cross section 28. The laterally displaceable section 198 movement along vector SD, the chain guide section 189 movement along vector GS, and the transmission carrier 197 movement along vector AS are all coordinated together to affect a change in the drive ratio of the transmission.

FIG. 31-C1 is an embodiment of the moveable section of the stepped gear cluster of FIG. 31-C wherein moveable section 198-A shifts laterally along vector SD combined with stepped gear cluster 197-A shifts along vector AS control a drive ratio up or down shift of endless loop cross section 28 on the stepped gear cluster 197-A. Cam control device 457 and cam control device 458 are attached to cam support 456. Cam control device 457 connects from cam support 456 to cam connector mount 453 and cam control device 458 connects from cam support 456 to cam connector mount 452. Cam support 456 is supported on shaft 450-B by bearing 455. Cam device 457 enables shift AS of the stepped gear cluster main section 196-A along the central axis of shaft 450-B. Cam device 458 enables shift SD of the laterally displaceable section 198-A. Rotation vector IS represents the rotation of shaft 450-B around a central axis. Bearing 454 is mounted on stepped gear cluster 196 and supports cam connector mount 453. Bearing 452 is mounted to moveable section 198-A and supports cam connector mount 452.

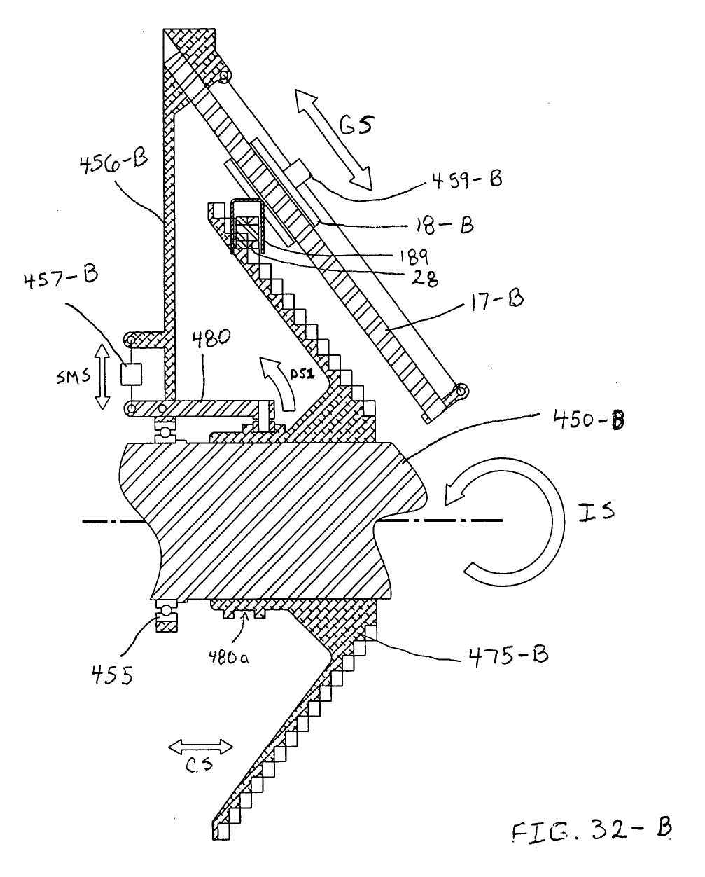

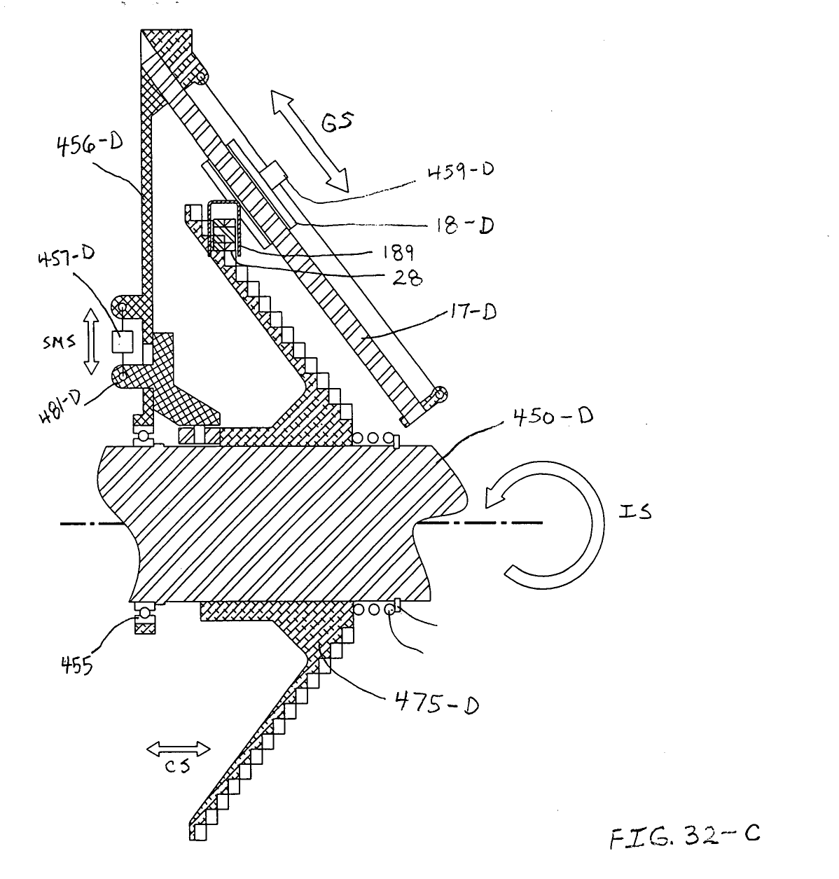

FIG. 32-A depicts the transmission carriers 52 and 53 of FIG. 2 with a cam guide pin attached to transmission carrier 53. As transmission carrier 53 rotates along the vector R, the cam pin 59 is controlled by cam guide profile 60 on the outer diameter cam 58. Shifts of the transmission carrier 53 along the vector CS enable controlled lateral movement of chain 54 on the transmission carrier 53 stepped profile diameters.

FIG. 32-B is an embodiment of the cam controlled stepped gear cluster of FIG. 32-A wherein stepped gear cluster 475-B has a cam guide groove 480a. Cam control device 457-B enables shifts of stepped gear cluster 475-B along shift vector CS and shift control device 459-B enables shifts along vector GS to coordinate movement of two vectors to allow a drive ratio shift of endless loop cross section 28 up or down on the stepped gear cluster 475-B. Shift control device 459-B controls the position of the endless loop cross section 28 via shifts along vector GS of guide 189 connected to guide housing 18-B which moves along guide rod 17-B which is attached to cam support 456-B. Rotation vector IS represents the rotation of shaft 450-B around a central axis. Bearing 455 supports cam support 456-B. Cam control device 457-B controls contact of the cam arm 480 with cam groove 480a through engagement or disengagement of cam arm 480 by shift vector SMS.

FIG. 32-C is an embodiment similar to the cam controlled stepped gear cluster of FIG. 32-A wherein stepped gear cluster 475-D has a cam guide face 480b. Cam control device 457-D enables shifts of stepped gear cluster 475-D along shift vector CS and shift control device 459-B enables shifts along vector GS to coordinate movement of two vectors to allow a drive ratio shift of endless loop cross section 28 up or down on the stepped gear cluster 475-D. Shift control device 459-D controls the position of the endless loop cross section 28 via shifts along vector GS of guide 189 connected to guide housing 18-D which moves along guide rod 17-D which is attached to cam support 456-D. Rotation vector IS represents the rotation of shaft 450-D around a central axis. Bearing 455 supports cam support 456-D. Cam control device 457-D controls contact of the cam roller 480c on cam arm 481-D with cam face 480b through engagement or disengagement of cam arm 481-D by shift vector SMS. Spring 480-5 and retainer 480-6 maintain tension on stepped gear cluster 475-D for the cam roller 480c contact with cam face 480b.

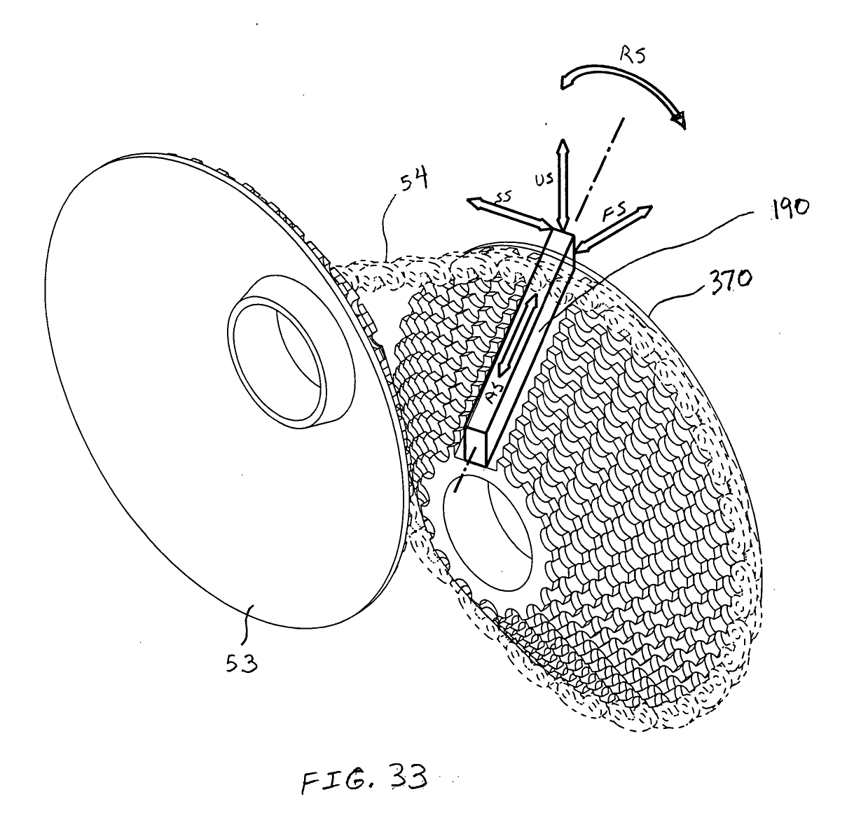

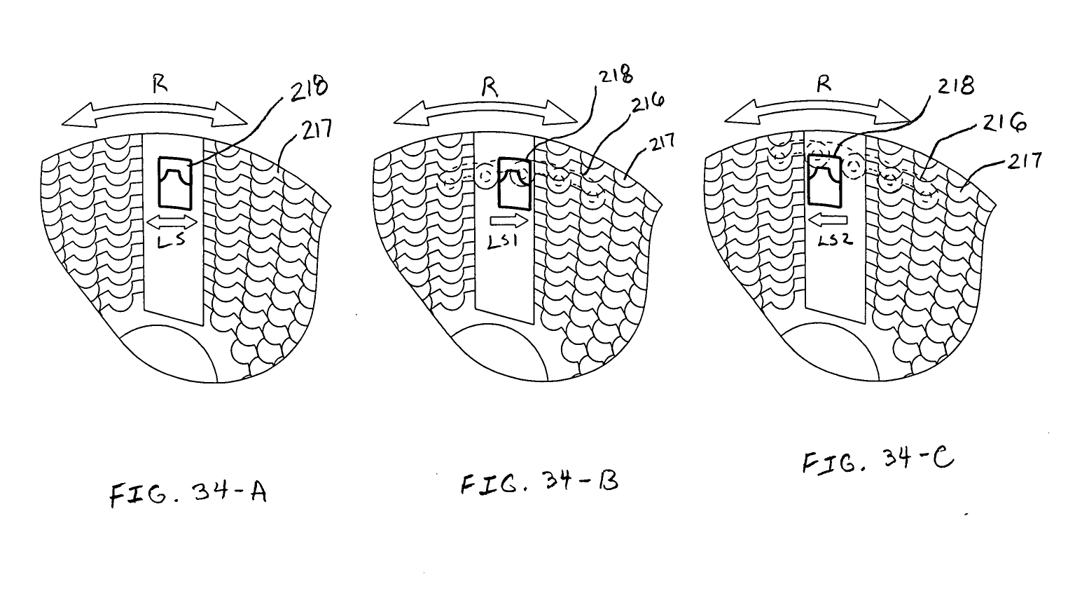

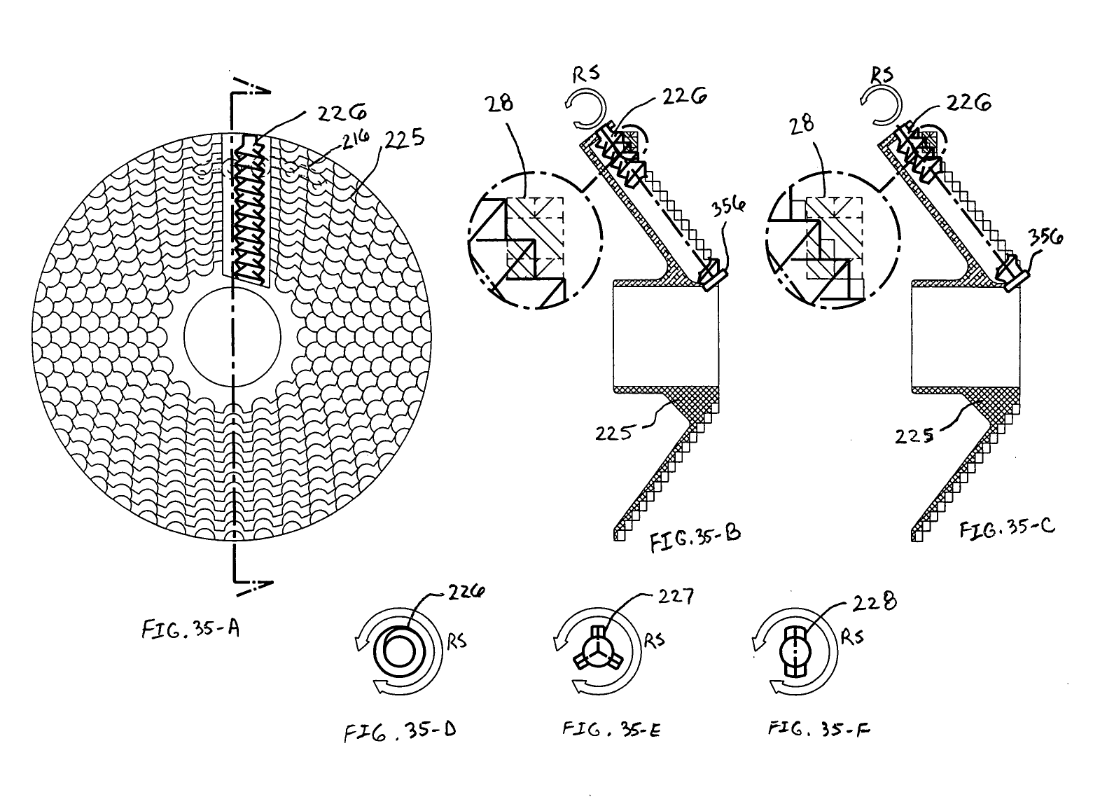

In FIG. 33, an embodiment of the transmission carriers of FIG. 2 is depicted. Transmission carrier 370 is a modification of transmission carrier 52 whereby an endless element control device 190 is inserted. The endless element control device 190 may be moveable along multiple vectors as shown by rotational vector RS, side shift vector SS, fore-aft shift vector FS, vertical vector US, and diagonal vector AS. The endless element control device's key purpose is to assist in the lateral movement of the endless loop element 54 between the stepped profiles of transmission carrier 370. The main method of the control device to influence the endless loop path is through the interruption of the endless loop path by displacing the control element along the endless loop path in such a way as to block, lift, or to allow to drop the endless loop links, as the endless loop links pass across the profiles on the control device surface. Although only one endless element control device 190 is shown on transmission carrier 370, an endless element control device may be used on both transmission carriers.

FIG. 34-A shows a moveable section of an endless loop control element noted as endless element control device side shifter 218 is movable along the vector LS as transmission carrier 217 rotates along the vector R. Endless element control device side element shifter 218 has an endless loop profile on the surface that matches the pitch of the stepped profiles on the surface of transmission carrier 217. The side to side movement of the endless element control device side shifter 218 allows the control device to assist a movement of the endless loop element to a larger stepped diameter or to a smaller stepped diameter pattern by transferring the endless loop to the new diameter during the side to side shift.

In FIG. 34-B, as transmission carrier 217 rotates along vector R a side shift of endless element control device side shifter 218 along vector LS1 assists a transfer of the chain segment 216 to another profile diameter of transmission carrier 217. FIG. 34-C displays a movement of endless element control device side shifter 218 along vector LS 2 whereby the chain segment 216 is transferred to another stepped profile diameter of transmission carrier 217.

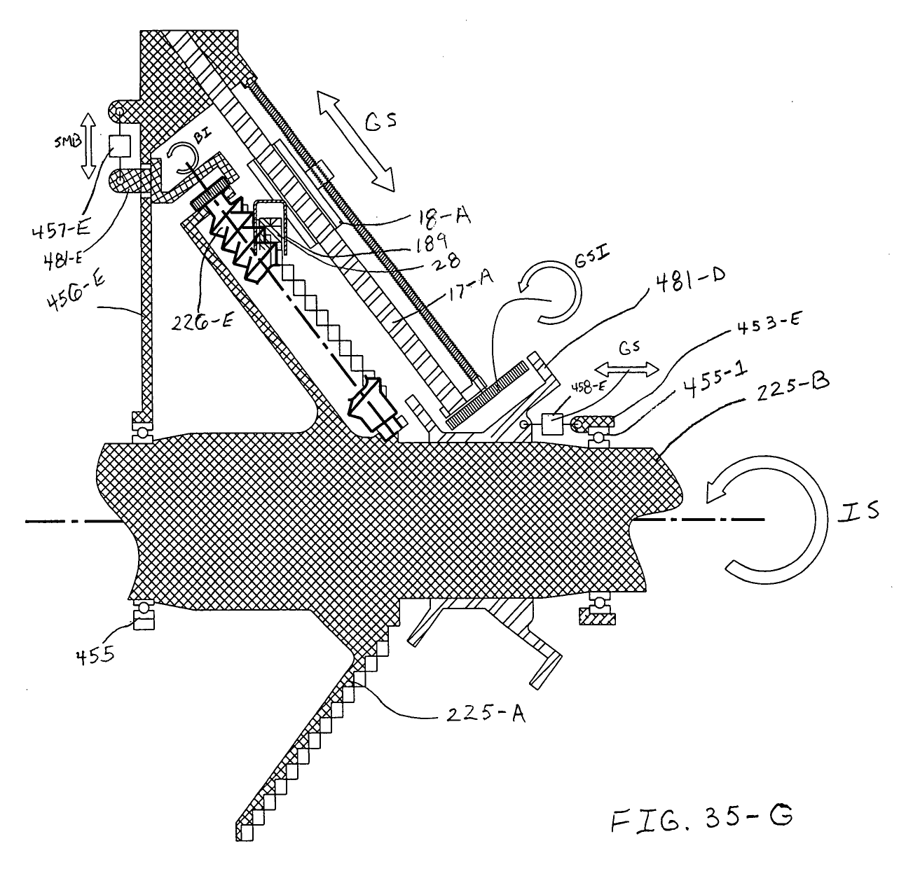

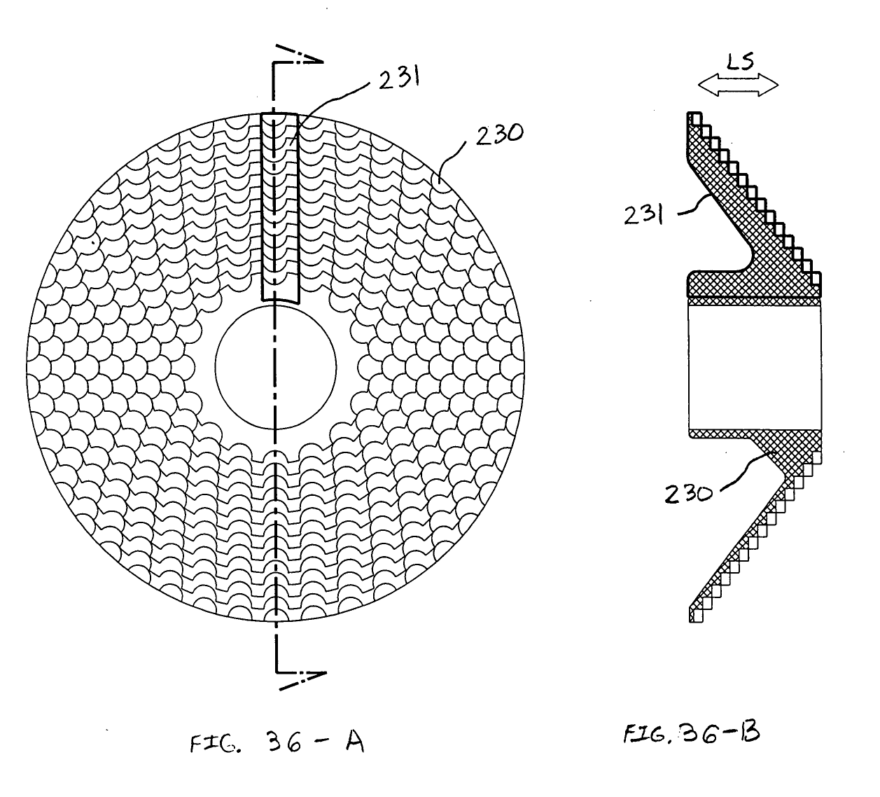

In FIG. 35-A, another embodiment of an endless element control device is introduced which operates in a rotary manner. Transmission carrier 225 has an embedded endless element control device rotary shifter 226 approximately parallel to the conical taper of the carrier. The chain segment 216 engages a stepped profile along the surface of transmission carrier 225 and the endless element control device rotary shifter 226 is positioned below the stepped profile surface as shown in FIG. 35-B. The endless element control device rotary shifter 226 has a rotary vector RS which is controlled by cam lobe 356.

In FIG. 35-C, the endless element control device rotary shifter 226 is shown in a blocking position of the endless loop cross section 28 which results in the displacement of the endless loop cross section 28 to a larger or smaller stepped profile on the transmission carrier 225. The timing and amount of rotation of the endless element control device rotary shifter 226 is determined by the cam lobe 356.

FIG. 35-D shows the helical end of the endless element control device rotary shifter 226.

FIGS. 35-E, and 35-F depict various profile embodiments for the endless element control device rotary shifter 226. The endless element control device rotary tri-lobed shifter 227 has a tri-lobed helical profile instead of a continuously helical surface. The endless element control device rotary dual-lobed shifter 228 has a dual-lobed helical profile with the lobes interspersed along the length of the central axis. The shifting of the chain with these embodiments is similar to the method used by the extendable pins disclosed earlier. The helical lobes can support or displace the chain for lateral shift movements between the transmission carrier stepped diameters.

FIG. 35-G depicts another embodiment of a stepped carrier with an endless element control device similar to FIG. 33-A wherein stepped gear cluster 225-A has a rotable endless element control device 226-E controlled by rotary control device 457-E. The endless element control device 226-E is approximately parallel to the conical taper of transmission carrier 225-A. Transmission carrier 225-A is an integrated section of shaft 225-B which rotates around a central axis as represented by vector IS. The endless loop cross section 28 engages a stepped profile along the surface of transmission carrier 225-A and the endless element control device 226-E is positioned above or below the stepped profile surface of transmission carrier 225-A to assist in an up or down shift of endless loop cross section 28. Bearing 455 is mounted to shaft 225-B and supports cam support 456-E. Shift index device 457-E controls shifts along vector SMB of rotator index arm 481-E. Rotator arm 481-E indexes endless element control device 226-E around vector BI. Shift control device 458-E controls the position of the endless loop cross section 28 via shifts along vector GS of guide 189 connected to guide housing 18-A which moves along guide rod 17-A which is attached to cam support 456-E. Shift control device 458-E shifts along vector GS2 and is connected to support 453-E and indexer body 481-D. Shift control device 458-E controls engagement of indexer body 481-D to the indexing rod 481-F. Indexing rod 481-F rotates about rotational vector GS1 which positions the guide housing 18-A linearly along guide rod 17-A for control of the endless loop cross section 28. Bearing 455-1 is mounted on shaft 225-B and connects to support 453-E.

FIG. 36-A is a depiction of transmission carrier 230 with an endless element control device section 231.

As shown in FIG. 36-B, the endless element control device section 231 is laterally displaceable along vector LS and has a matching surface profile as the transmission carrier 230. The lateral movement along vector LS is similar to the lateral movement functions shown in FIG. 29-B and FIG. 31-A.

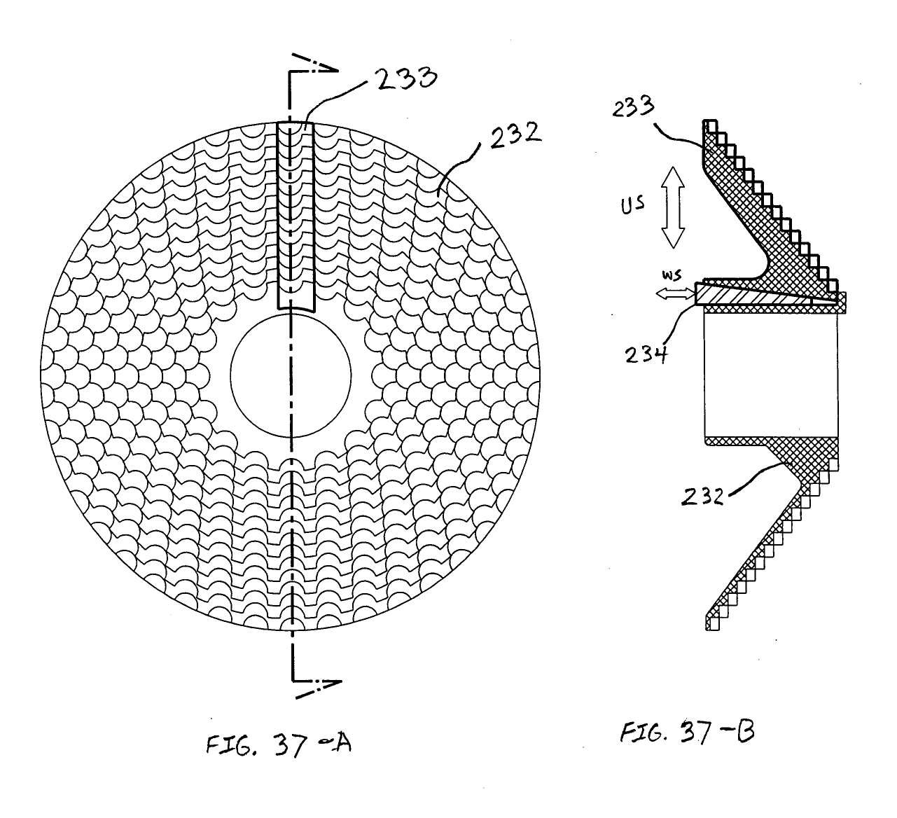

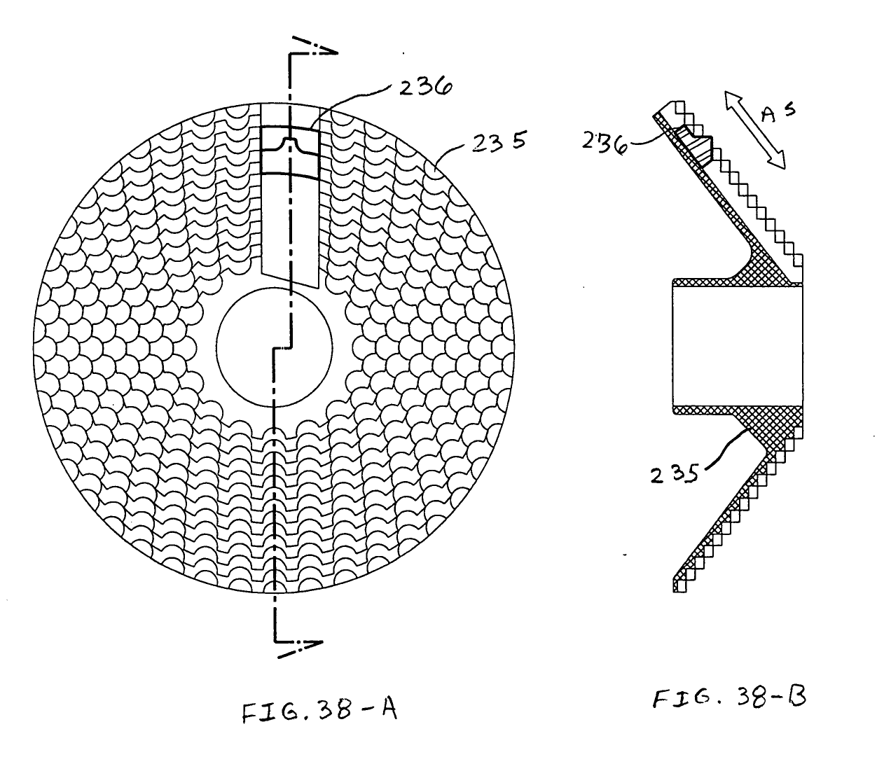

In FIG. 37-A is a depiction of another embodiment with transmission carrier 232 having an endless element control device upshiftable section 233.

As shown in FIG. 37-B, the endless element control device upshiftable section 233 is displaceable along vector US and has a matching surface profile as the transmission carrier 233. Wedge 234 has a movement vector WS which moves the endless element control device upshiftable section 233 up or down along the vector US. In this way the section displaces or supports an endless loop element along the transmission carrier 232 stepped profile diameters.

FIG. 38-A depicts a transmission carrier 235 with an endless element control device tapered section 236 which is located in a pocket on the transmission carrier surface. Endless element control device tapered section 236 is moveable along vector AS which is approximately parallel to the conical taper of the transmission carrier 235 stepped profile surfaces as shown in FIG. 38-B. Endless element control device tapered section 236 has a stepped profile shape on the outermost surface which matches the stepped profile shapes of the transmission carrier 235. The movement along the vector AS will displace or support an endless loop element along the transmission carrier stepped profile surface to assist in the up or down shifting of an endless loop on the transmission carrier 235.

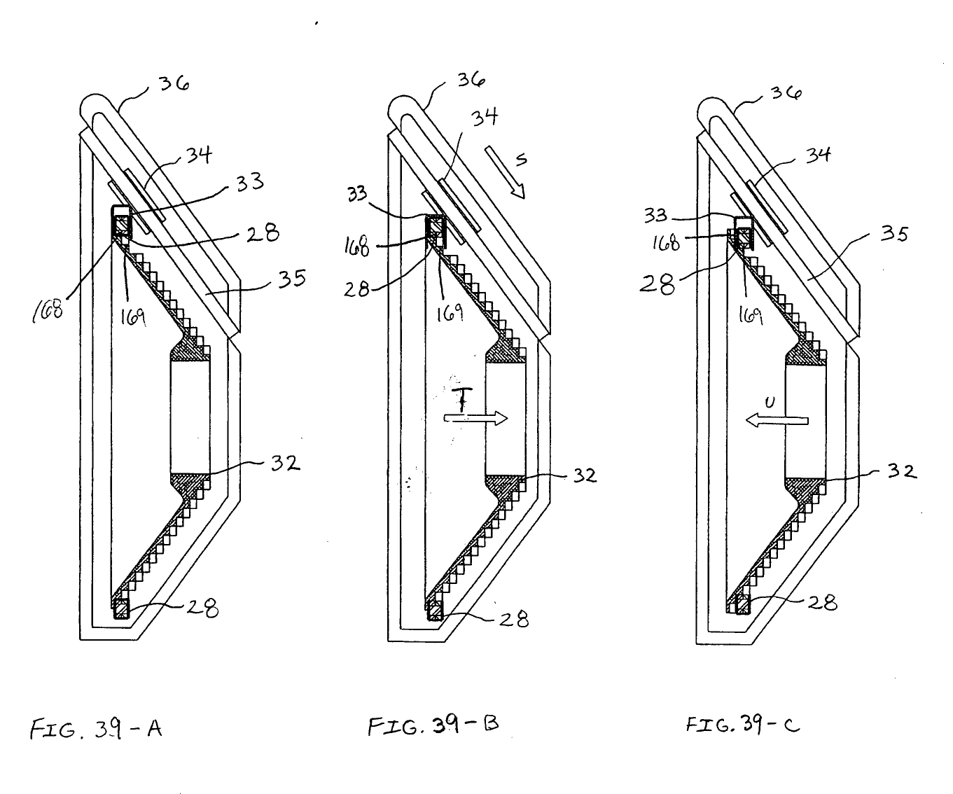

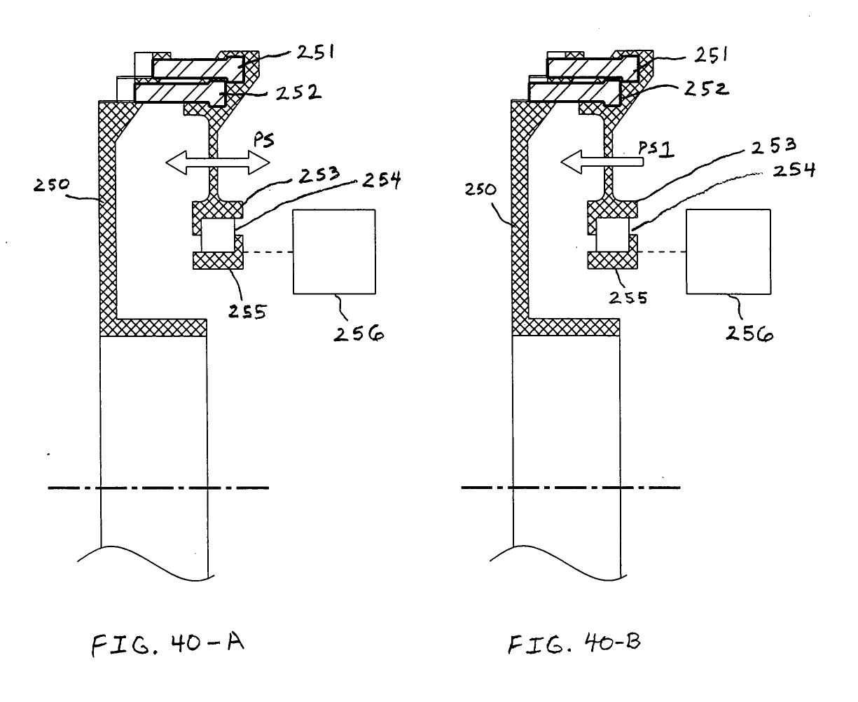

In FIGS. 39-A, 39-B, and 39-C, a series of sequential steps illustrate the coordination of an endless loop shift mechanism and a transmission carrier shift movement. Chain guide 33 is attached to chain guide housing 34 which is movable along the guide housing support rod 35 which is positioned along an axis that is approximately parallel to the tangent angle of the external stepped profiles of transmission carrier 32. The guide housing support rod 35 is installed into and supported by the outer housing 36. The shift mechanism vector and carrier shift vectors are denoted by directional arrows ‘S’, ‘T’ and ‘U’. The shift vector of the guide housing 34 movement along the guide housing support rod 35 is denoted as vector ‘S’. The initial guide housing movement is in a coordinated relationship with carrier 32 whose lateral movement along the carrier central axis ‘A’ is denoted by vector ‘T’. As chain guide housing 34 moves chain guide 33 along the ‘S’ vector, carrier 32 shifts along vector ‘T’ to keep the chain in position on the first carrier element 168, as shown in FIG. 39-B.

In FIG. 39-C, the endless loop cross section 28 is transferred from the first carrier element 168 to the second carrier element 169 when carrier 32 shifts along the carrier ‘A’ axis as denoted by vector ‘U’ and the chain guide housing 34 maintains the position achieved in FIG. 39-B. One complete cycle is complete when the carrier 32 has shifted back to the initial position. The endless loop cross section 28 is now on the second carrier element as shown.

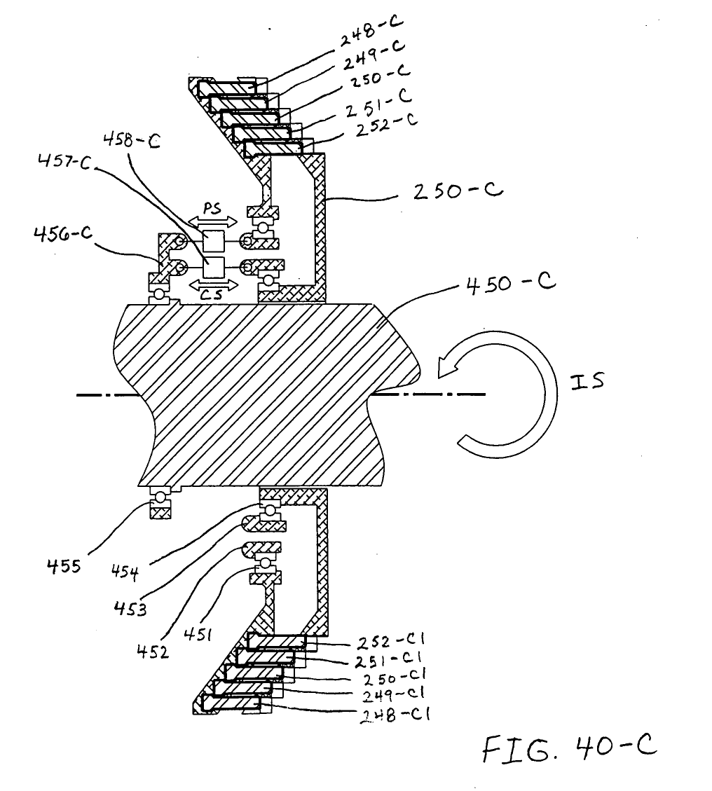

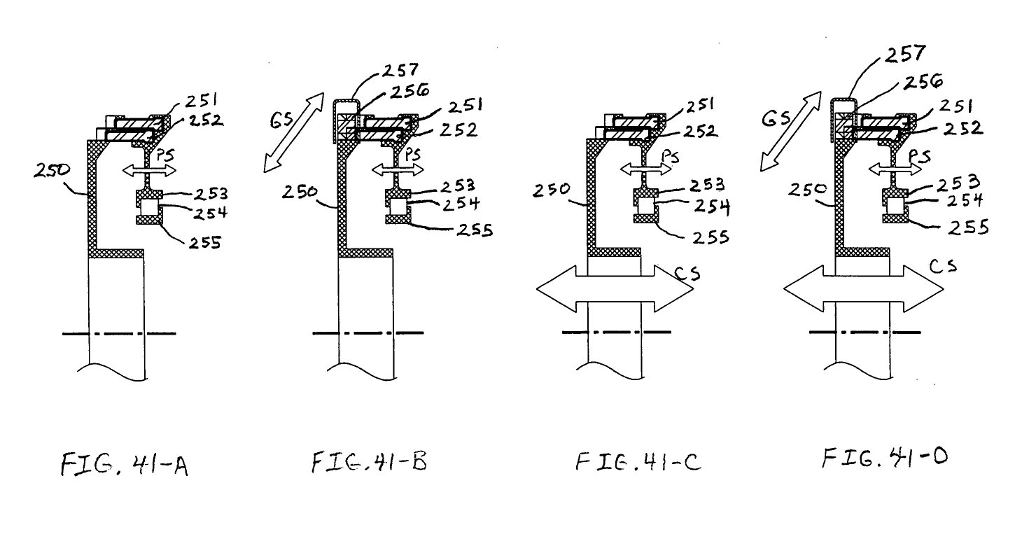

FIG. 40-A is an embodiment of a shift transfer means for the pins defined in FIG. 24-A. Transmission carrier 250, only two drive/driven elements or steps shown, has pin openings and pins 251 and 252 are representative examples of the earlier pin 27a of FIG. 24-A. Pin holder section 253 solidly grips the back of pins 251 and 252 and has a movable axis as defined by vector PS. Pin holder section 253 is supported by bearing 254 which is installed into sleeve 255. Pin shuttle cam 256 actuates the movement of the pin holder section 253.

FIG. 40-B depicts the movement of the pin holder section 253 in vector PS1 direction. The pins 251 and 252 now extend beyond the surface profile of transmission carrier 250.

FIG. 40-C depicts an embodiment similar to the stepped gear cluster of FIG. 40-A wherein stepped gear cluster 250-C is shifted by cam control device 457-C and pin carrier 253-C is shifted by cam control device 458-C along the central axis of shaft 450-C. The controlled shift of the stepped gear cluster 250-C along vector CS and the controlled shift of the pin carrier 253-C along vector PS enable a controlled up and down shift of an endless loop element on the stepped gear cluster 250-C profiles. Pin carrier 253-C engages a row of shift pins 248-C, 249-C, 250-C, 251-C, 252-C which are located on a separate stepped profile and a row of shift pins 252-C1, 251-C1, 250-C1, 249-C1, 248-C1 are located on the same separate stepped profiles at a different rotation interval. Stepped gear cluster 250-C is rotatable around the central axis of shaft 450-C as represented by rotational vector IS. Bearing 455 is mounted on input shaft 450-C and supports cam support 456-C. Cam control device 457-C mounts from cam support 456-C to carrier shift support 453. Cam control device 458-C mounts from cam support 456-C to pin support 452. Bearing 451 mounts on pin support 452 and is housed by pin carrier 253-C. Bearing 453 mounts on stepped gear cluster 250-C and is housed in carrier shift support 453.

FIGS. 41-A, 41-B, and 41-C depict combinations of pin shifts, chain guide shifts, and carrier shifts.

In FIG. 41-A, the pin shift mechanism shown in FIGS. 40-A and 40-B is combined with a guide shift vector GS and a moveable chain guide 257. Chain cross section 256 can be laterally transferred between carrier 250 profile diameters with coordinated movements of the pin holder section 253 along vector PS and the chain guide 257 along vector GS. Another embodiment of a combination of shift methods is in FIG. 41-B. Transmission carrier 250 movements along vector CS can be combined with movements of the pin holder section 253 along vector PS.

In FIG. 41-C, the embodiment is a combination of three shift vectors in coordination. Transmission carrier 25 movement along vector CS, combined with movements of the pin holder section 253 along vector PS and the chain guide 257 along vector GS allow for a very efficient and precise drive ratio changing method.

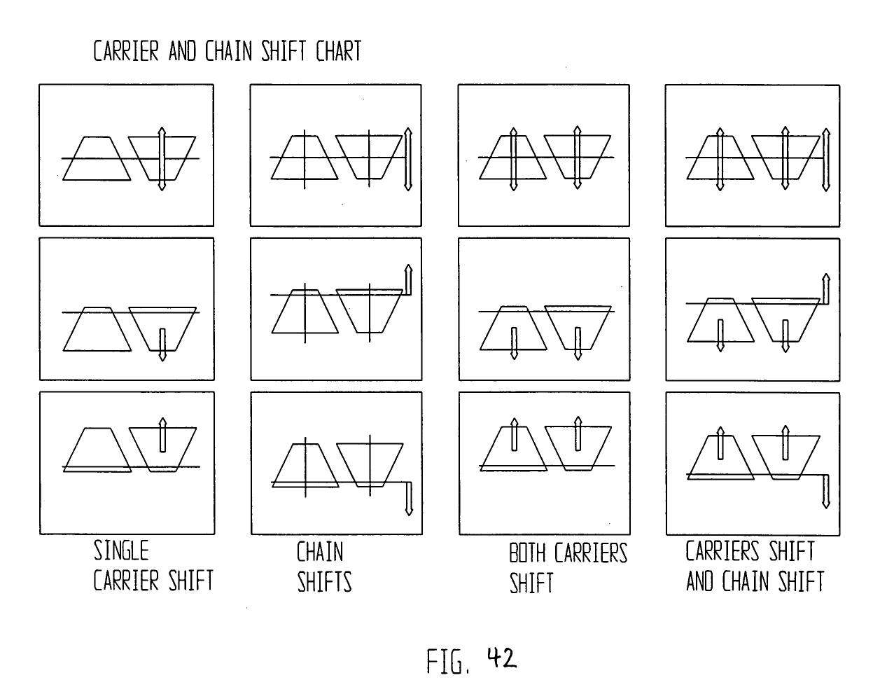

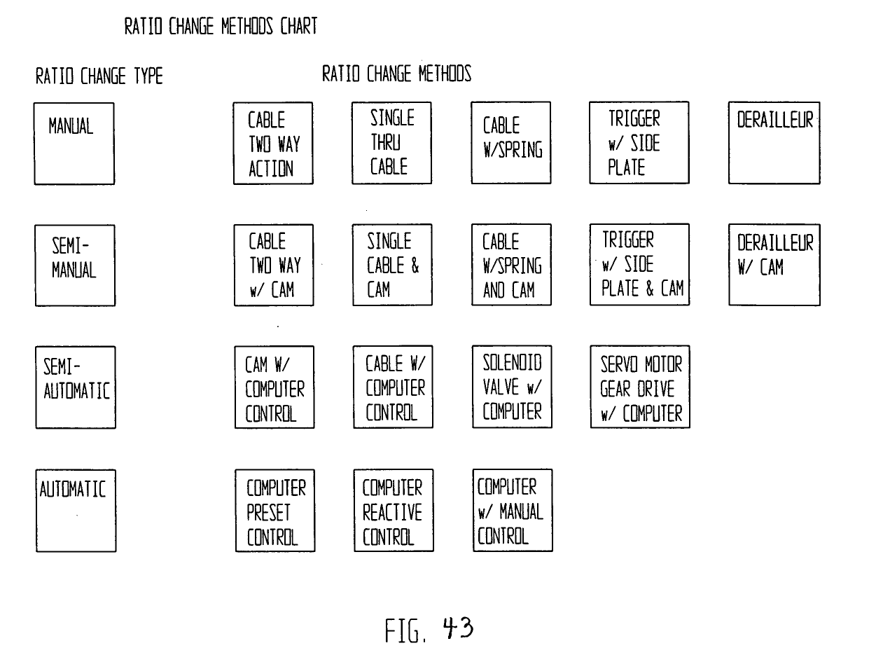

FIG. 42 is a simplified chart showing a single carrier shift vectors, chain shift vectors, both carriers shift vectors, and combined carriers and chain shift vectors. Earlier shift methods have shown the movement of the chain laterally as a primary method of transfer for drive ratio changes. Carrier lateral shift distances may be increased to allow for the chain to stay in the same lateral position.

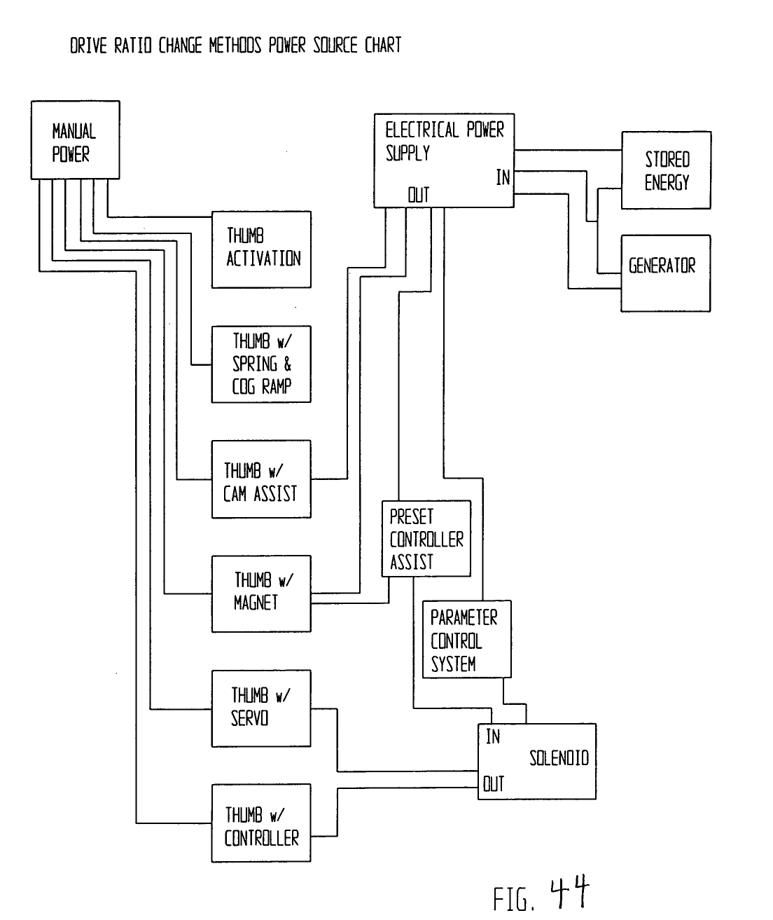

FIG. 43 is a chart listing of transmission ratio change types and drive ratio change methods. Ratio change type categories include yet are not limited to manual, semi-manual, semi-automatic, and automatic. Ratio change methods include but are not limited to dual action cables, single action cable, cable with spring, triggers with side plates, derailleurs, two way cables with cam assist, single cable pull with cam assist, single cable with spring return and cam support, trigger with side plate and cam assist, derailleur with cam assist, cam assist with computer control, single cable with computer control, solenoid value with computer control, servo motor gear drive with computer control, computer preset control, computer reactive control, and computer control with manual assist.

FIG. 44 is a chart listing of drive ratio change device types and power supply types for the drive ratio devices. Manual power, magnetic force, electrical energy supplied by a generator, stored energy as from a battery or a spring, singly or in combination may provide the energy for the drive ratio change devices.

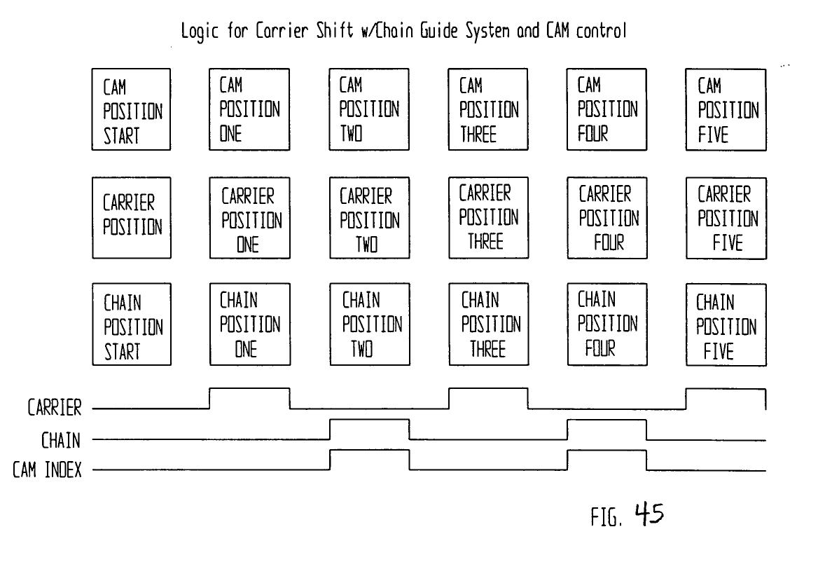

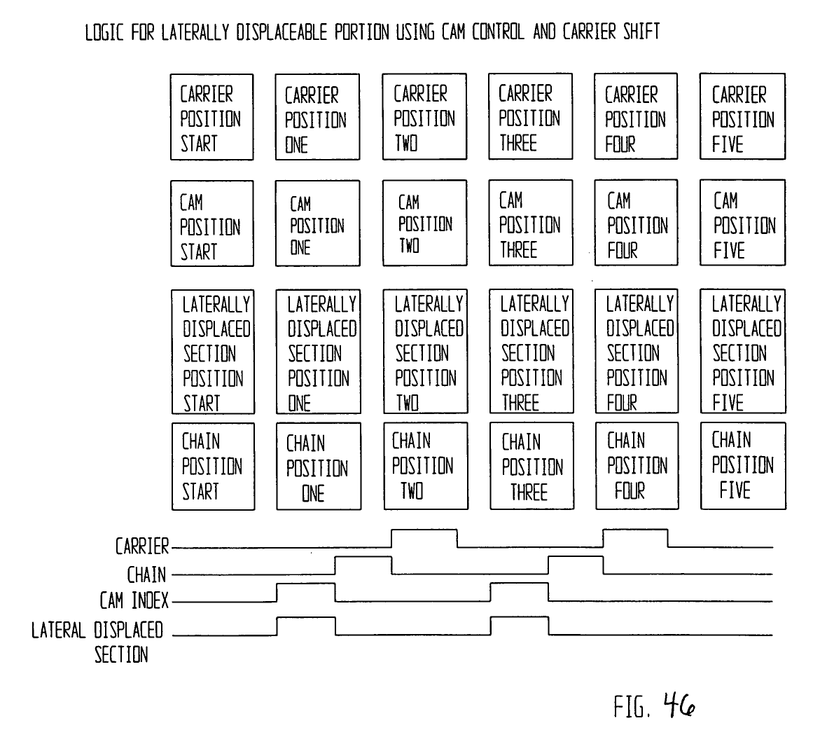

FIG. 45 graphically represents a basic carrier shift and chain guide system whereby a CAM controls the coordination of the carrier shifts. Cam actuators provide shift mechanism timing control where multiple movements are required simultaneously or in rapid sequence. The cam lobes provide the index or timing movement required for the shift mechanisms.

FIG. 46 graphically represents a flow chart that is indicative of coordinated carrier shifts with additional shift mechanisms via CAM control. In this case, a laterally displaceable section and a carrier shift are coordinated by the CAM function.

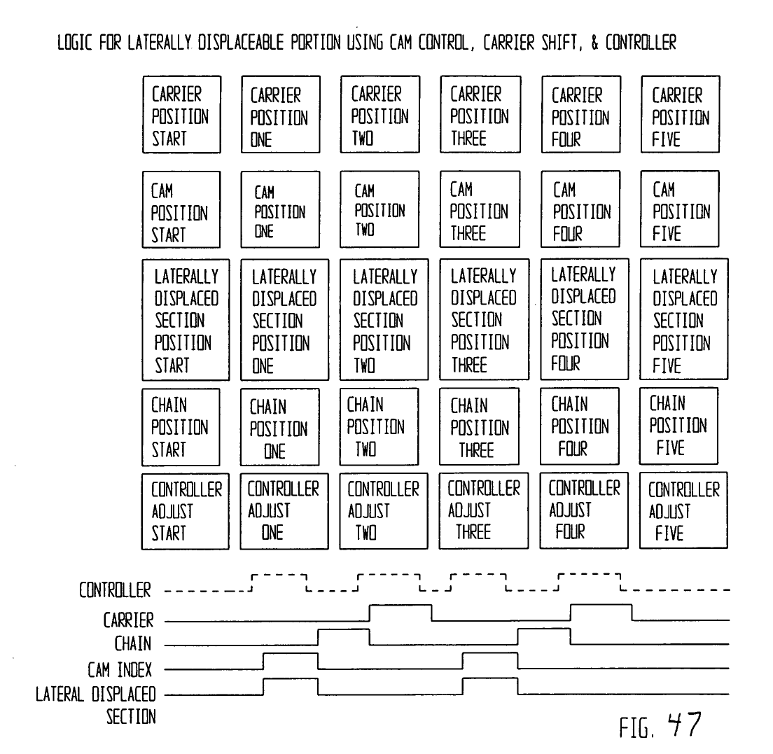

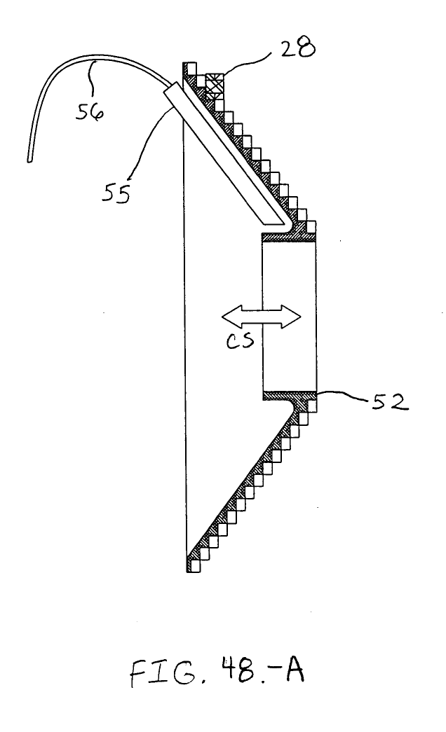

FIG. 47 graphically represents a controller coordination of carrier shifts, laterally displaceable section shifts via cam controls.

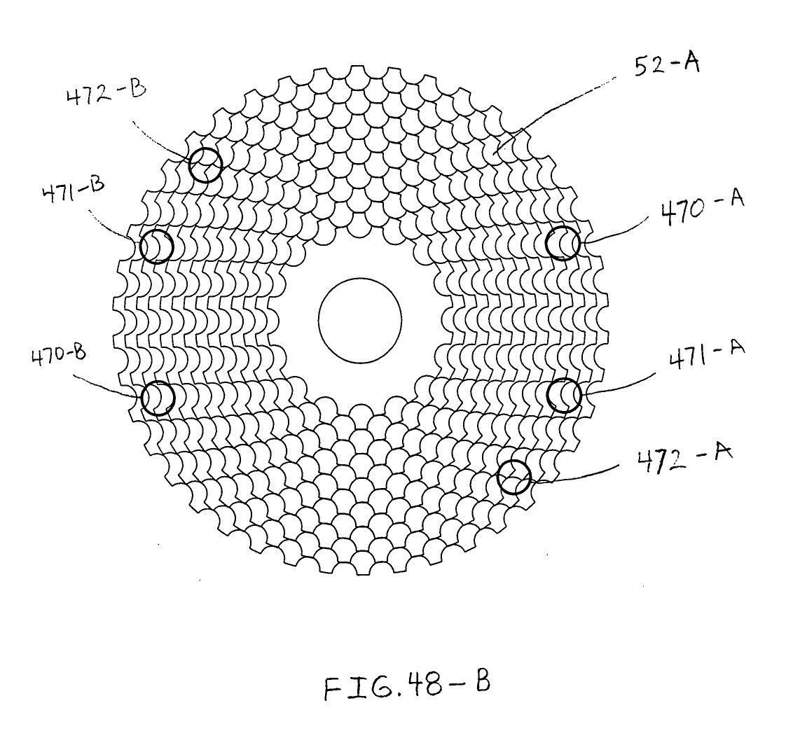

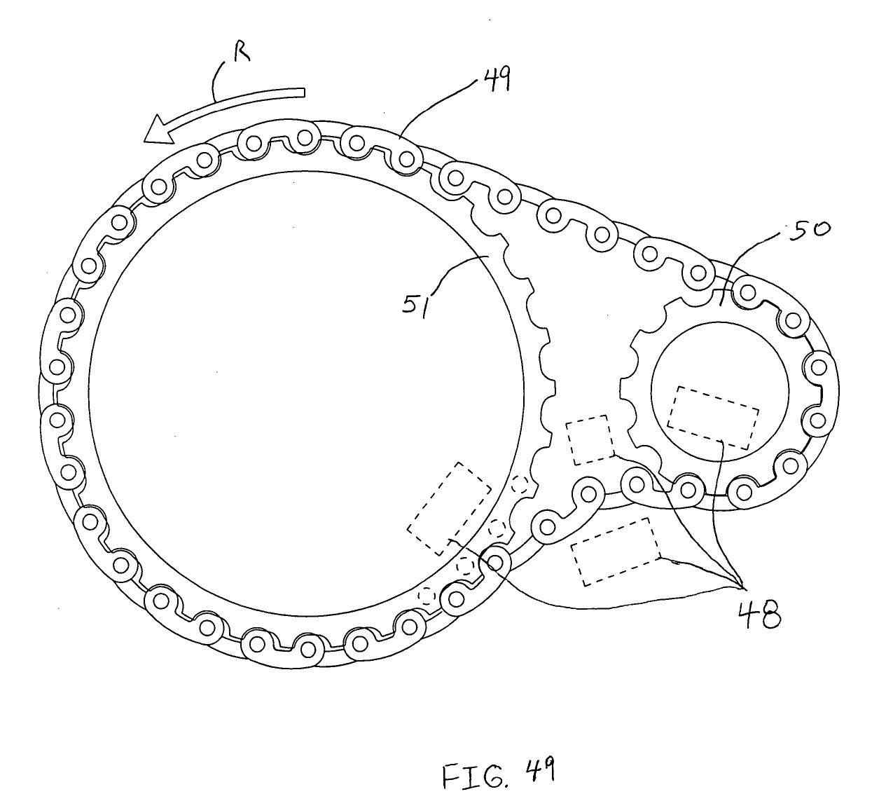

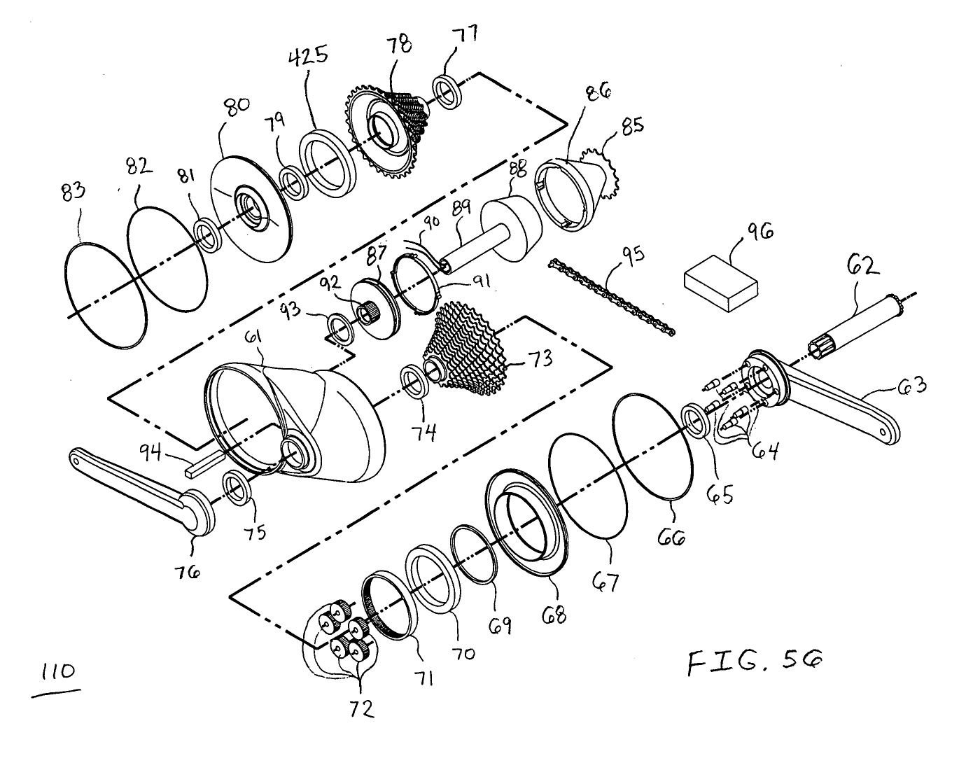

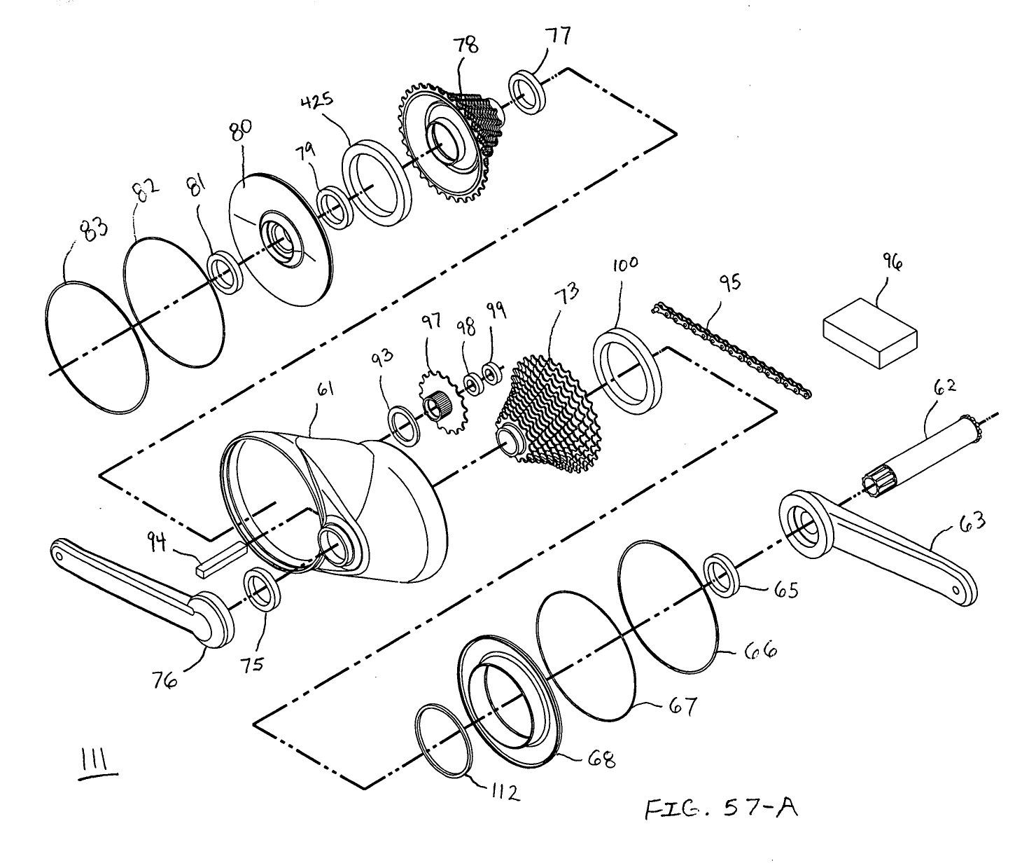

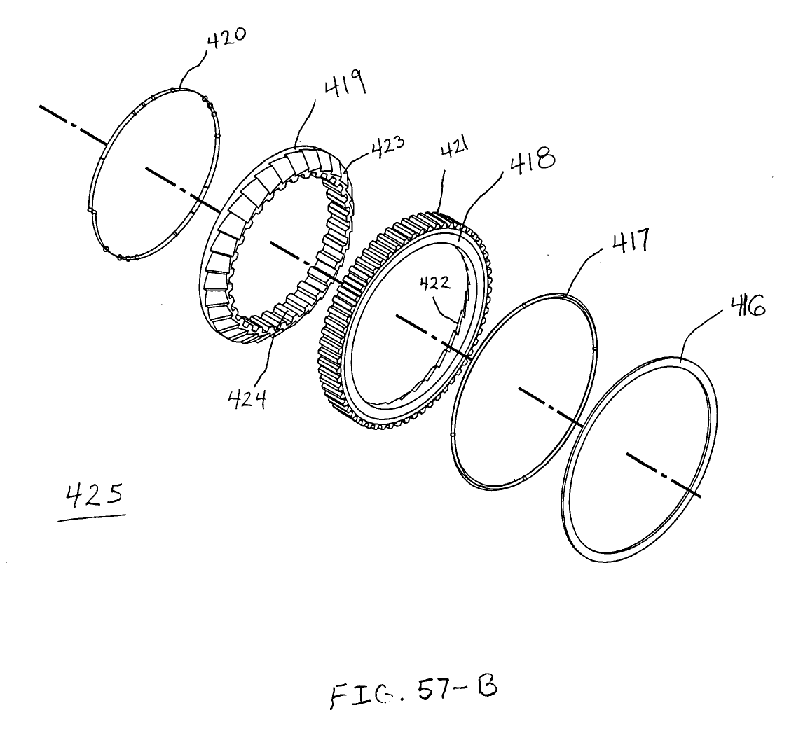

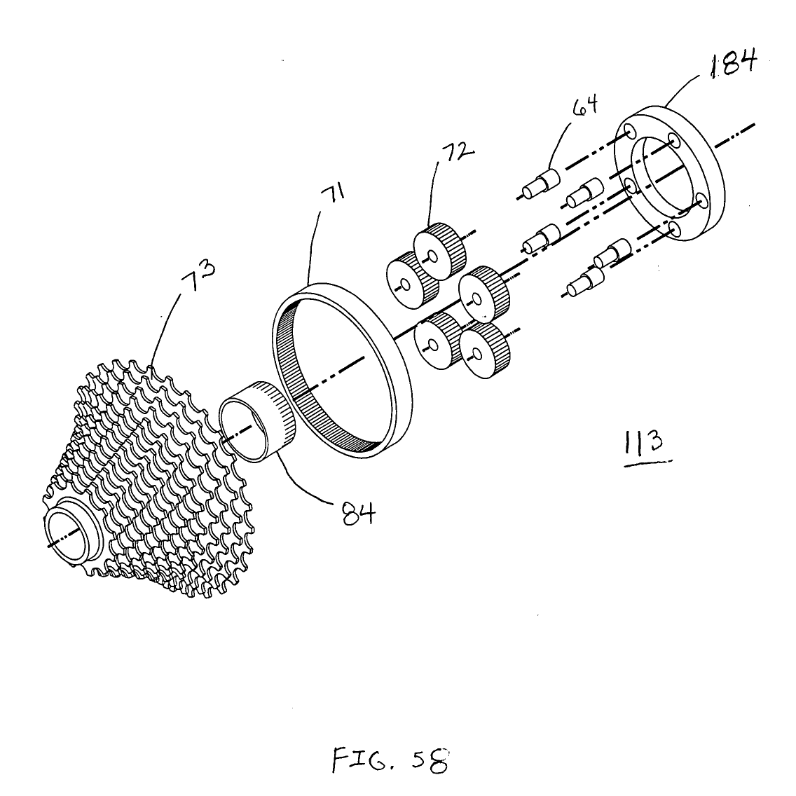

Proximity sensor 55 positioned as shown in FIG. 48-A inside the transmission carrier 52 measures the vector CS changes in position of the carrier and the location of the endless loop cross section 28 on the carrier. Sensor cable 56 transmits the sensor signals to a controller such as the controller depicted in FIG. 56. Although only one sensor is shown, one or more sensors may be used in combination.

FIG. 48-B depicts approximate sensor locations for proximity sensor 55 of FIG. 48-A. Sensors 472-B and 472-A would provide signals for the index location initiation for the stepped profiles of transmission carrier 52-A. Sensors 470-A, 470-B, 471-A, and 471-B provide the index shift zone information for a controller. Sensors send output signals to a controller such as the controller depicted in FIG. 56. The application of multiple sensors used in combination provide a highly accurate determination of the transmission carrier 52-A rotational position even at elevated rotational speeds.

FIG. 49 depicts an embodiment wherein the endless loop 49 made of a magnetic material remains engaged on the carrier 51 by a magnetic force provided by magnets 48 as shown. The magnetic force assists the endless loop 49 in staying engaged to the carrier profiles for a longer distance on the relaxed side of the carrier profile before the endless loop begins to transfer through space to carrier 50. The magnets 48 may be located at one or all of the locations outlined. Magnets may be located out from the carrier surface, also. They may be energized to push the endless loop 49 away from the carrier element diameter to assist in a shift process and pull the endless loop 49 to the carrier element diameter to maintain a completed shift process. A magnetic field control circuit is controlled through rotational position switches, cams, solenoids, or a controller that sends a signal to the magnetic control circuit. The magnet arrangement is also integrateable with an electricity generator device.

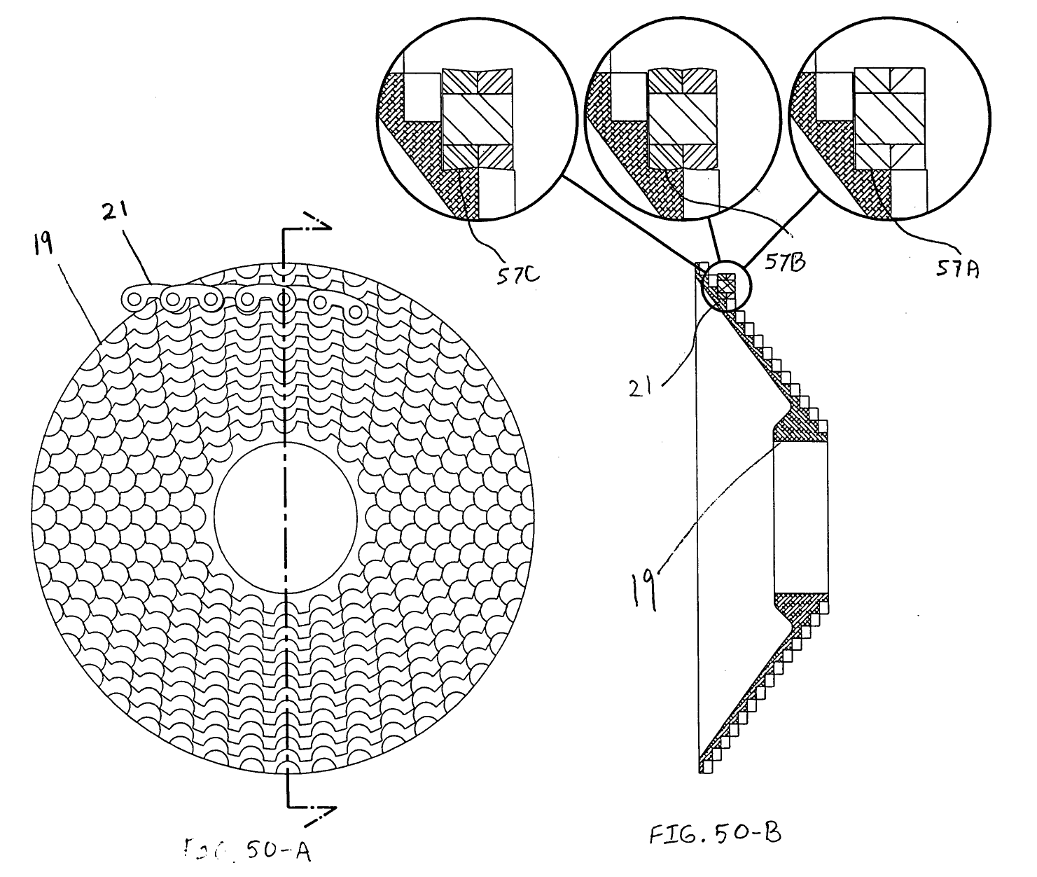

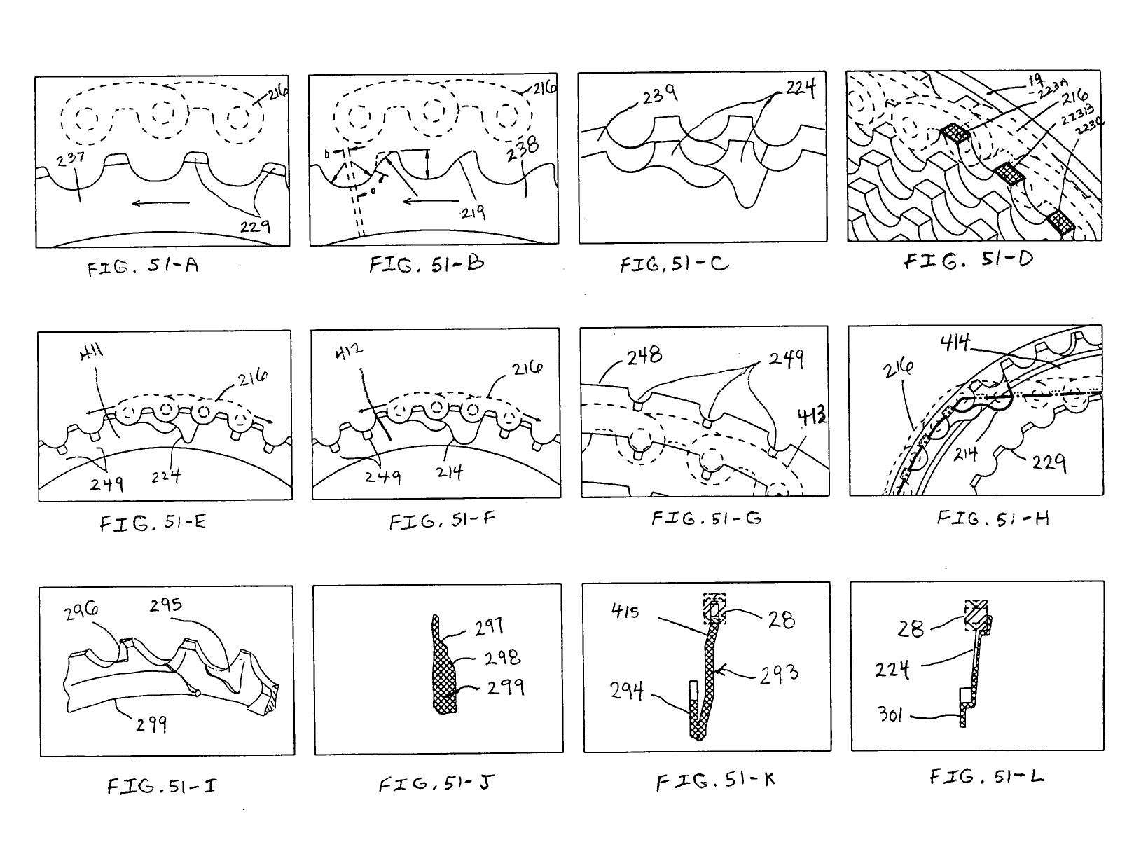

In FIG. 50-A, carrier 19 has multiple steps with profiled patterns to drive endless loop 21.

FIG. 50-B shows three embodiments of bottom edge profiles on the profiled pattern for the bottom edge of endless loop 21. Profile 57 ‘A’ is straight and uniform across the bottom edge width. Profile 57 ‘B’ has two radial sections across the bottom width for engagement. Profile ‘C’ is an inverted taper that centers in the middle of the bottom edge. These profiles assist in aligning the bottom edge of the endless loop 21 with the carrier's stepped profiles. The shaped surfaces assist in making a positive engagement that resists lateral deflections except when the endless loop 21 is purposely laterally shifted by shift mechanisms.

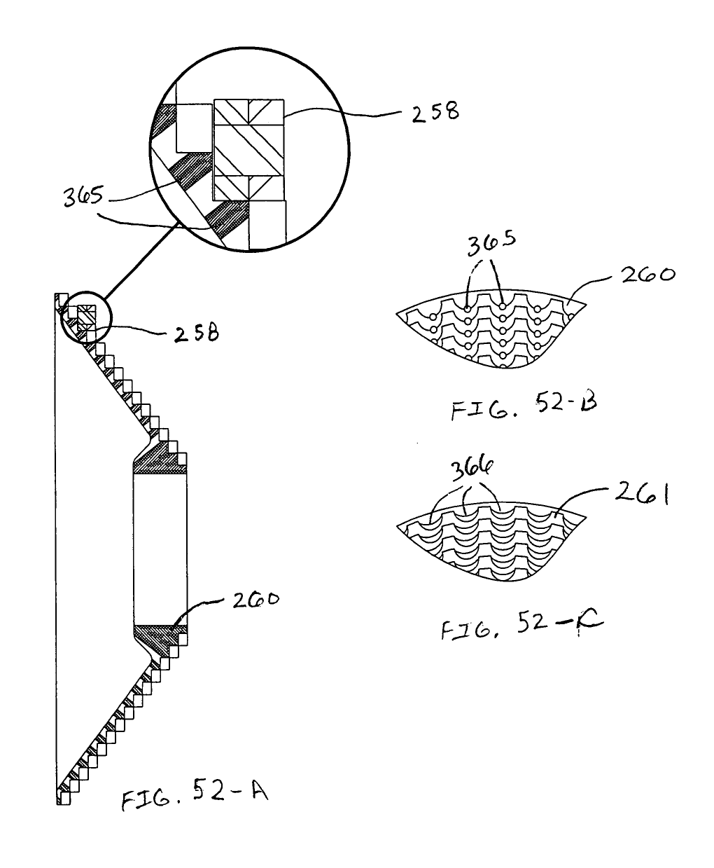

In FIGS. 51-A through 51-L, stepped gear profile modifications are depicted that when applied to the stepped gear clusters of FIG. 2 would aide in the lateral movement and control of the endless loop and the common engagement surfaces of the same.

In FIG. 51-A, transmission carrier stepped profile element 237 has chamfered profile edges 229 to assist in lateral movements of the endless loop 216. Chamfered profile edges are similar to those referenced from U.S. Pat. No. 4,348,200 Terada, September 1982.

In FIG. 51-B, gear profiles on transmission fixable element 238 may be modified as shown on gear shape 219 and are similar to reference U.S. Pat. No. 5,830,096 Schmidt et al., November 1998 to assist in the lateral movement of endless loop 216 and to allow for variations in the amount of stretch and assembly tolerance of the endless loop 216.

In FIG. 51-C, stepped gear profiles of transmission fixable element 239 has a side clearance portion similar to that shown in reference U.S. Pat. No. 5,545,096 Su, August 1996. The side clearance portion provides a transitional support surface during the lateral transfer of endless loop elements from a larger diameter element to a smaller diameter element on a transmission carrier.

FIG. 51-D is a depiction of the contact surfaces of the stepped gear profiles of transmission carrier 19. During an endless loop 216 lateral transfer between stepped profiles the contact surfaces 223A, 223B, and 223C will provide a transition of engagement as the endless loop lateral shifts to a smaller stepped gear profile diameter.

In FIG. 51-E, gear profiles on transmission fixable element 411 may be modified by a combination of clearance 224 similar in shape as shown in reference U.S. Pat. No. 5,545,096 Su, August 1996 and recesses 249 similar in shape as shown in reference U.S. Pat. No. 6,013,001 Miyoshi, January 2000.

In FIG. 51-F, stepped gear profiles on transmission fixable element 412 may be modified by a combination of clearance 214 similar in shape as shown in U.S. Pat. No. 5,609,536 Hsu, March 1997 and recesses 249 as shown in U.S. Pat. No. 6,013,001 Miyoshi, January 2000. The relieved portion of clearance 214 on the stepped profile will assist the endless loop element 216 transition between stepped gear profile diameters when lateral transfers are made. Recesses 249 assist in the ability for the stepped profiled gear surface to be free of debris.

In FIG. 51-G, gear profiles on transmission fixable element 248 that are shaped to drive the connecting pin of endless loop 413 similar in construction to the endless loop of FIG. 14-L may be modified with clearance shapes 249 as referenced by U.S. Pat. No. 6,013,001 Miyoshi, January 2000. The clearance shapes 249 allow for debris to not prevent the engagement of the endless loop 413 contact surface with the transmission carrier 248.

In FIG. 51-H, the stepped gear element 414 has a recessed portion 214 as referenced in U.S. Pat. No. 4,889,521 Nagano, December 1989. The recessed portion supports the endless loop 216 during a lateral movement transition to the next smaller diameter stepped profile 229 as shown.

In FIG. 51-I, gear profiles on transmission fixable element 299 are modified with clearance relief 296 and side portion recess 295 as per reference U.S. Pat. No. 5,192,249 Nagano, March 1993.

In FIG. 51-J, a stepped gear profile cross section 299 is shown similar to reference U.S. Pat. No. 6,666,786 Yahata, December 2003. Clearance shape 297 and clearance radius 298 assist in the endless loop lateral transfers between stepped profile diameters.

FIG. 51-K depicts an endless loop cross section 28 on a fixable element 293 outer gear profile. Fixable element 293 has a tapered angle 415 on the side that assists in the transfer of the endless loop cross section 28 to the smaller diameter fixable element 294.

FIG. 51-L depicts the clearance portion 224 as shown in FIG. 51-E on transmission carrier 301. Endless loop cross section 28 is a reference for the endless loop position prior to a lateral shift.

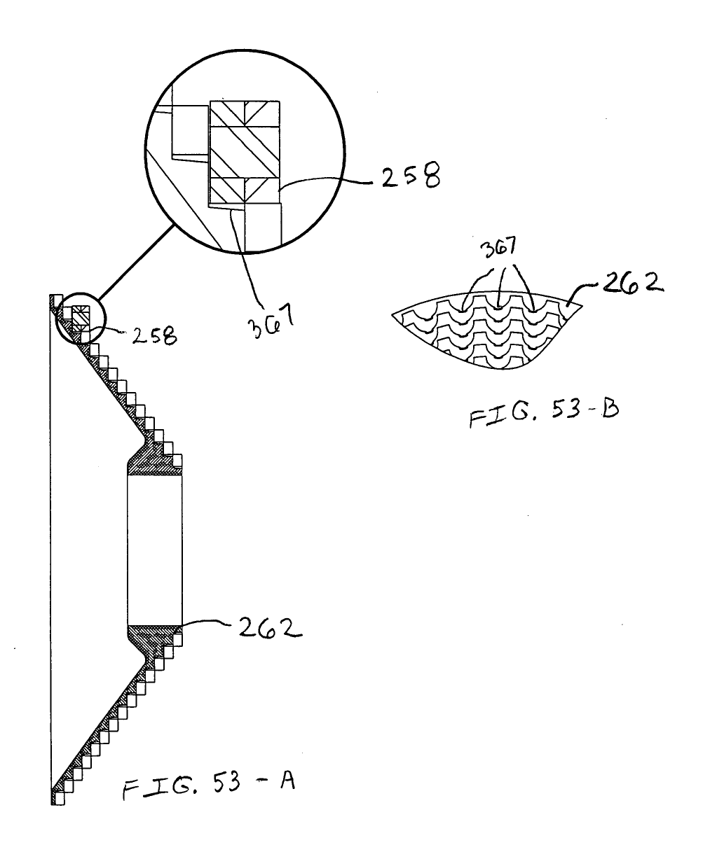

In FIGS. 52-A and 52-B, a transmission carrier 260 with stepped profiles has holes 365 through the profiled stepped surfaces. Debris and small bits of material are transferable from the contact surface of the carrier and the endless loop as represented by endless loop cross section 258. The ability to shed the debris reduces the friction caused by uneven gear profile contact surfaces.

FIG. 52-C shows a variation of the through hole embodiment. Chamfered slots 366 can also be used to shed debris as shown on transmission carrier 261 profiles.

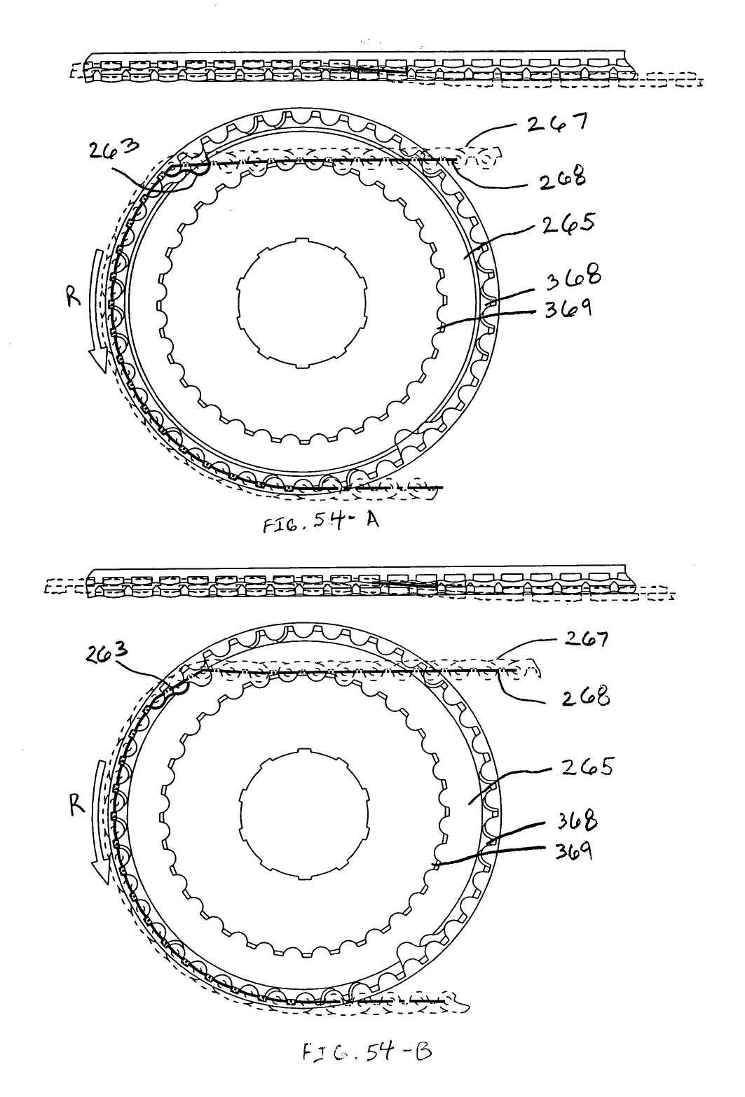

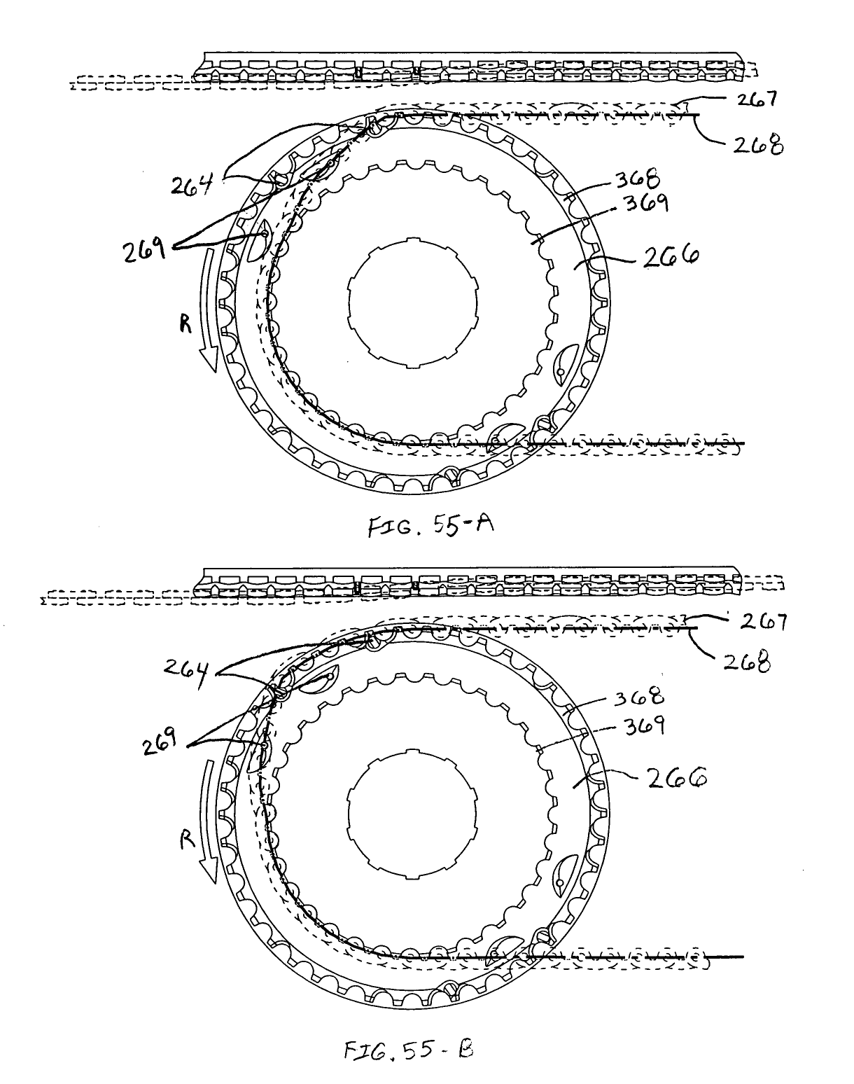

FIGS. 53-A and 53-B are further embodiments of mud or debris clearance methods on transmission carriers. Transmission carrier 262 has tapered recesses 367 under the profiled steps and this design does not require holes through the carrier surface.

In FIGS. 54-A and 54-B, transmission carrier 265 has two carrier elements with a large difference in diameter. The transfer of chain 267 across the large diameter difference is aided by selective profiled clearance cutouts as shown previously in FIG. 31-F into the sidewall of outer diameter element 368. Chain 267 is able to drop into the clearance area 263 during the rotation R of transmission carrier 265. The chain path 268 now shows that the chain 267 has an angle that is able to engage with the smaller diameter element 9.

In FIGS. 55-A and 55-B, transmission carrier 266 has two carrier elements with a large difference in diameter similar to transmission carrier 265. The wide difference in diameter creates a difficulty when attempting to shift from the smaller diameter to the larger diameter. Pins 264 and pins 269 installed into the outer diameter side face aide in the upshift of chain 267 from smaller diameter element 369 to the larger diameter element 368.

As transmission carrier 266 rotates in the R direction, chain 267 is supported by the pins 264 and 269 as the chain transfers to the larger diameter as shown in chainpath 268. These types of shift aides are similar to those depicted in reference U.S. Pat. No. 6,572,500 Tetsuka, June 2003.

Transmission carriers similar to those shown in FIG. 3 are utilized in the transmission assembly disclosed in FIG. 56 (REFERENCE is FIG. 14; from Improvements in Bicycle Systems and Method Provisional Application No. 60/610,944; Inventor: Darrell W. Voss; Filed Sep. 20, 2004), and the individual component parts of transmission assembly 110 are as follows:

### PARTS LIST

61—Case
62—Spindle
63—Crank A
64—Planetary Post
65—Bearing
66—Clip Ring
67—O-Ring Seal
68—Flange
69—Seal
70—Bearing
71—Ring Gear
72—Planetary Gears
73—Transmission drive carrier
74—Bearing
75—Bearing
76—Crank B
77—Bearing
78—Transmission driven carrier
79—Bearing
80—Flange
81—Bearing
82—O-Ring Seal
83—C Clip Retainer
85—Output Sprocket
86—Clutch Hub
87—Inner Clutch Hub
88—Generator/Alternator
89—Shaft
90—Generator/Alternator output wires
91—Clutch Bands
92—Sun Gear
93—Seal
94—Shift Device
95—Chain
96—Control box

In this illustration, the chain 95 is a single endless loop which is laterally moved by shift device 94 which is operated mechanically, hydraulically or electrically. In the case of electrically, the power for this comes from the generator/alternator 88 and/or a battery system. Control box 96 is mounted inside or external of case 61 and is powered by the generator/alternator 88 and/or a battery system. Various control inputs may be generated in sensor devices corresponding to those disclosed in the PCT application, reference Voss U.S. patent application Ser. No. 10/113,931 filed Apr. 2, 2002 and International Publication No. WO 2002/081257A3 entitled VEHICLES AND METHODS OF USING CENTER-OF-GRAVITY AND MASS SHIFT CONTROL SYSTEM. The transmission carriers 73 and 78 are essentially identical, but this need not be the case. In other words, one transmission carrier can be larger or smaller than the other and vice versa. One transmission carrier can also have more or less elements than the other and vice versa.

The chain 95 is an endless loop, that is the ends are connected together and is diagrammatically illustrated as a single straight piece section in FIG. 56. In this embodiment, the output sprocket 85 is coupled to the vehicle drive system via a clutch mechanism having clutch bands 91 mounted on clutch hub 87 which engage with recesses in outer clutch hub 86 only when rotating in the drive direction. Normally, the carrier 78 is not rotating unless crank 63 and crank 76 are rotating, even if the rear wheel is rotating. The clutch mechanism is mounted on stationary shaft 89 which engages a generator/alternator 88. Generator power is supplied only when the vehicle output shaft is turning whether through manual power, motorized input power, or gravity. The generator/alternator output wires 90 route through the inside of the stationary shaft 89 for connection to a battery and/or a control device. A planetary gearing system 72 and ring gear 71 are coupled to transmission drive carrier 73 which is the power input of the transmission and via the chain 95 coupled to the transmission driven carrier cassette 78 which is the ratio changed output of the transmission, which is clutched to the output sprocket 85 via outer clutch hub 86. When the rider apples torque through the pedals, the gearing transfers the rider's energy or power input via the stepup or stepdown transmission drive to the rear wheels. The transmission system assembly 110 can be an integral element in combination with the suspension and braking systems due to its compact features and centralized locations. While the transmission system shown in FIG. 56 is preferred, other speed change mechanisms may also be incorporated wherein. For example, the transmission system in combination with variable V-belt drives, hydraulic eccentric gear drives, hydrostatic drives, or toroidal fluid drives are within the scope of this invention.

Referring to FIG. 57-A, the transmission system assembly 111, similar to transmission assembly 110 of FIG. 56, is without a planetary system installed. Clutch assembly 100 allows the crank 63 to be separate from the drive carrier such as when the vehicle is going down an incline and gravity provides the energy needed for the vehicle motion. Output sprocket 97 is the external drive output connection.

FIG. 57-B discloses an embodiment of a clutch assembly 425 similar to clutch assembly 100 of FIG. 57-A. Retainer 416 captures o-ring 417 against one flat side face of outer clutch ring 418. Outer clutch ring 418 has a spline profile 421 on the outer diameter for load transfer. The outer clutch ring 418 has a convex tapered helical toothed pattern 422 on the opposite side face. The face with the convex tapered helical toothed pattern 422 meshes with the side face of inner clutch ring 419 which has an opposing concave tapered toothed pattern 423. Inner clutch ring 419 has a spline profile 424 on the inner diameter for load transfer. Spring 420 applies a force to the opposite side face of inner clutch ring 419. The spring 420 applies a consistent load to mesh the helical faces of the inner clutch ring 419 and outer clutch ring 418. The two clutch rings are driven together when a rotation occurs in the same direction as the helical faces mesh. The clutch rings do not drive each other when one or the other ring is not driven in the same direction. The helical angle of the meshed faces allows the clutch rings to spring apart and rotate independent of each other when not driven in the same direction.

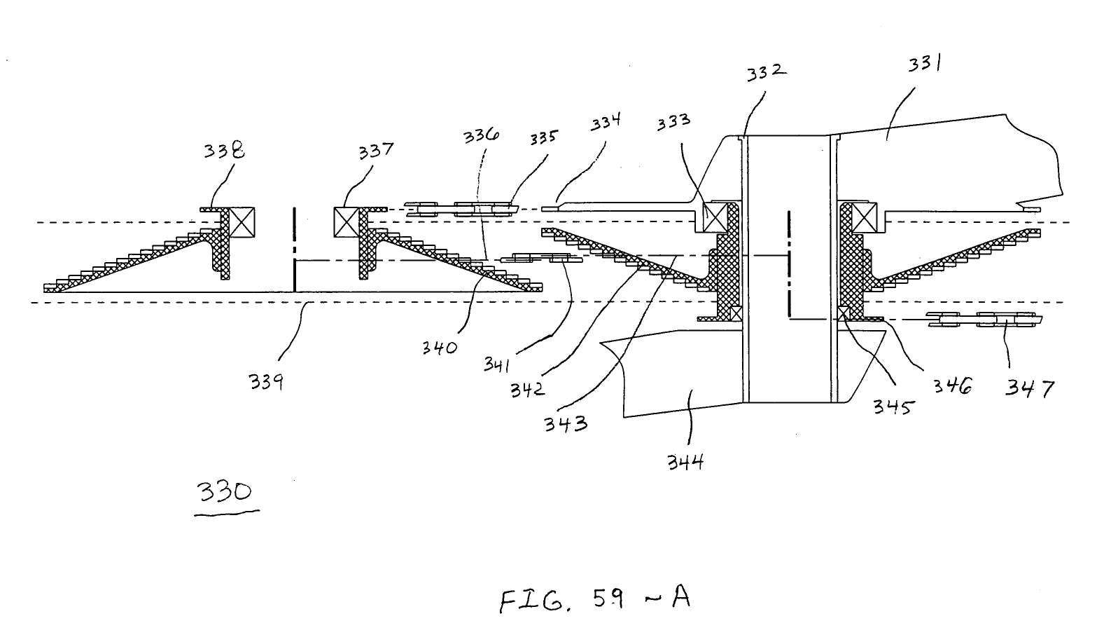

In FIG. 58, a planetary system assembly 113 is disclosed. Transmission carrier 73 is coupled with outer sun ring 71. Planetary gears 72 engage with the sun gear 71 and the inner drive ring 84 which is connected to a shaft (not shown). The planetary gears 72 mount on planetary posts 64. Planetary posts 64 are mounted to mounting ring 184. Transmission input energy in the form of rotational speed will drive the planetary gears 72 to provide a speed increasing effect as the gears mesh with the sun gear 71. The transmission carrier 73 will rotate at higher revolutions per minute than if directly connected to the transmission input device. This in effect, reduces the frictional forces and loads at the transmission carrier element contact interfaces with a coupling element such as chain 95 of FIG. 56.

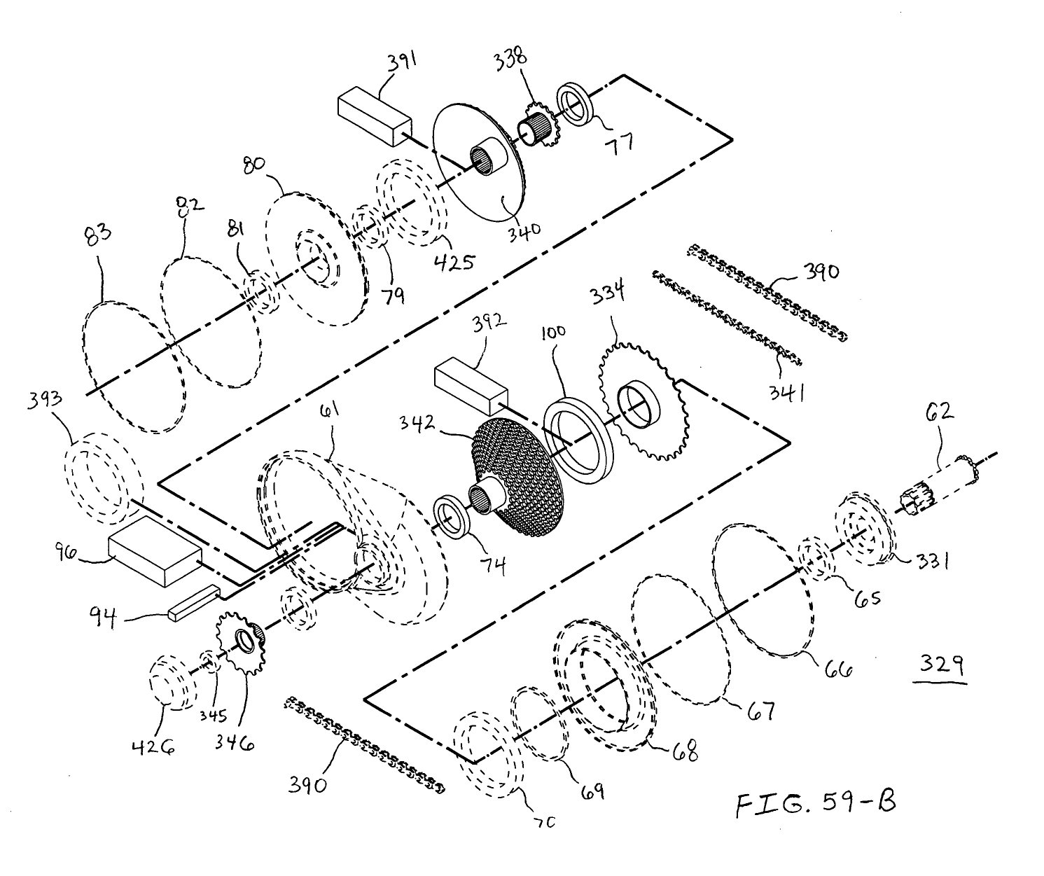

In FIG. 59-A, transmission carriers based on the narrow carrier form shown in FIG. 4-B are incorporated into a transmission assembly 330 that is compact and has a narrower width in comparison to the carrier diameters. The transmission assembly 330 is also novel in respect to the transfer of the power input through drive input sprocket 334 that couples via drive input transfer chain 335 to a smaller diameter drive carrier input sprocket 338. The power input revolutions per minute are sped up through the large to small diameter transfer. The other novel aspect of this design is that the power input and power output is accomplished through the same axle centerline. Power inputs are through a drive input connecting axle 332 that is mounted internally to the driven transmission carrier 342 that is coupled to driven output sprocket 346 and driven output sprocket output endless loop element 347 which couples the output sprocket to the attached device whether the attached device is a wheel assembly for a vehicle, a flywheel for an energy storage device, a shaft for a power generator device, or similar system that uses transmission system outputs. The transmission drive carrier 340 and transmission driven carrier 342 are coupled together by endless loop element for stepped gear clusters 341. Power input is through drive input A 331 and drive input B 344 which are connected together by drive input connecting axle 332. Bearing 345 supports the output sprocket 346 about the outer diameter of the drive input connecting axle 332. Bearing 333 supports input loads at the opposite end of the drive input connecting axle 332 and the drive input sprocket 334. Bearing 337 internally supports the drive carrier input sprocket 338 which connects with transmission drive carrier 340. Chain path representations 336 and 343 show the engagement alignments of the endless loop element for stepped gear clusters 341 with transmission drive carrier 340 and transmission driven carrier 342 respectively. Support body 339 is the structure that contains the internal drive assembly 330.

In FIG. 59-B, a transmission assembly 329 similar to the transmission assembly of FIG. 59-A utilizes shift mechanism 392, as disclosed earlier herein, to control the endless loop 341 alignment and coupling to transmission driven carrier 342 and shift mechanism 391 to control the endless loop 341 alignment and coupling to transmission drive carrier 340. In this illustration, shift device 94 actuates shift mechanisms 392 and 391 singly or together so that the endless loop 341 is laterally moved to effect a drive ratio change. Shift device 94 is operated mechanically, hydraulically or electrically. In the case of electrically, the power for this comes from the generator 393 and/or a battery system. Control box 96 is mounted inside or external of optional case 61 and is powered by the generator 393 and/or a battery system. Various control inputs may be generated in sensor devices corresponding to those disclosed in the PCT application, reference Voss U.S. patent application Ser. No. 10/113,931 filed Apr. 2, 2002 and International Publication No. WO 2002/081257 A3 entitled VEHICLES AND METHODS OF USING CENTER-OF-GRAVITY AND MASS SHIFT CONTROL SYSTEM. Shaft 62 supports bearing 65 which is housed in carrier 331.

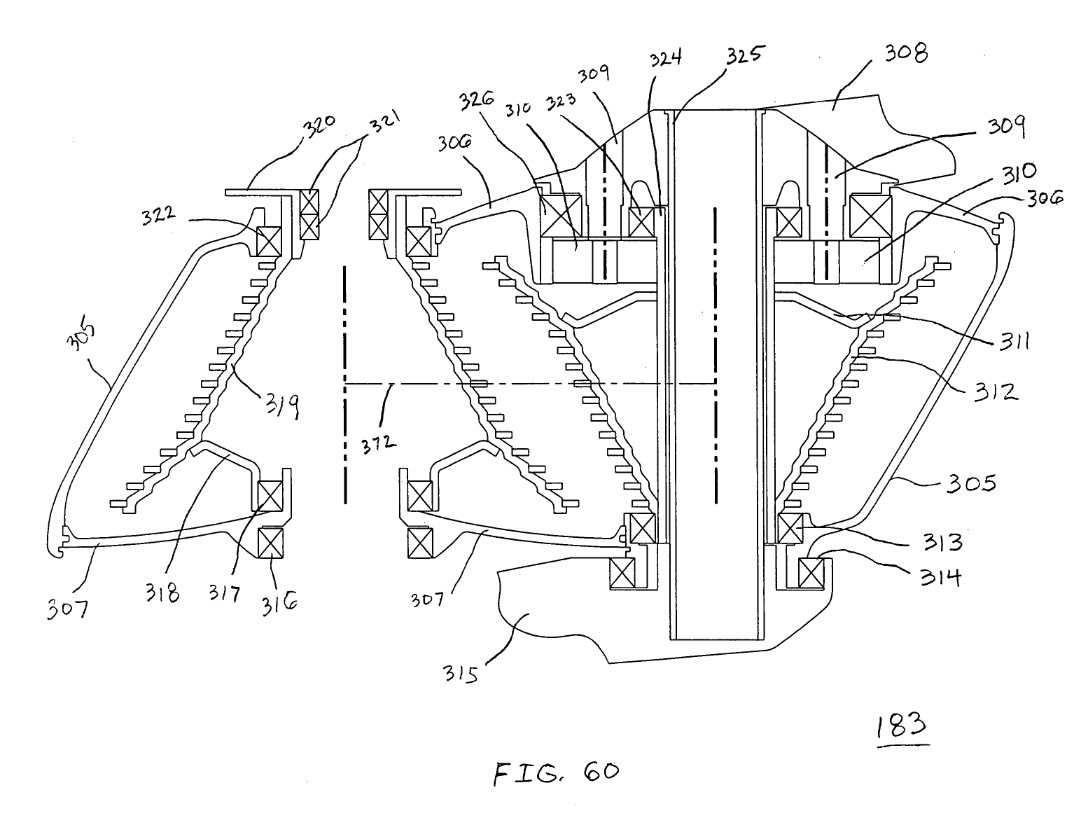

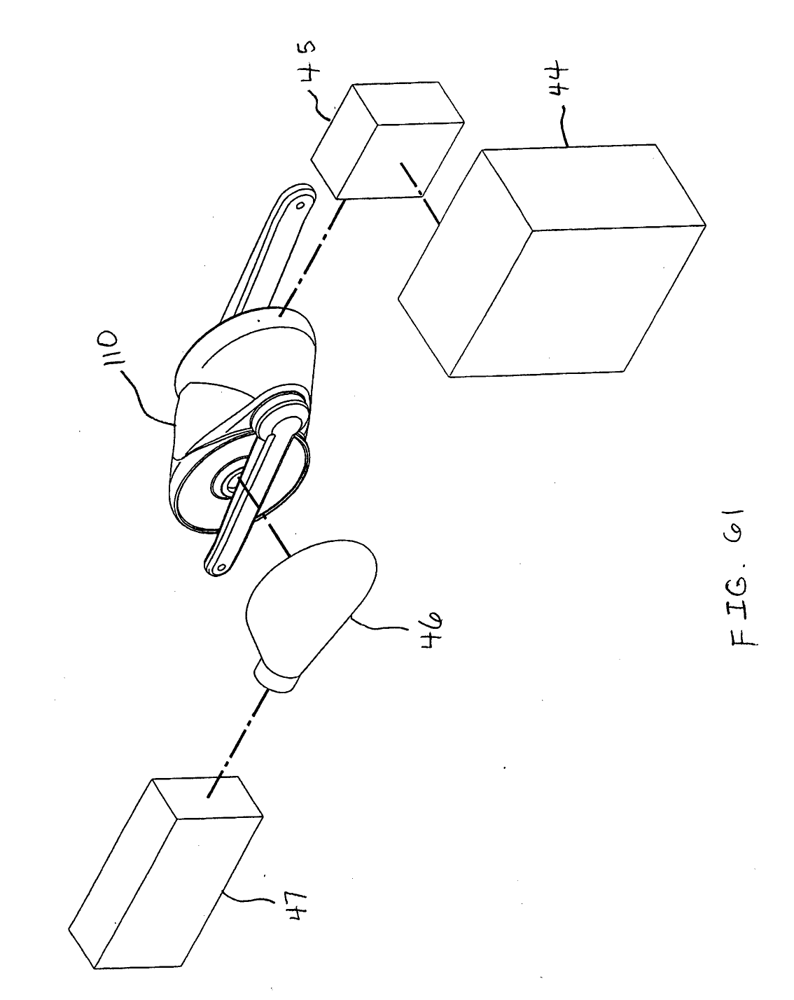

In FIG. 60, a transmission assembly is shown using transmission carriers similar in design to those shown in FIG. 1. Transmission assembly 183 is comprised of a transmission drive carrier 312 coupled by an endless loop represented by endless loop representative 372 to transmission driven carrier 319 to effect a drive to driven ratio. The transmission carriers each have fifteen fixable drive elements providing thirty one separate drive ratio outputs. Driven carrier 319 is supported by carrier support 318 on bearing 317. Main housing 305 connects with housing cover 307 where bearing 316 is nested. Power input 315 and 308 are mounted at the ends of transfer shaft 325. Carrier support 311 mounts to planet gear transfer 324. Planet gears 310 rotate around the planet gear posts 309 mounted into power input 308. Planet gears engage with the sun gear body 306. Outer bearing 326 supports the sun gear body 306 around power input 308. Inner bearings 323 supports the radial load of the planet gear transfer 324. Outer sprocket 320 is connected to driven carrier 319 and is supported by bearings 321. Power input 315 houses bearing 314 and carrier bearing 313 supports main housing 305. This carrier arrangement provides for a compact, efficient transmission assembly.

In FIG. 61, the transmission assembly 110 of FIG. 56 is shown coupled to a motor power supply 44 via clutch system 45. Output transfer assembly 46 connects the transmission assembly 110 output to an output transfer device 47. Output transfer device 47 may include but is not limited to a shaft drive, worm gears, chain drive, helical gears, spur gears, cable drive, or pulley belt.

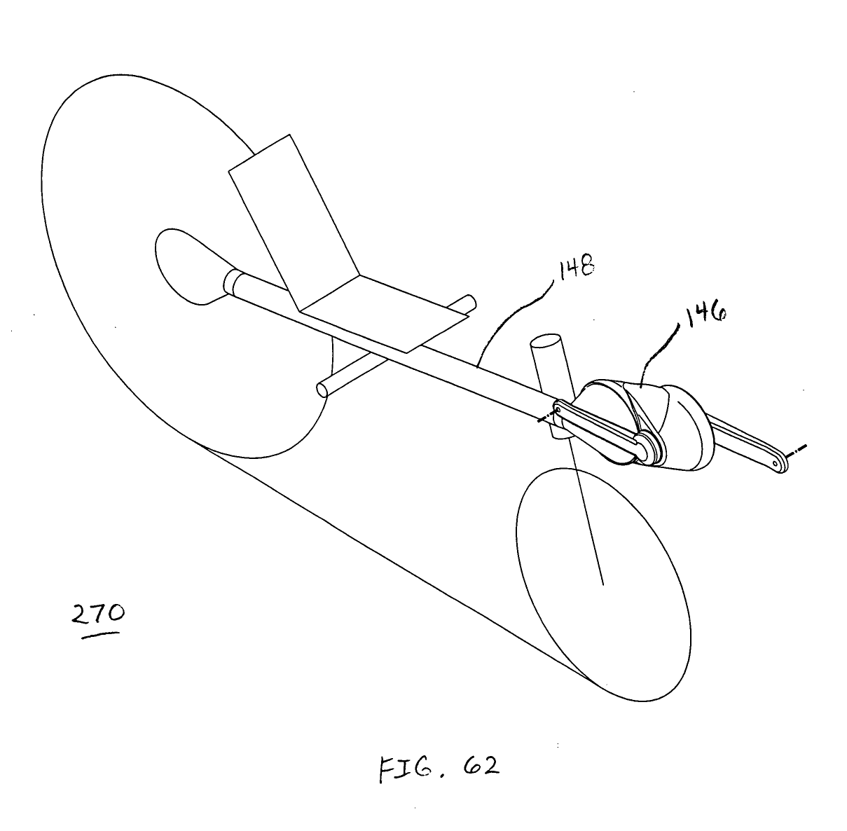

FIG. 62 refers to a representative recumbent bicycle assembly 270 and a novel transmission system disclosed herein. A transmission system 146 is coupled to the rear wheel by transfer device 148. The transmission system 146 is generally of the type disclosed in FIG. 56 herein.

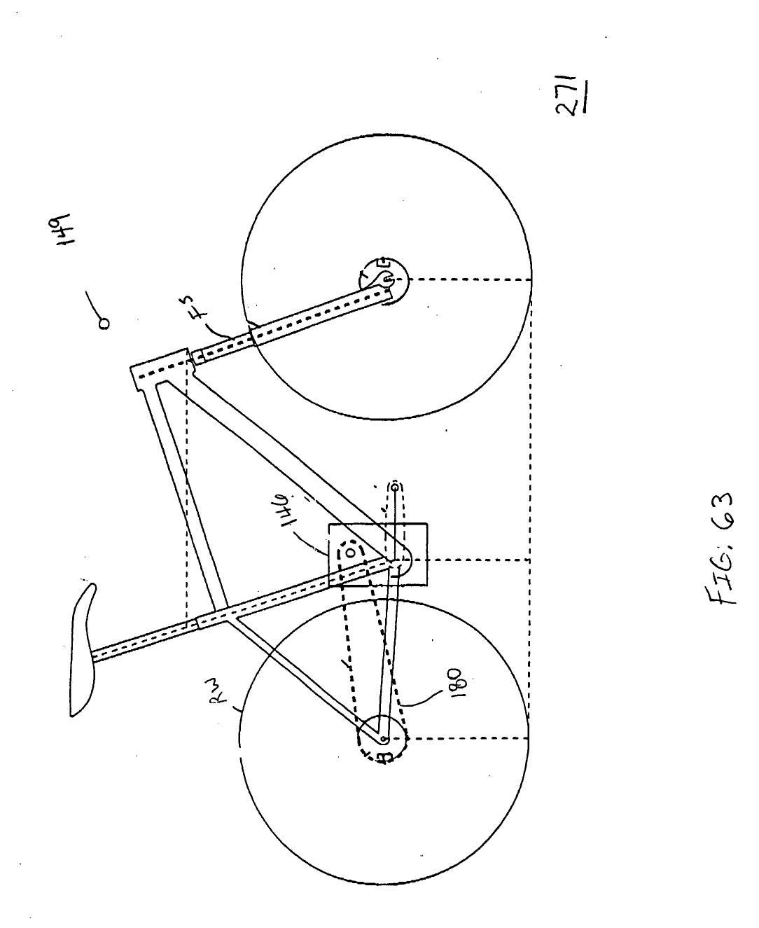

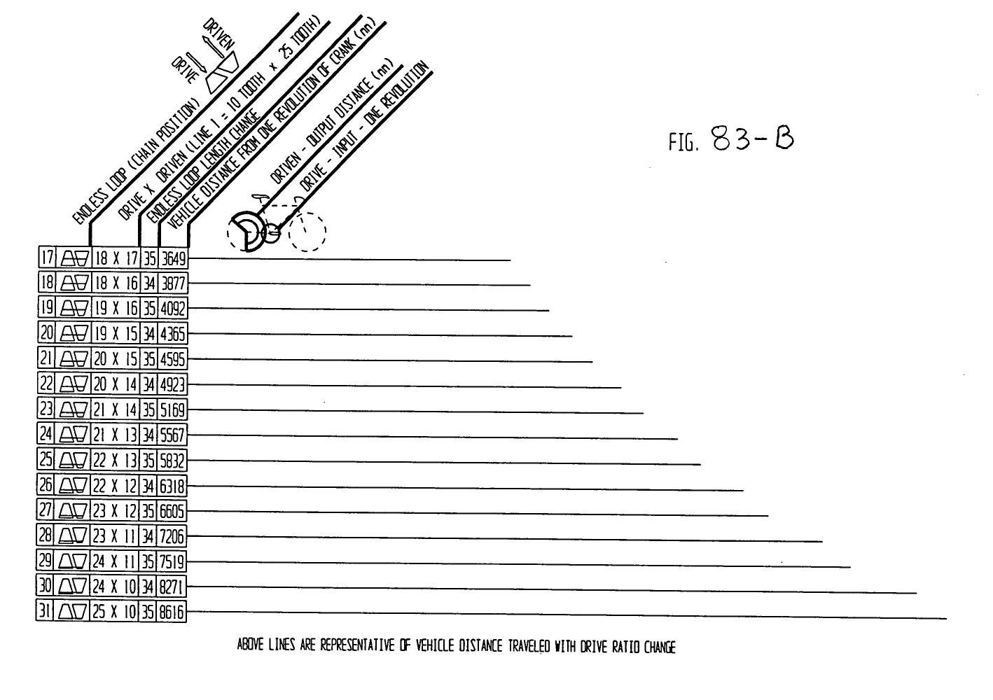

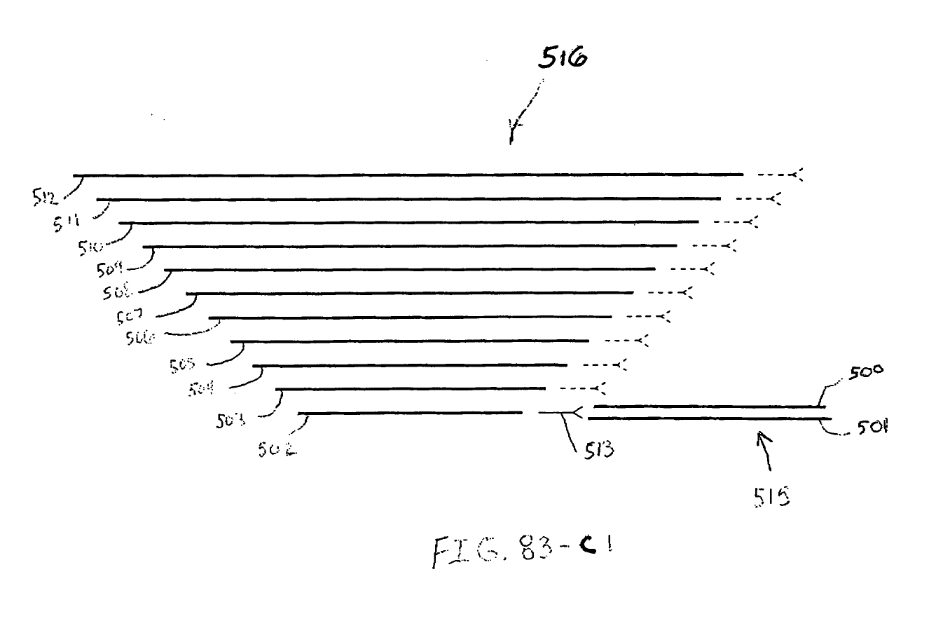

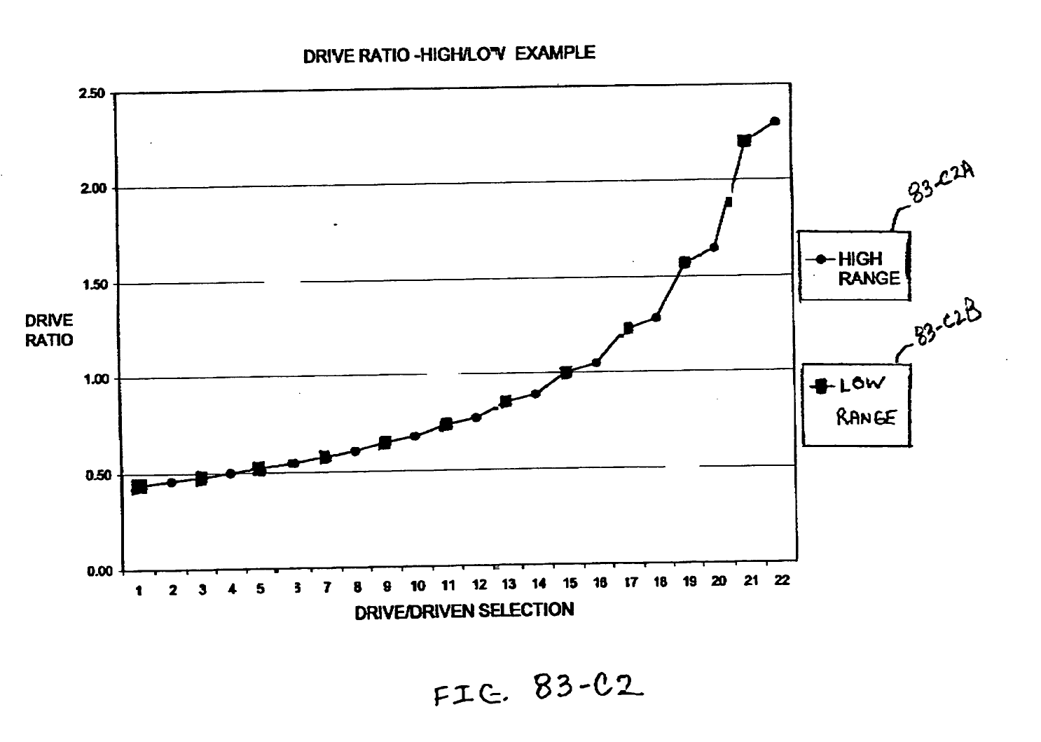

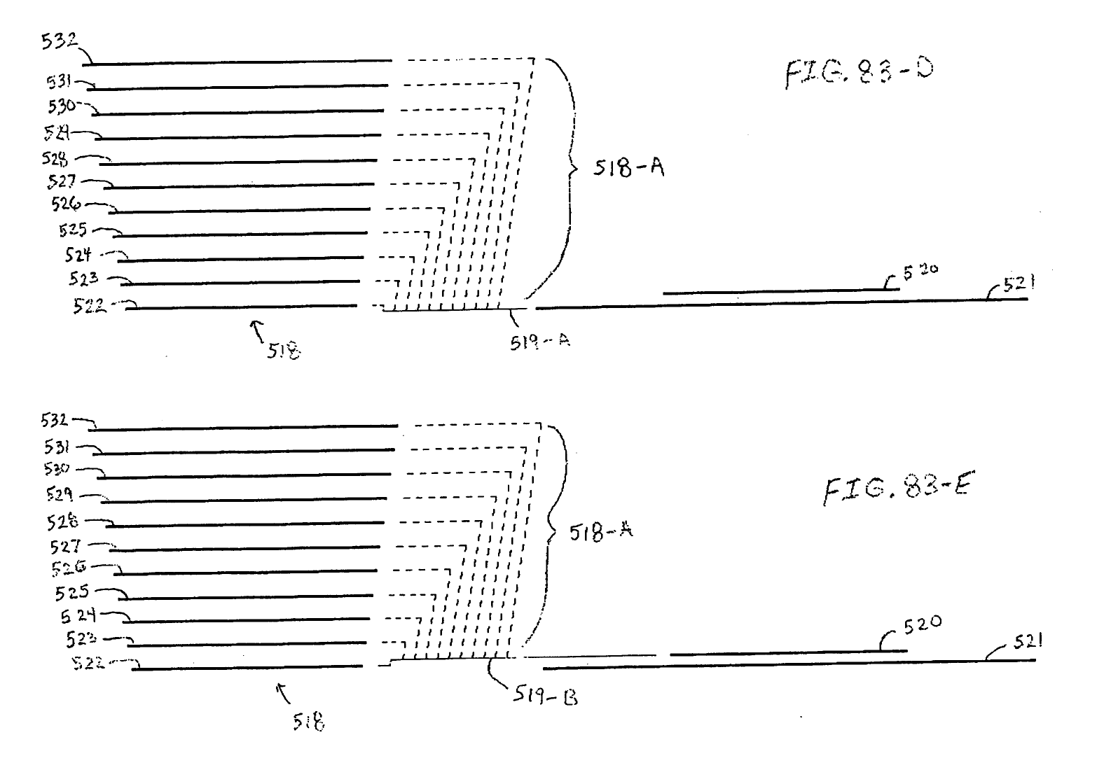

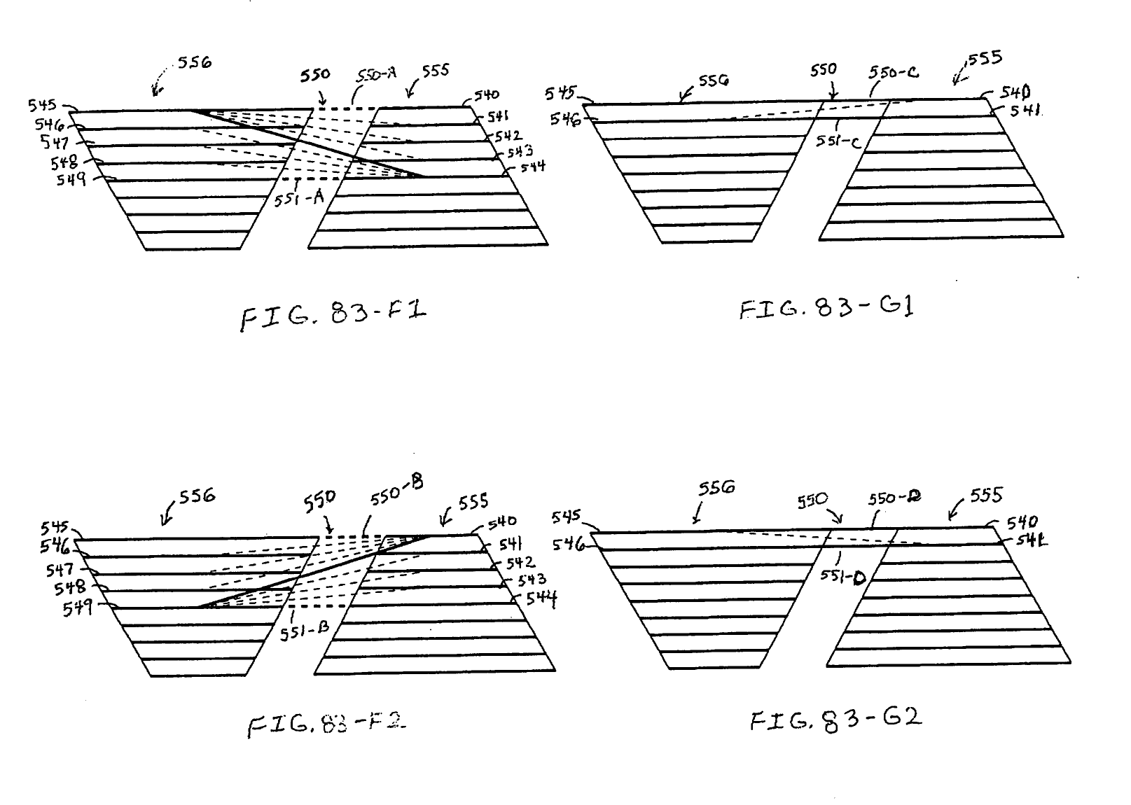

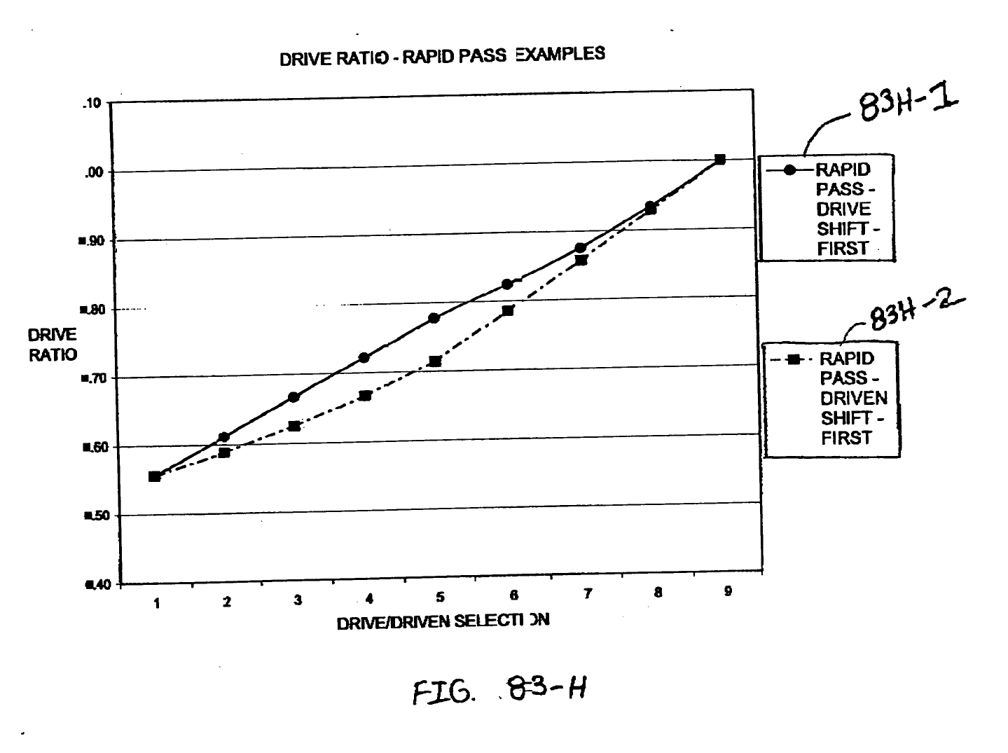

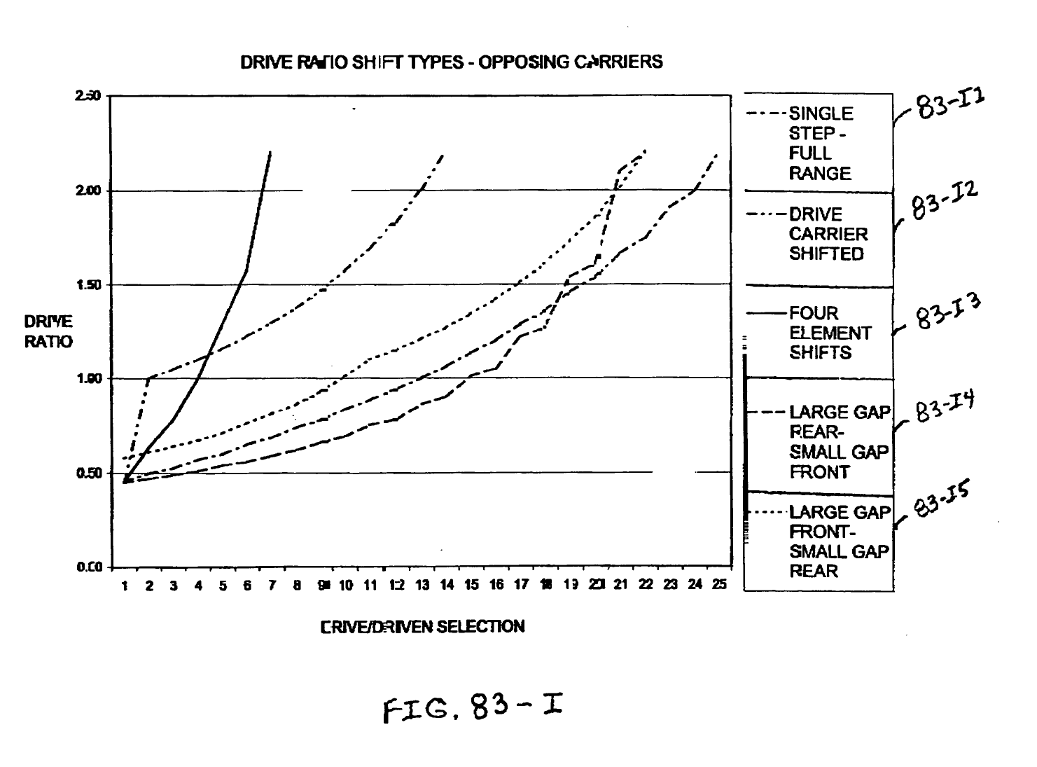

Referring to FIG. 63, a bicycle assembly 271 is comprised of a double triangle frame in the format of a mountain bicycle with a front shock suspension FS and handlebar 149 (REFERENCE is FIG. 1; from Improvements in Bicycle Systems and Method Provisional Application No. 60/610,944; Inventor: Darrell W. Voss; Filed Sep. 20, 2004). A transmission system 146 having a pedaling crank is coupled to the rear wheel RW by a sprocket chain 180. The transmission system is generally of the type disclosed in FIG. 56 herein and is adapted to provide drive ratios of the character diagrammatically illustrated in FIGS. 83-A & 83-B.

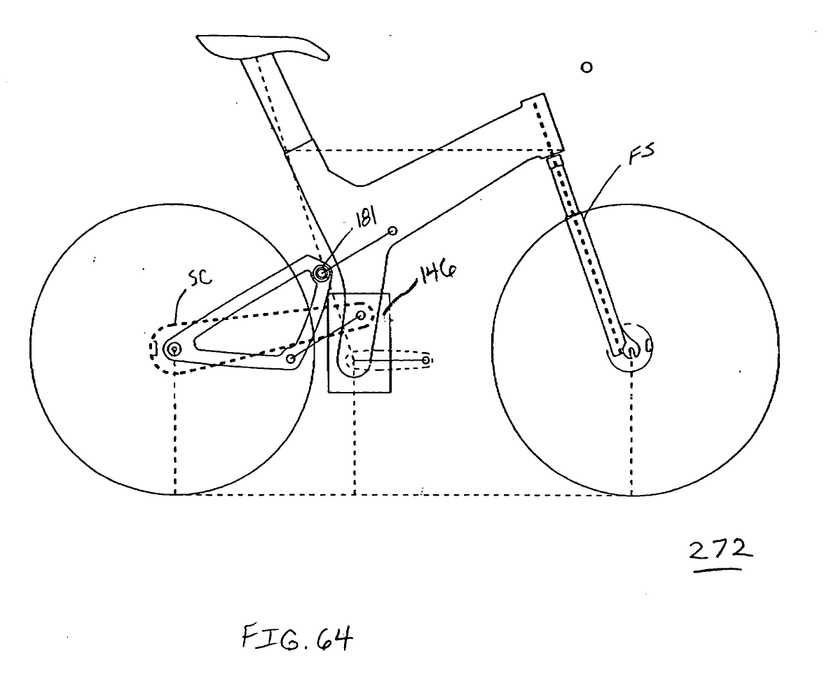

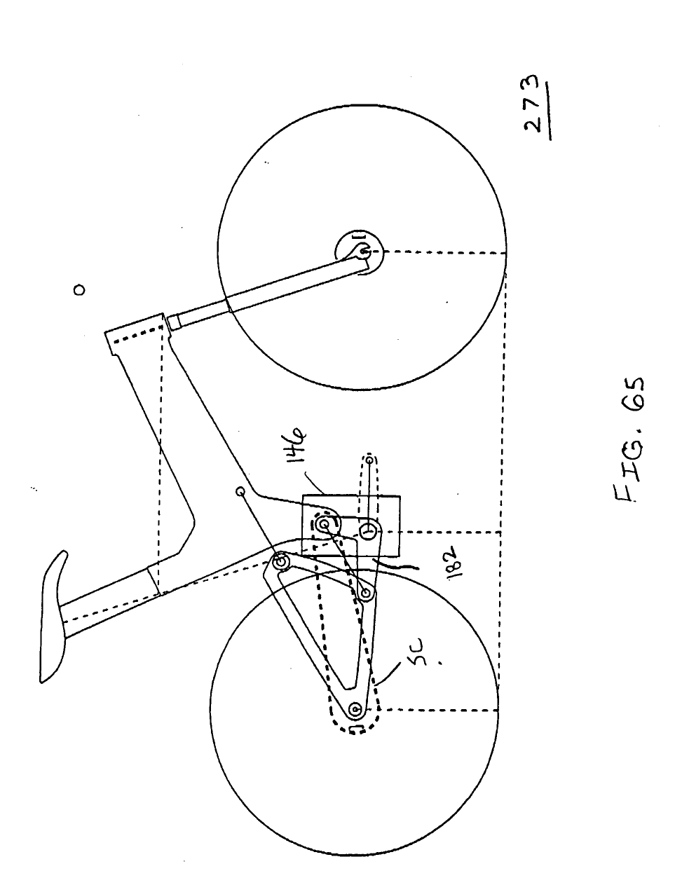

FIG. 64 is illustrative of a bicycle assembly 272 in which the front composite frame independently has the rear frame suspended therefrom and appropriate shock absorber 181 and shock absorber FS are appropriately positioned thereon (REFERENCE is FIG. 2; from Improvements in Bicycle Systems and Method Provisional Application No. 60/610,944; Inventor: Darrell W. Voss; filed Sep. 20, 2004). The transmission assembly 146 is generally of the type disclosed in FIG. 56 and is mounted to the front frame.

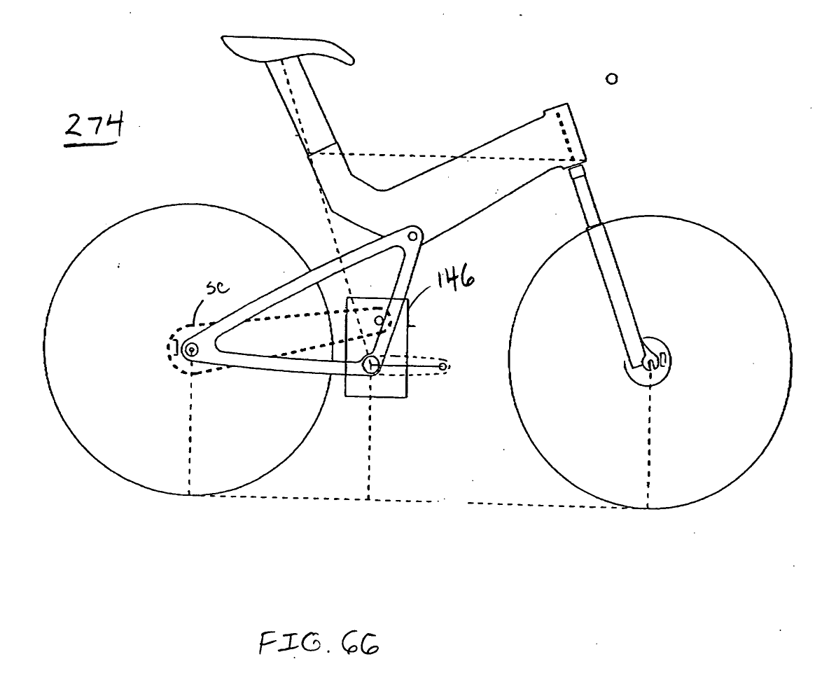

FIG. 65 depicts a bicycle assembly similar to FIG. 64 wherein bicycle assembly 273 has a transmission system 146 mounted from a bell crank lever 182 which is suspended from the front frame from which a rear frame is independently suspended therefrom (REFERENCE is FIG. 3; from Improvements in Bicycle Systems and Method Provisional Application No. 60/610,944; Inventor: Darrell W. Voss; filed Sep. 20, 2004). The transmission system 146 is generally of the type disclosed in FIG. 56 herein.

Referring to FIG. 66, the transmission system 146 is pivotally mounted to a rear triangle which is in turn pivotally connected to the front frame of bicycle assembly 274 (REFERENCE is FIG. 4; from Improvements in Bicycle Systems and Method Provisional Application No. 60/610,944; Inventor: Darrell W. Voss; filed Sep. 20, 2004). The transmission system 146 is generally of the type disclosed in FIG. 56 herein.

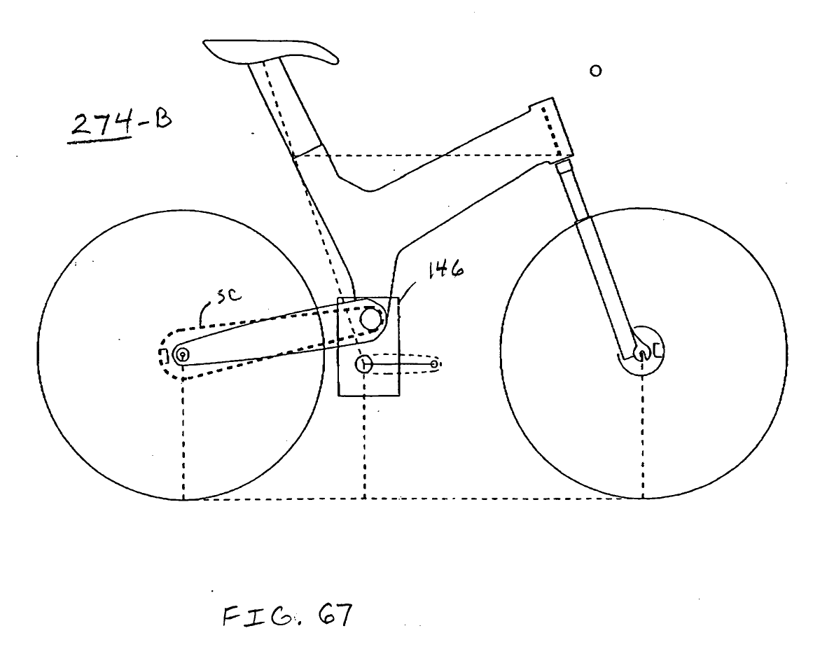

FIG. 67 is similar to FIG. 63 except that instead of a rear triangle, the rear wheel is cantilevered on a cantilever frame structure (REFERENCE is FIG. 5; from Improvements in Bicycle Systems and Method Provisional Application No. 60/610,944; Inventor: Darrell W. Voss; filed Sep. 20, 2004). The bicycle assembly 274-B has a transmission assembly 146 suspended from the main frame structure. Transmission assembly 146 is generally of the type disclosed in FIG. 56 herein.

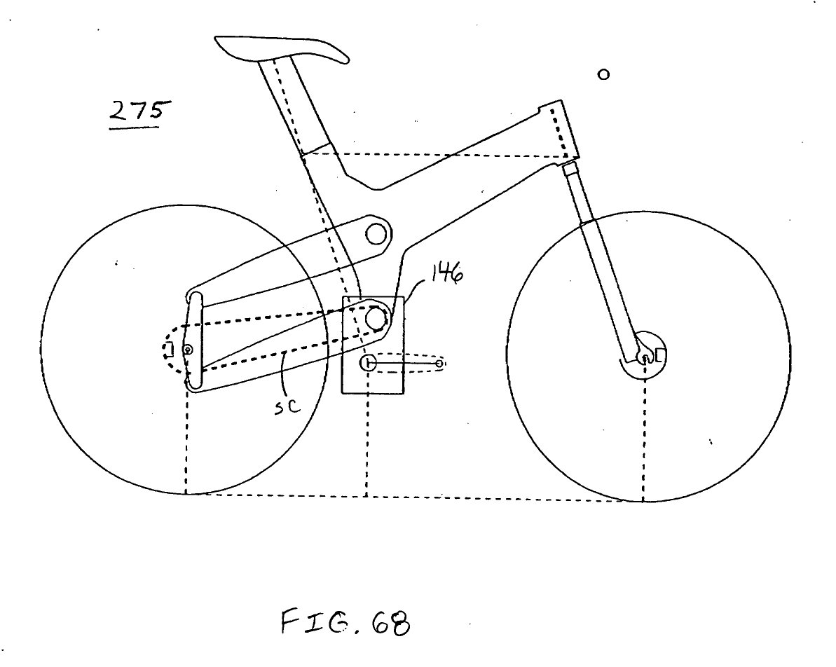

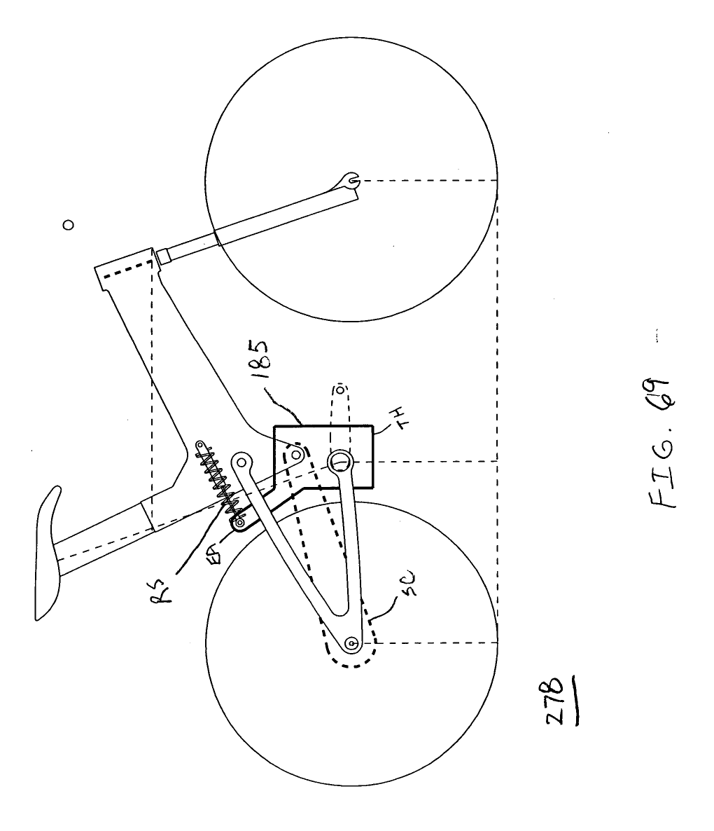

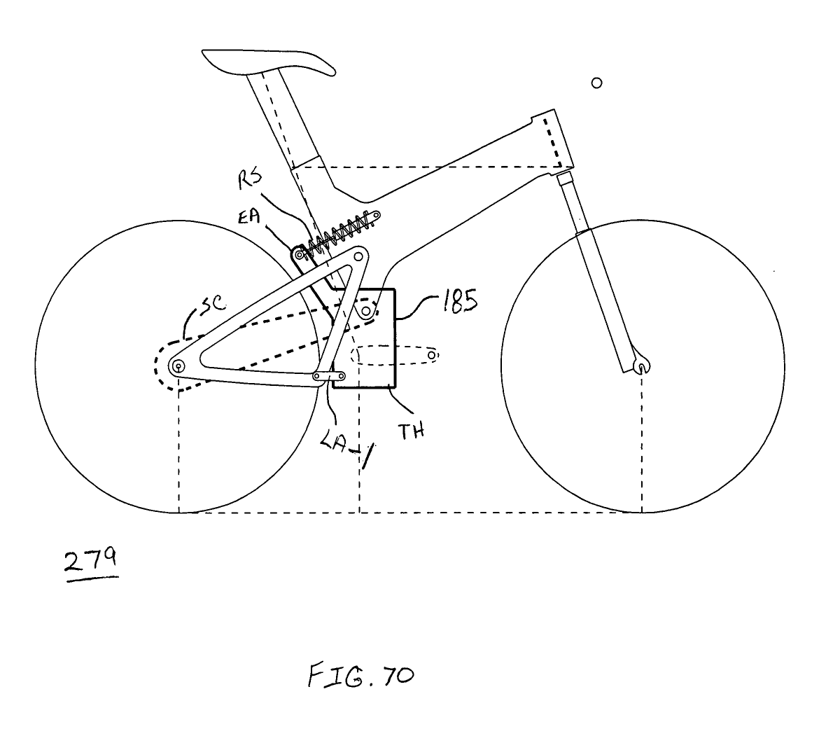

FIG. 68 is an embodiment of a transmission assembly similar to FIG. 63 except here in this case the transmission system 146 is coupled to the front frame and the rear wheel is mounted by a four-bar linkage system to the main front frame of bicycle assembly 275 (REFERENCE is FIG. 6; from Improvements in Bicycle Systems and Method Provisional Application No. 60/610,944; Inventor: Darrell W. Voss; filed Sep. 20, 2004). The transmission system 146 is generally of the type disclosed in FIG. 56 herein.

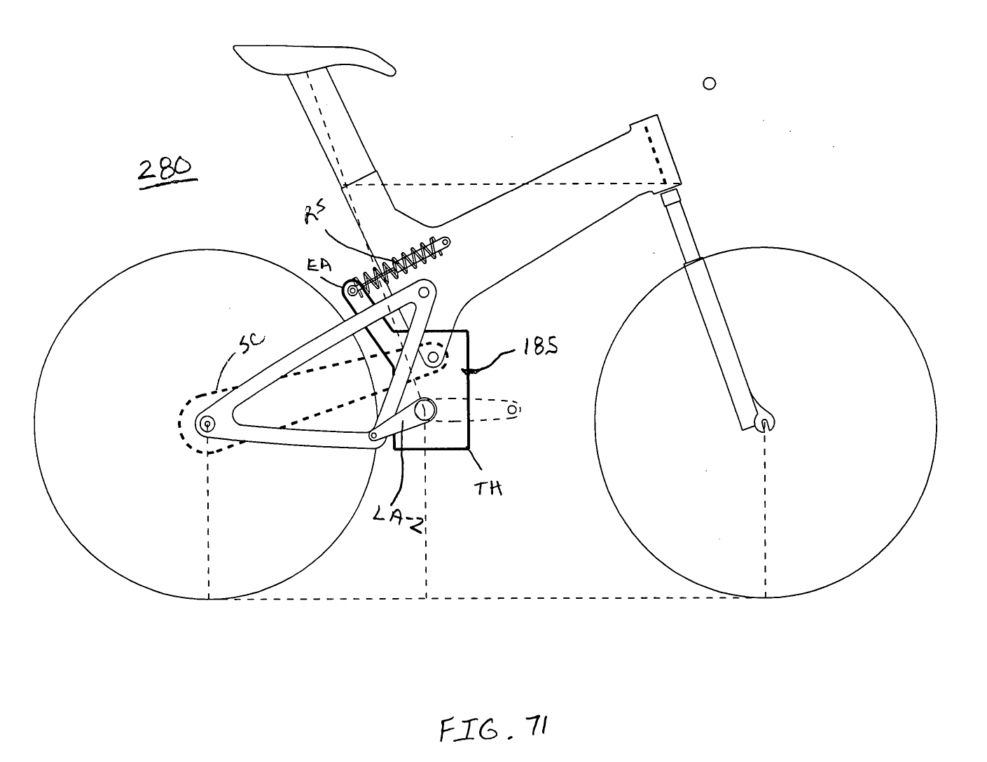

Referring to FIG. 69, the bicycle assembly 278 has a rear assembly that is pivotably mounted to the main frame and to transmission assembly 185. The transmission system 185 is pivotably coupled to the front frame and rotational movement is controlled by the rear shock assembly RS which is mounted to an extended arm EA from the transmission assembly housing TH. The other end of rear shock assembly RS is mounted to the main bicycle frame. The transmission system 185 is generally of the type disclosed in FIG. 56 herein.

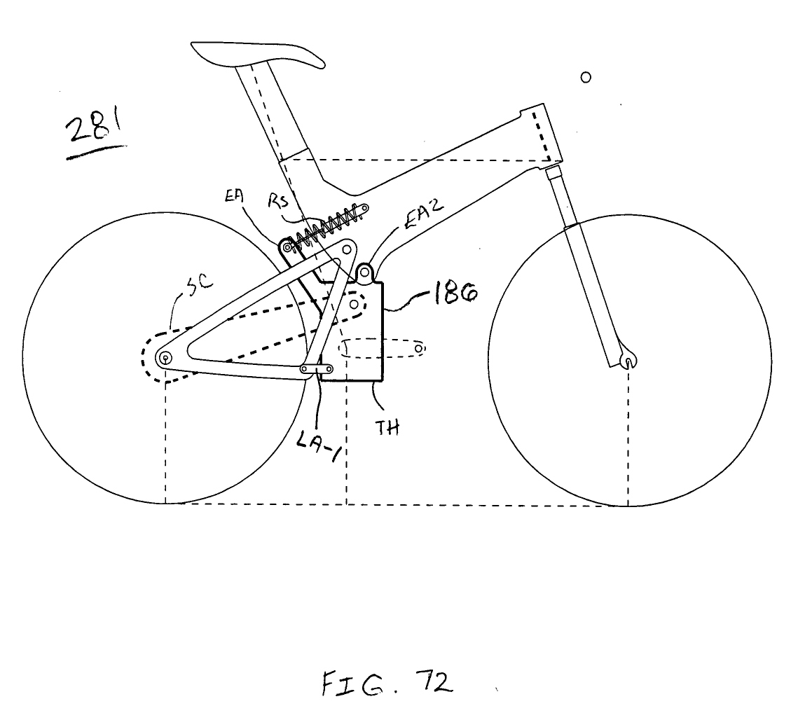

Referring to FIG. 70, the bicycle assembly 279 has a rear assembly that is pivotably mounted to the main frame and then to transmission assembly 185 by link assembly LA-1. The transmission system 185 is pivotably coupled to the main frame and rotational movement is controlled by the rear shock assembly RS which is mounted to an extended arm EA from the transmission assembly housing TH. The other end of rear shock assembly RS is mounted to the main bicycle frame. The transmission system 185 is generally of the type disclosed in FIG. 56 herein.

FIG. 71 is an embodiment of a bicycle assembly similar to FIG. 70 wherein bicycle assembly 280 has a rear assembly pivotably mounted to the main frame and then to transmission assembly 185 by link assembly LA-2 that pivots about the pedal crank input axis. The transmission system 185 is pivotably coupled to the main frame and rotational movement is controlled by the rear shock assembly RS which is mounted to an extended arm EA from the transmission assembly housing TH. The other end of rear shock assembly RS is mounted to the main bicycle frame. The transmission system 185 is generally of the type disclosed in FIG. 56 herein.

FIG. 72 is an embodiment of a bicycle assembly similar to FIG. 70, except that the bicycle assembly 281 has a rear assembly that is pivotably mounted to the main frame and then to transmission assembly 186 by link assembly LA-1. The transmission system 186 is pivotably coupled to the main frame by extended arm EA2 and rotational movement is controlled by the rear shock assembly RS which is mounted to an extended arm EA from the transmission assembly housing TH. The other end of rear shock assembly RS is mounted to the main bicycle frame. The transmission system 186 is generally of the type disclosed in FIG. 56 herein.

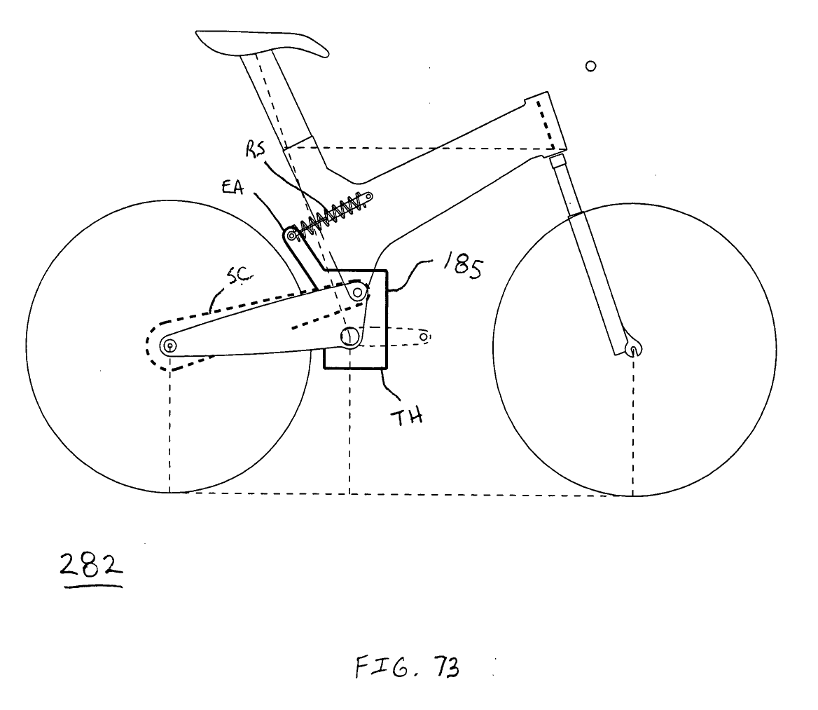

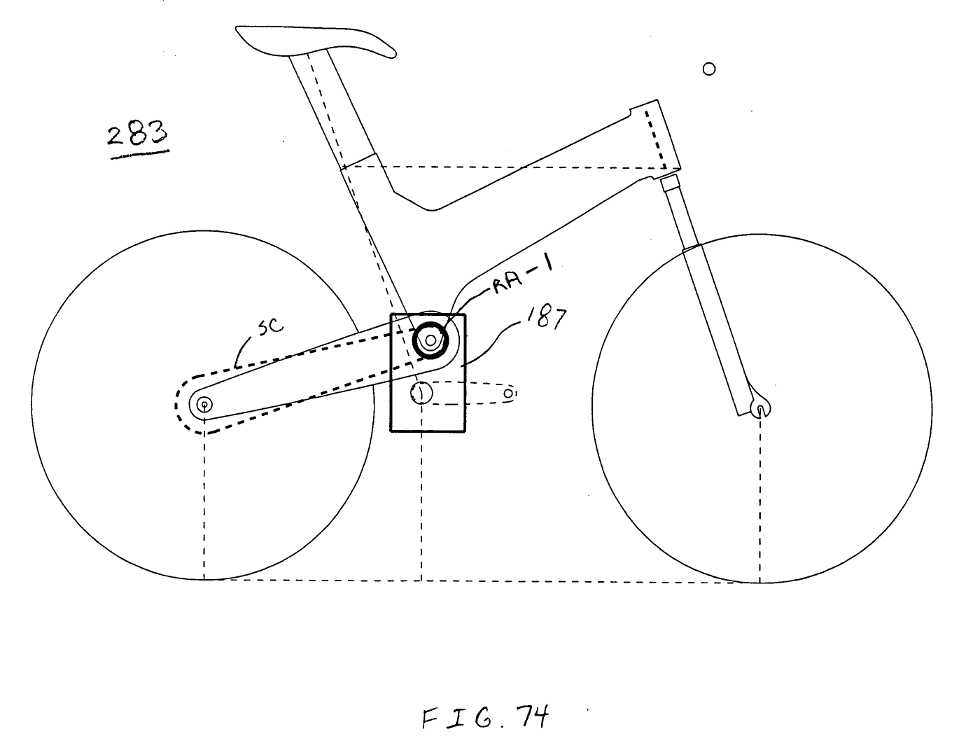

FIG. 73 is an embodiment of a bicycle assembly similar to FIG. 70, except that the bicycle assembly 282 has a rear assembly that pivots about the pedal crank input axis of transmission assembly 185. The transmission system 185 is pivotably coupled to the main frame and rotational movement is controlled by the rear shock assembly RS which is mounted to an extended arm EA from the transmission assembly housing TH. The other end of rear shock assembly RS is mounted to the main bicycle frame. The transmission system 185 is generally of the type disclosed in FIG. 56 herein.

Referring to FIG. 74, the bicycle assembly 283 has a rear assembly that is pivotably mounted to the main frame and rotational movement is controlled by the rubber shock assembly RA-1 which is mounted on the main frame pivot. Transmission assembly 187 is pivotably coupled to the main frame and rotational movement is controlled by the rubber shock assembly RA-1. The transmission system 187 is generally of the type disclosed in FIG. 56 herein.

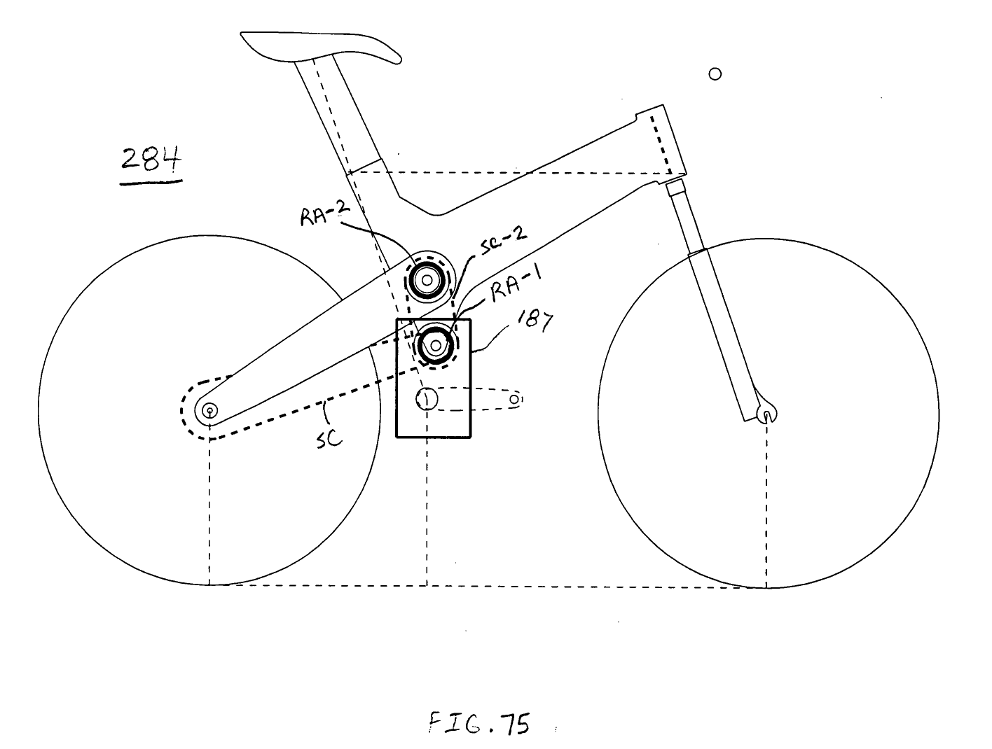

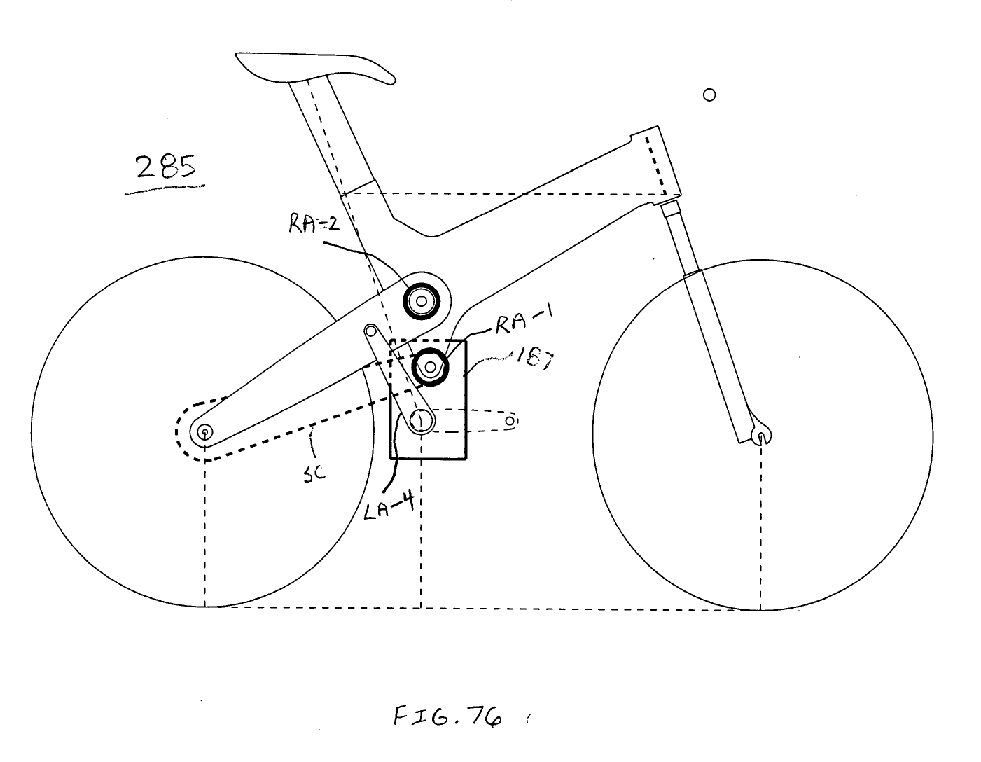

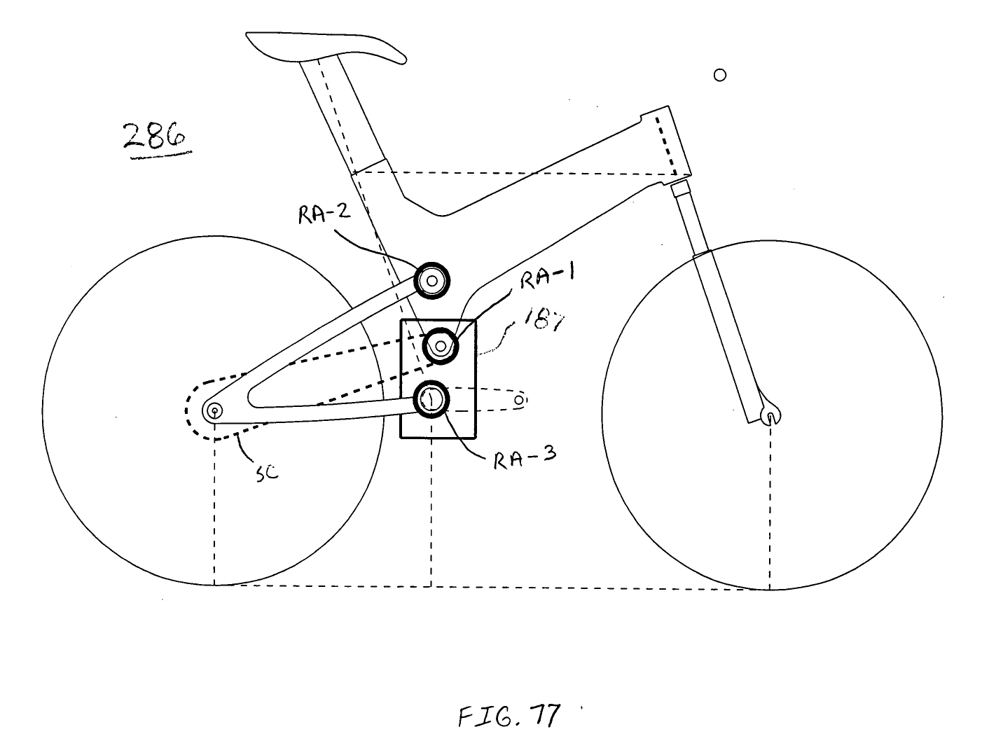

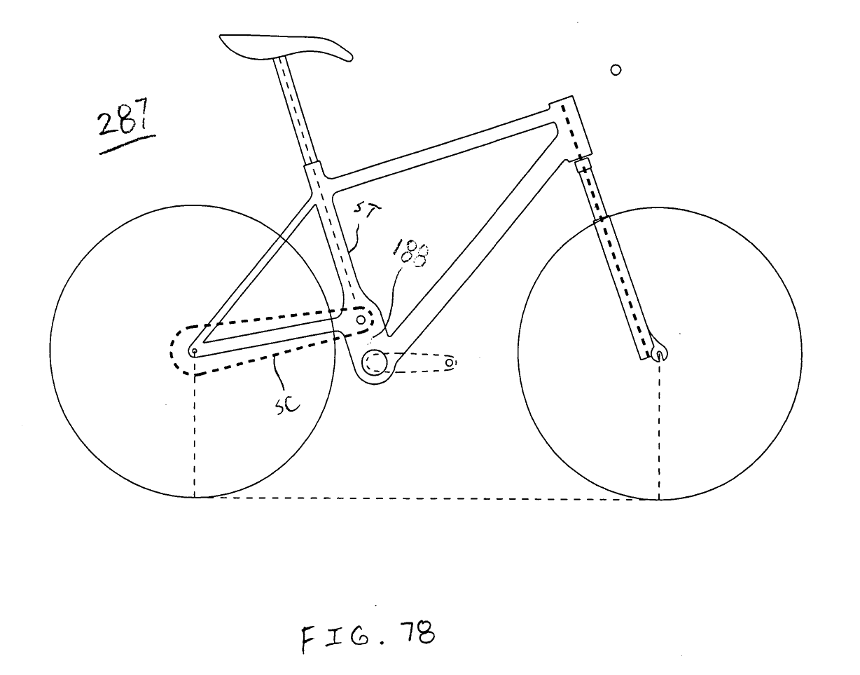

FIG. 75 is an embodiment of a bicycle assembly similar to FIG. 74, except the bicycle assembly 284 has a rear assembly that is pivotably mounted to the main frame above the transmission assembly pivot and rotational movement is controlled by the rubber shock assembly RA-2 which is mounted on the main frame upper pivot. Transmission assembly 187 is pivotably coupled to the main frame and movement is controlled by the rubber shock assembly RA-1. Sprocket chain SC-2 encircles and engages the two main frame pivots to resist the rotation of the transmission assembly 187 about the main frame pivot. The transmission system 187 is generally of the type disclosed in FIG. 56 herein.

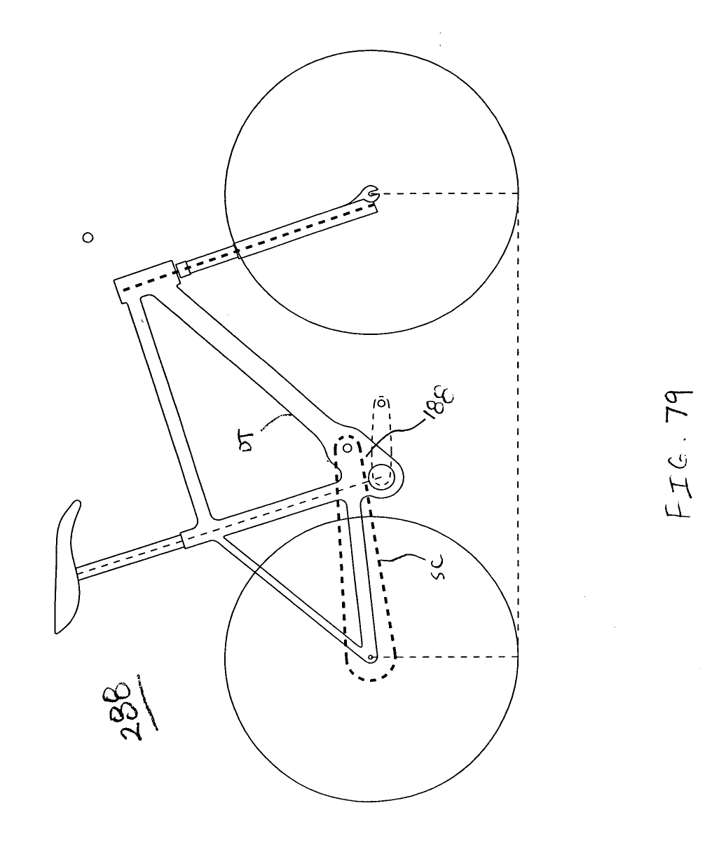

FIG. 76 is an embodiment of a bicycle assembly similar to FIG. 74, except the bicycle assembly 285 has a rear assembly that is pivotably mounted to the main frame above the transmission assembly pivot and a connecting link assembly LA-4 is connected to the transmission assembly 187 pedal crank input axis. Rear assembly rotational movement is controlled by the rubber shock assembly RA-2 which is mounted on the main frame upper pivot. Transmission assembly 187 is pivotably coupled to the main frame and rotational movement is controlled by the rubber shock assembly RA-1. The transmission system 187 is generally of the type disclosed in FIG. 56 herein.

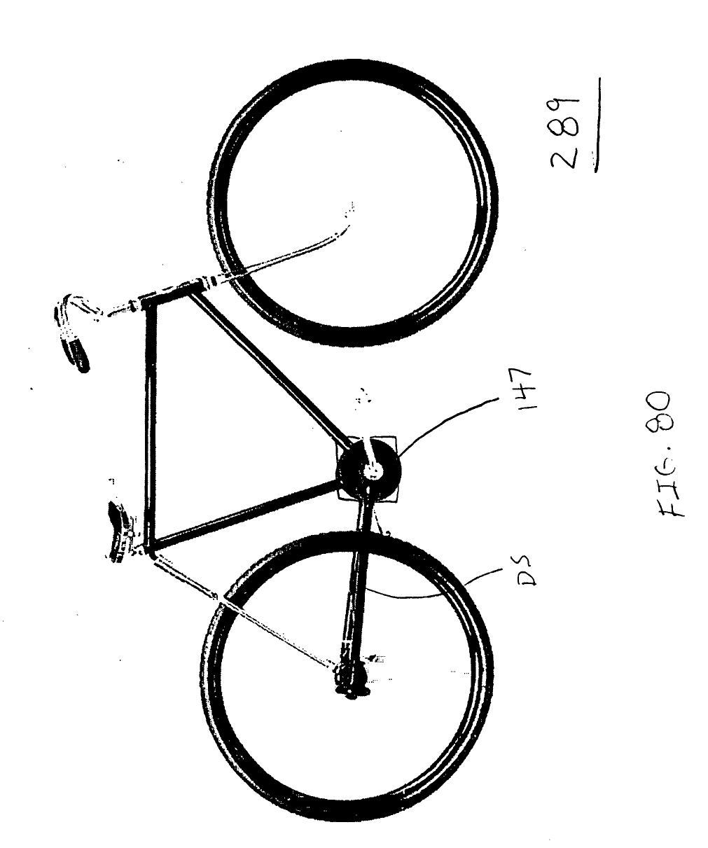

FIG. 77 is an embodiment of a bicycle assembly similar to FIG. 74, except the bicycle assembly 286 has a rear assembly that is pivotably mounted to the main frame above the transmission assembly pivot and pivotable mounted to transmission assembly 187. Rear assembly rotational movement is controlled by the rubber shock assembly RA-2 which is mounted on the main frame upper pivot and RA-3 which is mounted on the transmission assembly 187 pedal crank input axis. Transmission assembly 187 is pivotably mounted to the main frame and rotational movement is controlled by rubber shock assembly RA-1. The transmission system 187 is generally of the type disclosed in FIG. 56 herein.

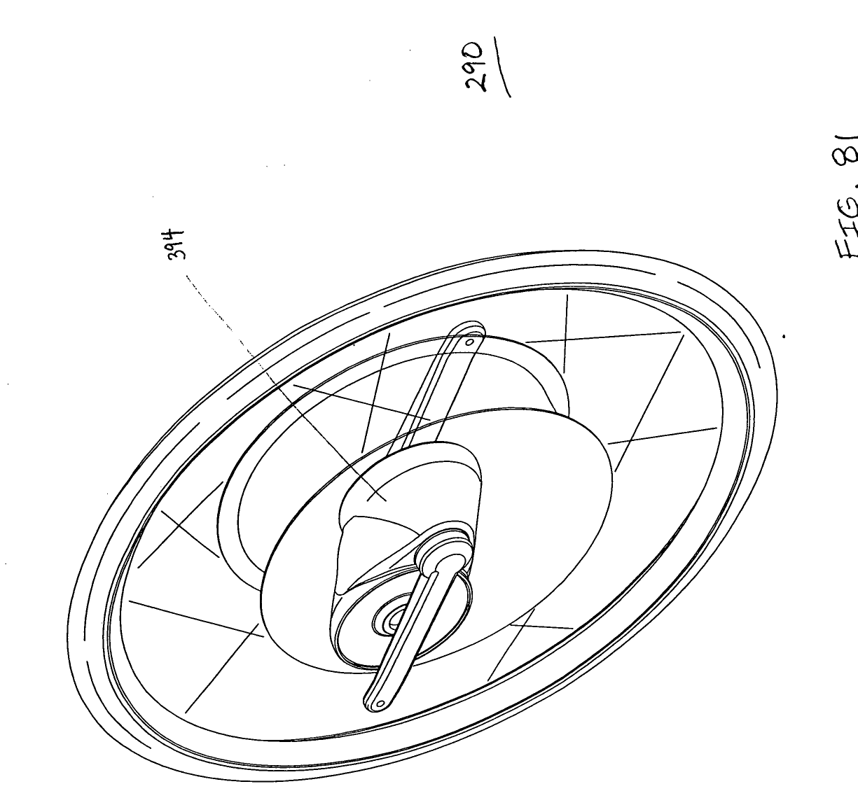

Referring to FIG. 78, transmission assembly 188 is mounted within the framework of the bicycle assembly 287. The bicycle assembly 287 structure is that of a front suspension bicycle similar to FIG. 63. The sprocket chain SC transfers the driven output of the transmission assembly 188 from the bicycle front frame seat tube ST to the rear wheel. The transmission system 188 is generally of the type disclosed in FIG. 56 herein.

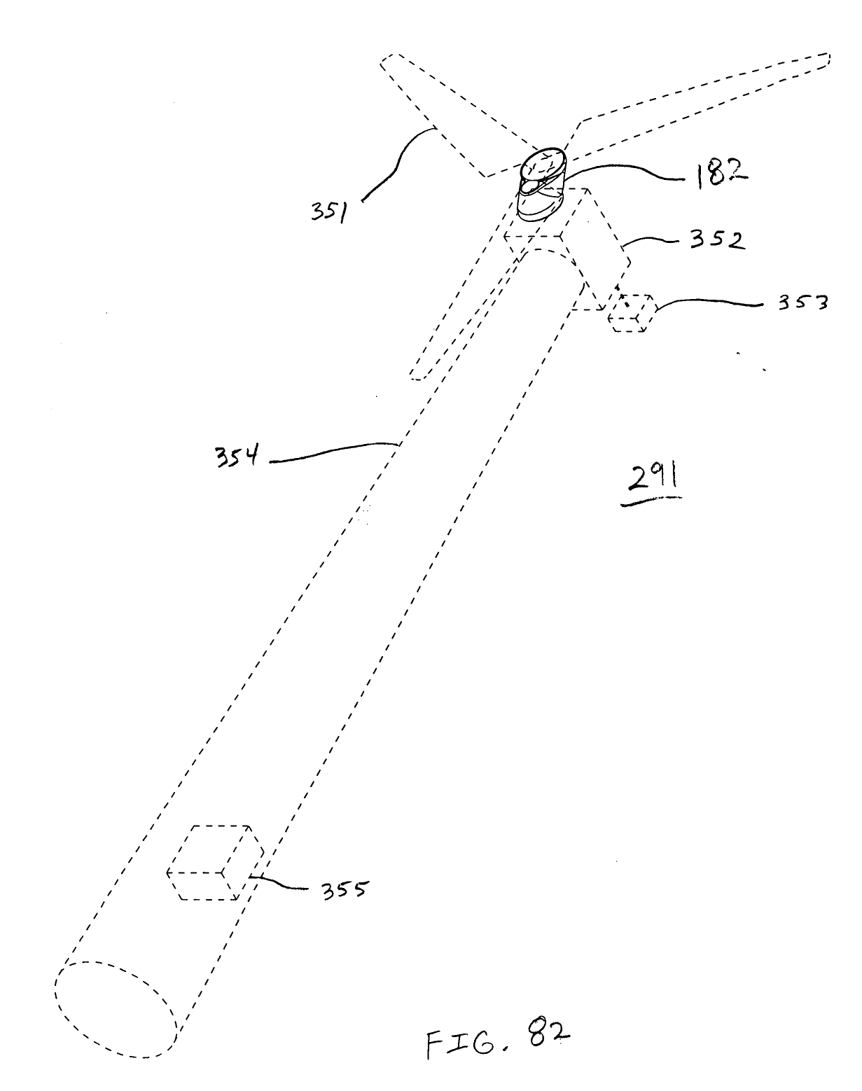

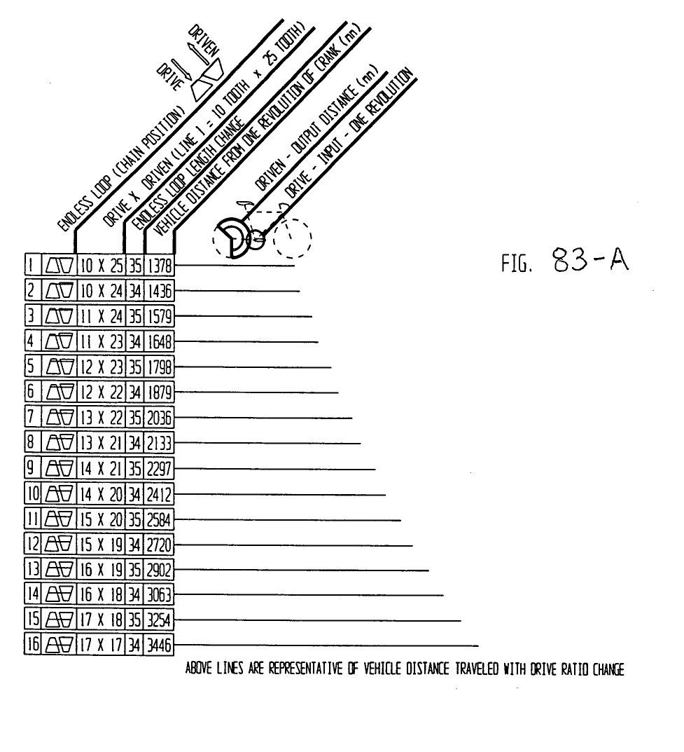

FIG. 79 is an embodiment of a bicycle assembly similar to FIG. 78, except the sprocket chain SC transfers the driven output of the transmission assembly 188 from the bicycle main frame down tube DT to the rear wheel. The bicycle assembly 288 structure is that of a front suspension bicycle similar to FIG. 63. The transmission system 188 is generally of the type disclosed in FIG. 56 herein.

FIG. 80 depicts the use of a drive shaft DS output from transmission assembly 147 applied to bicycle assembly 289. The transmission system 147 is generally of the type disclosed in FIG. 56 herein.

FIG. 81 depicts a transmission system 394 generally of the type disclosed in FIG. 56 herein located inside a wheel assembly 290 for a vehicle. Transmission system 394 is connected directly to a vehicle attached device, which in this case is a vehicle wheel assembly.

FIG. 82 is an embodiment of a transmission assembly 182 incorporated in a wind power energy generation device 291. The wind power device has a power capture system, power generation system, and transmission systems to enable an efficient use of the wind energy. Wind energy transfer blade assembly 351 rotates as wind flows across the airfoil shapes of the blades. The spinning blades are coupled through transmission assembly 182 which used the novel transmission carrier designs described previously to efficiently transfer the captured wind energy that has been converted into a rotational force. Transmission assembly 182 transfers the rotational force with appropriate drive ratios to maximize the efficiency of the attached power generator assembly 352. Clutch assembly 353 is attached to the power generator assembly 352 to enable consistent operating conditions during variable wind conditions. Tower support 354 functionally provides the appropriate heights required for the blade length and enables the connection of the power generated to the power output assembly 355.

FIGS. 83-A and 83-B are graphical illustrations detailing a set of transmission ratios from transmission drive and driven carriers wherein each carrier has thirteen elements each having one tooth difference in diameter. Drive and driven carriers are each shifted one element in an alternating sequence similar to the sequence shown in FIGS. 18-A and 18-B. Twenty five drive ratios are possible from this specific combination.

FIG. 83-C1 depicts a drive carrier 515 having drive elements 500 and 501 with a circumferential difference between them and driven carrier 516 having driven elements 502, 503, 504, 505, 506, 507, 508, 509, 510, 511, and 512; wherein each driven element has a progressively increasing circumference. Drive carrier 515 may consist of two or more elements. Drive ratio changes are progressively increasing or decreasing when the drive carriers' 515 drive elements circumferential difference is less than the circumferential difference between each pair of elements of driven carrier 516. Connecting element 513 connecting from drive element 501 to driven element 502 provides a drive ratio as shown. A drive ratio change is provided when connecting element 513 is shifted from drive element 501 to drive element 500. Driven carrier 516 is shiftable in increments of one, two, or more driven elements. In this way, the drive ratio can be changed quickly to the approximate desired drive ratio and then minor drive ratio adjustments are made through shifts of connecting element 513 on drive carrier 515 elements 500 and 501. Additional shifting methods and patterns are also conceivable in this arrangement.

FIG. 83-C2 illustrates the high and low range of a drive ratio shift pattern as defined in FIG. 83-C1. Shift pattern 83-C2A represents the high ratio range of ratios for each rear driven element selected in combination with the largest circumferential drive element. Shift pattern 83-C2B represents the low ratio range of ratios for each rear driven element selected with the smallest circumferential drive element.

FIG. 83-D depicts drive carrier 517 having drive elements 520 and 521 with a circumferential difference between them and driven carrier 518 having driven elements 522, 523, 524, 525, 526, 527, 528, 529, 530, 531, and 532; each with an increasing circumference. The driven elements range is group 518-A. Drive element 521 is connectively coupled through connecting element 519-A to each driven element on the driven carrier 518 to provide drive ratios. The drive carrier 517 may consist of two or more elements. The shifting of the connecting element 519-A provides progressively increasing or decreasing drive ratios, as long as the driven elements circumferential difference is greater than the circumferential difference of group 518-A.

FIG. 83-E depicts drive carrier 517 having two drive elements with a circumferential difference between them similar to FIG. 83-D. Driven carrier 518 has driven elements 522, 523, 524, 525, 526, 527, 528, 529, 530, 531, and 532; each having an increasing circumference. Driven elements are grouped together as group 518-A. Drive carrier 517 is connected from drive element 521 coupled through connecting element 519-B for each element on the driven carrier 518. The drive carrier 517 may consist of two or more elements. The shifting of the connecting element 519-A provides progressively increasing or decreasing drive ratios, as long as the driven elements circumferential difference is greater than the circumferential difference of group 518-A.

FIGS. 83-F1 and 83-F2 are chart illustrations of drive ratio shift patterns representing a sequence wherein an endless coupling passes through elements on a drive or driven transmission carrier to achieve a rapid change in the drive ratios. The drive ratio patterns are possible for both increasing or decreasing ratio directions by reversing the sequences of shifts. A rapid change in drive ratios is possible from the advance of the endless coupling 550 passing through a plurality of elements along either the drive or driven carriers. Passing through a plurality of drive elements and then a plurality of driven elements to achieve a change in drive ratios is shown in FIG. 83-F1. Transmission drive carrier 555 and transmission driven carrier 556, each comprised of nine elements, have an endless coupling 550 connecting drive element 540 and driven element 545 at starting position 550-A. Endless coupling 550 is shifted in rapid sequence along transmission drive carrier 555 passing through to drive element 541, to drive element 542, to drive element 543, and then on to drive element 544. Endless coupling 550 is then shifted in a rapid sequence along transmission driven carrier 556 passing through driven element 545 to driven element 546, to driven element 547, to driven element 548, and then on to driven element 549. The endless coupling 550 provides a changed drive ratio by connecting drive element 544 and driven element 549 at position 551-A. In FIG. 83-F2, a similar change of drive ratios is shown, although the sequence is started along the driven carrier first, as transmission drive carrier 555 and transmission driven carrier 556 have endless coupling 550 connecting drive element 540 and driven element 545 at starting position 550-B. Endless coupling 550 is shifted in rapid sequence along transmission driven carrier 556 passing through driven element 545 to driven element 546, to driven element 547, to driven element 548, and then on to driven element 549. Endless coupling 550 is then shifted in a rapid sequence along transmission drive carrier 555 passing through from drive element 540 to drive element 541, to drive element 542, to drive element 543, and then on to drive element 544. The endless coupling 550 provides a changed drive ratio by connecting drive element 544 and driven element 549 at position 551-B.

FIGS. 83-G1 and 83-G2 are chart illustrations of shift patterns representing a sequence wherein endless coupling shifts to each individual element on a drive or driven transmission carrier provide a change in drive ratios. A change in drive ratios is provided by the advance of endless coupling 550 to an element along either the drive or driven carriers. A change of drive ratios by shifting along either the drive or driven carriers first is applicable for both increasing and decreasing drive ratios. In FIG. 83-G1, transmission drive carrier 555 and transmission driven carrier 556 are comprised of nine elements each and have an endless coupling 550 connecting drive element 540 and driven element 545 at starting position 550-C. Endless coupling 550 is shifted along transmission driven carrier 556 from driven element 545 to driven element 546 to provide a drive ratio change. Endless coupling 550 is then shifted along transmission drive carrier 555 from drive element 540 to drive element 541 to create the next drive ratio change. The endless coupling 550 provides a drive ratio change by connecting drive element 541 and driven element 546 at ending position 551-C. The same pattern is repeatable for creating drive ratio changes from the drive and driven elements along the drive and driven carriers until the ends of the carriers are reached. In FIG. 83-G2, a drive ratio change is shown by endless coupling 550 connecting drive element 540 and driven element 545 at starting position 550-D and then being shifted along transmission drive carrier 555 from drive element 541 to drive element 540 to create a drive ratio change. Endless coupling 550 is then shifted along transmission driven carrier 556 from driven element 545 to driven element 546 to position 551-D to create another drive ratio change. The same pattern is repeatable for creating drive ratio changes from the drive and driven elements along the drive and driven carriers until the ends of the carriers are reached.

FIG. 83-H is a chart showing drive ratio variations from using a shift pattern where the drive carrier or driven carrier elements are passed over first to provide drive ratios. Shift pattern 83-H1 is a pattern of ratios derived from passing over the drive carrier, then the driven carrier ratio until the carriers are aligned on opposing elements such as the pattern shown in FIG. 83-F1. Shift pattern 83H-2 shows the change in drive ratios when the driven carrier is shifted, then the drive carrier such as the pattern shown in FIG. 83-F2.

In FIG. 83-1, the chart illustrates five drive ratio shift patterns using different shift methods and carrier types. Shift pattern 83-I1 represents the drive ratios similar to those of FIGS. 83-A and 83-B. Shift pattern 83-I2 represents a drive carrier shifted similar to FIG. 83-F1. Shift pattern 83-I3 is representative of the pattern shown in FIG. 87. Shift pattern 83-I4 is representative of the drive and driven carriers shown in FIG. 83-C1. The available shift sequences and methods enable versatility in application of the transmission system.

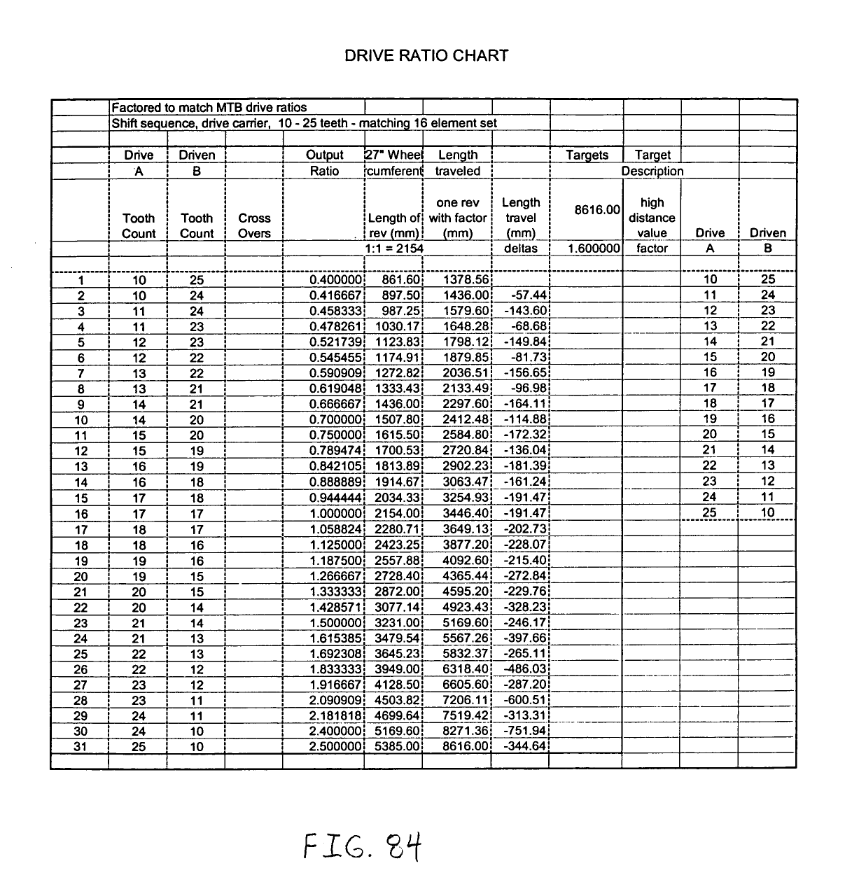

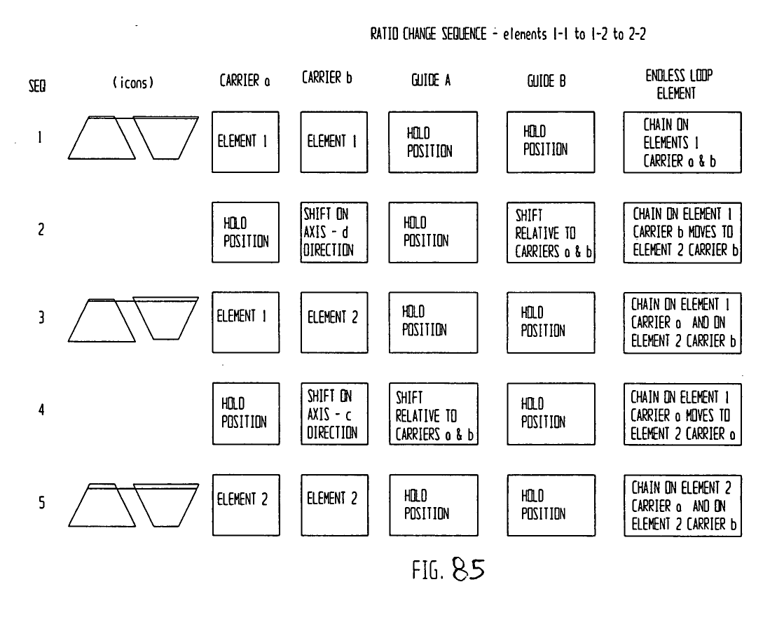

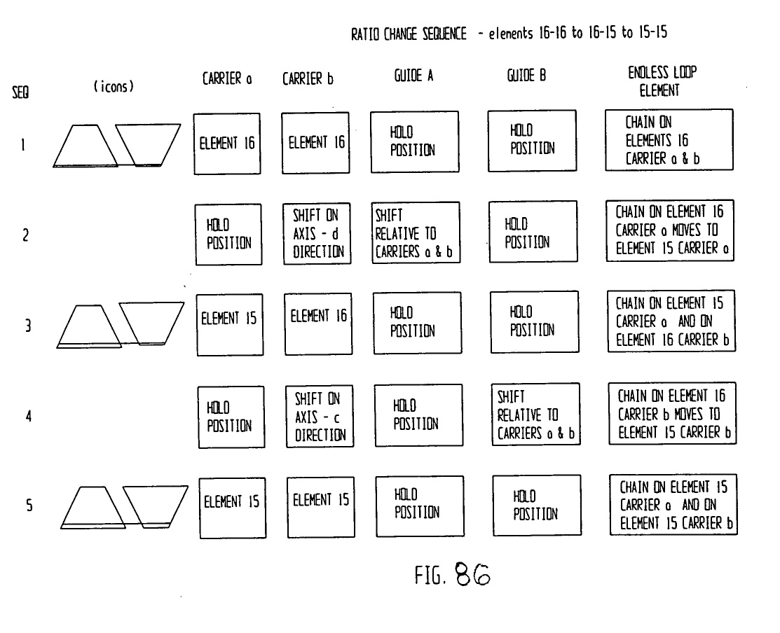

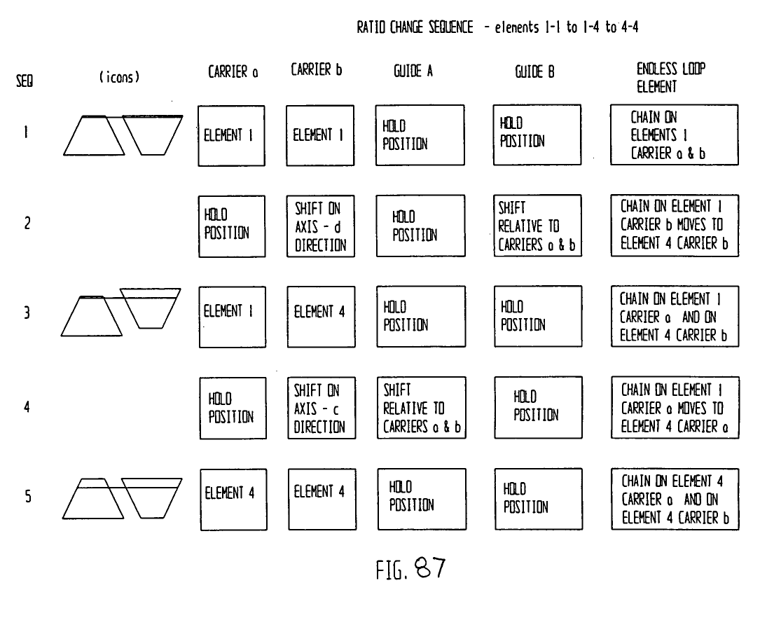

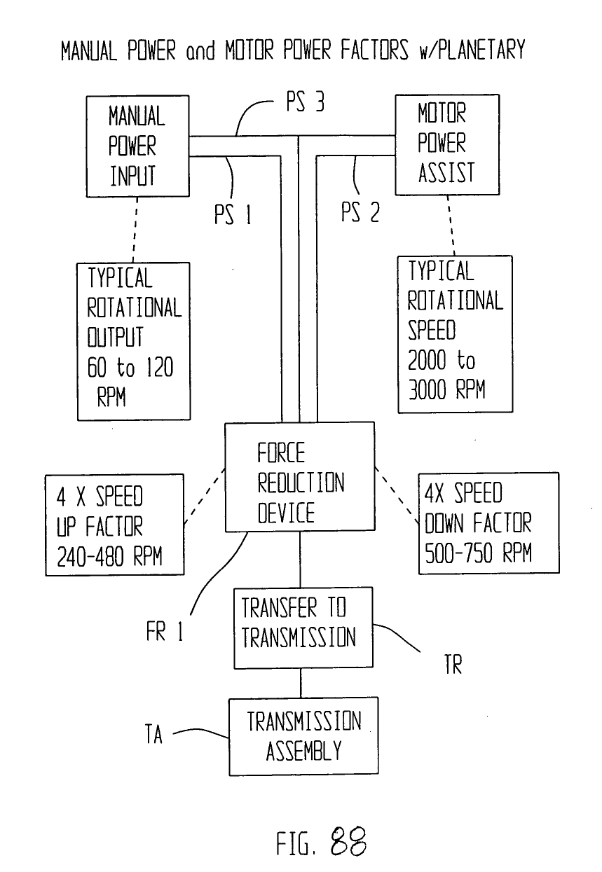

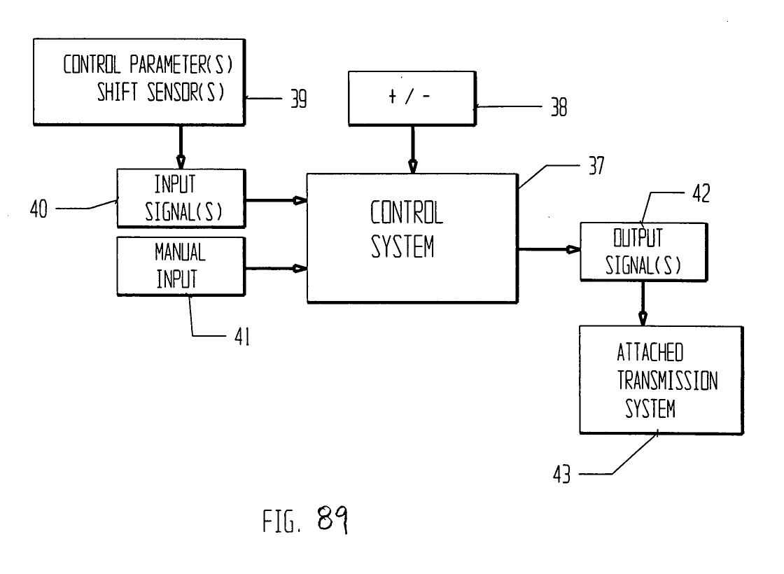

FIG. 84 is a chart detailing the changes in length of travel derived from the gear ratio combinations as shown in the charts of FIGS. 83-A and B. The high range ratio target of a bicycle road configuration is derived from a fifty three tooth drive to an eleven tooth driven ratio of 4.81818. The high range target ratio provides 10378.36 millimeters of wheel travel per one revolution of the eleven tooth driven gear when attached to a wheel with a 2154 millimeter circumference. The wheel circumference of 2154 millimeters multiplied by the output ratio of the driven carrier and then multiplied by a factor value of 2.11999 provides the millimeters traveled by the wheel per one revolution of the driven carrier. The factor value of 2.11999 is derived from the high range travel length target of a bicycle road configuration divided by the output ratio of the twenty five tooth drive to eleven tooth driven carriers.

FIG. 85 is a chart detailing a ratio change sequence for transmission drive and driven carrier elements; elements 1-1 to 1-2 to 2-2; respectively. The chart depicts the component element relationships during a ratio change sequence. The first step is the initial position profile of a continuous loop 7 on transmission drive carrier element 1 and transmission driven carrier element 1. Steps two and three show the ratio change means for the continuous loop 7 transition from transmission driven carrier element 1 to element 2 while the continuous loop 7 stays engaged on transmission drive carrier element 1. Steps four and five show the ratio change means for an continuous loop 7 transition from transmission drive carrier element 1 to element 2 while the continuous loop 7 stays engaged on transmission driven carrier element 2.

FIG. 86 is a chart detailing a ratio change sequence for transmission drive and driven carrier elements; elements 16-16, 15-16, 15-15. The first step is the initial position profile of a continuous loop 7 on transmission drive carrier element 16 and transmission driven carrier element 16. Steps two and three show the ratio change means for the continuous loop 7 transition from transmission drive carrier element 16 to element 15 while the continuous loop 7 stays engaged on transmission driven carrier element 16. Steps four and five show the ratio change means for a continuous loop 7 transition from transmission drive carrier element 16 to element 15 while the continuous loop 7 stays engaged on transmission driven carrier element 15.

FIG. 87 is a chart detailing a ratio change sequence for multiple carrier elements; elements 1-1, 1-4, 4-4. The first step is the initial position profile of a continuous loop 7 on transmission drive carrier element 1 and transmission driven carrier element 1. Steps two and three show the ratio change means for the continuous loop 7 transition from transmission driven carrier element 1 to element 4 while the continuous loop 7 stays engaged on transmission drive carrier element 1. Steps four and five show the ratio change means for an continuous loop 7 transition from transmission drive carrier element 1 to element 4 while the continuous loop 7 stays engaged on transmission driven carrier element 4.

A graphical illustration of the conversion of human energy to motion is illustrated in FIG. 88. As shown, the applied human energy is converted to a rotational force, that is a torque, as a downward force on the crank arm rotates the axle. The manual power input force PS1 is connected to force reduction ratio device FR1. The rotational force is converted to a faster rotation by force reduction ratio device FR1 which converts the rotational speed into a higher output ratio conversion. The schematic also shows the connection of an additional power supply in the form of a motor power device PS2 which is applicable as the primary power supply or as a supplemental power supply to PS1. The output ratio device reduces the output rotational speed of the motor power force PS2 to more closely match the manual power input force PS1. Power supply PS3 is the power supply ratio of PS1 and PS2 combined. The power supply PS3 is a ratio that ranges from PS1 as 100 percent and PS2 as 0 percent of the power supply PS3 total and is infinitely adjustable to PS1 as 0 percent and PS2 as 100 percent of the power supply PS3 total. The rotational speed increase of the human power supply and the rotational speed decrease of the motor power supply provides more closely balanced rotational input speeds to the transmission assembly. The balanced speed inputs results in improved drive ratio transitions when switching between the power supplies or when one power supply provides a greater percentage of the power mix than the other power supply.

In FIG. 89, an example of the controller 96 of FIG. 56, is shown as control system 37 powered by power supply 38 which may be a battery and/or an electric generator evaluates control parameter shift sensors 39 input signals 40 to determine the appropriate output signals 42 for the attached transmission system 43. Additionally manual inputs are controlled through manual input 41.

FIG. 90 is a flow diagram example for external inputs to effect changes in drive ratio control system parameters by a technician or other manual means. The drive ratio control system runs a sensor input cycle beginning at step 33A. The cycle will look for technician or manual input first in step 33B. Knobs, switches, buttons, and other drive inputs are looked for in step 33C. A wait state step 33D to read variable condition states as follows. A technician display or other output device is updated in step 33E. The controller modifies the program parameters based on new variable values at step 33F. The cycle will pause briefly at exit command step 33G to determine if a program stop or exit command has been entered either by manual or automatic mode. If the exit command is read, the cycle will move to step 33H, step and switch to manual mode, then close cycle loop at step 33I. The cycle will continue to step 33J and make a system safety check before proceeding to step 33K if the safety mode is tripped or continue on to perform a sequence of sensor measuring functions shown as steps 33L, 33M, 33N, 33O, 33P, 33Q, 33R, 33S, 33T and 33U. After inputs from the sensor steps, the controller will read the variable states and determine if changes have occurred. The decision step 33V will send the cycle loop our after a timer wait state is reached. Then the cycle will begin again at step 33B.

FIG. 91 is a logic flow diagram for a programmable control to show one manner of a controller decision cycle for drive ratio changes using the embodiment of FIG. 1 in a transmission assembly with a controller similar to that shown in FIG. 56. The initial control cycle sets the control system parameters to zero in begin cycle step 32A, then initial drive ratio shift measurements are taken at step 32B. The drive ratio mode is determined by the selector step 32C and the cycle path is routed to the corresponding steps 32D, 32N, or 32X for the selected mode settings, “Climbing”, “Downhill”, and “Level” modes, respectively. The routing for the drive ratio mode described as “Downhill” is, as follows. If the cycle is the first cycle then step 32N sends a signal through the YES gate 32P. The control system then looks up the scanned history and makes changes (or not) based on drive ratio data 32Q. The control system sends a signal to regulate the drive ratio until balanced with the load sensor data at step 32R. The system reads load sensors at step 32S to determine the energy output rate to user interface and adjusts the drive ratio to match energy output rate parameters at step 32T. The system computes the reference cycles to create a baseline 32AH to use as comparison for the next cycle then returns to the beginning of the cycle through step 32AI which sends the signal to the drive ratio shift measurements step 32B. If the cycle was not the first cycle at step 32N, then the control system is routed through NO gate 32O to step 32U, which checks if the energy output rate has changed from the baseline parameter value. If the energy output rate has changed, then the signal is routed through YES gate 32V to steps 32R, 32S, 32T, 32AH, and 32AI. If the baseline energy output rate parameter value has not changed then the control signal sends the signal through the NO gate 32W to step 32AH and starts the scan process again through 32AI by returning to the beginning of the cycle at drive ratio shift measurements step 32B. An analogous procedure is followed for the “Climbing” mode using system parameter data designed for the optimal drive ratio conditions for the mode. The control system routes through step 32D to determine if the scan is the first pass. A first time scan is directed through the YES gate 32F to drive ratio data 32E to lookup the scanned history and make changes to the drive ratio based on mean history data. Routing then follows a similar sequence as the other modes; routing continues through to step 32J where the drive ratios are balanced to match the selected mean parameter values. Load sensors are read in step 32K and then step 32L adjusts the drive ratios to comply with energy output rate parameter settings for the “Climbing” mode. The signal routing is then sent through step 32AH to compile with reference cycles and step 32AI to start another scan process at step 32B. If the look up table at step 32D is not the first cycle then the control system routes through NO gate 32G onto step 32H to check if there has been a shift in the energy output rate parameters. If the parameters have changed, then the signal routes through the YES gate 321 to process through control steps 32J, 32K, 32L, 32AH, and 32AI. Step 32AI sends the process back to the beginning for drive ratio shift measurements at step 32B. If at step 32H, the control determines the parameters have not changed, then the control process is sent through NO gate 32M onto step 32AH and step 32AI back to the beginning drive ratio shift measurements step 32B. Another analogous procedure is followed for the “Level” mode using system parameter data designed for the optimal drive ratio positions for the mode. The control system 32C “Level” mode setting routes to step 32X to check if this is the first pass. If this is the first pass, the signal is sent through the YES gate 32Y to look up the scanned history at step 32Z. Transmission drive ratios are modified until balanced with the mean parameter values derived at step 32AA. The control then reads load sensors to determine energy output rate to user interface at step 32AC. Drive ratios are adjusted to comply with the energy output rate parameter setting in step 32AD. After adjustments are made, the control process goes to step 32AH to compile with the reference cycles to create an updated mean baseline value. Step 32AI then initiates another scan process back to drive ratio shift measurements at step 32B. If the process was not on the first pass at step 32X, then the signal routes through the NO gate 32AE on to step 32AF. At step 32AF, the control system determines if an energy output parameter shift has occurred and if so, the signal is then routed through the YES gate 32AB to step 32AA to modify the drive ratios until balanced with the mean parameter value. At this point, the control system follows the steps 32AC and 32AD to read sensors and adjust the drive ratios to match the energy output parameter setting values for the “Level” mode. After the drive ratio adjustments are made, the cycle will continue through to steps 32AH to compile with the reference cycles and 32AI to start a scan with the adjusted baseline in place. If the control system at step 32AF determines the energy output rate has not changed, then the signal is sent through the NO gate 32AG to steps 32AH to compile and 32AI to begin a scan at step 32B. The controller decision tree processing continues until the control system is powered off.

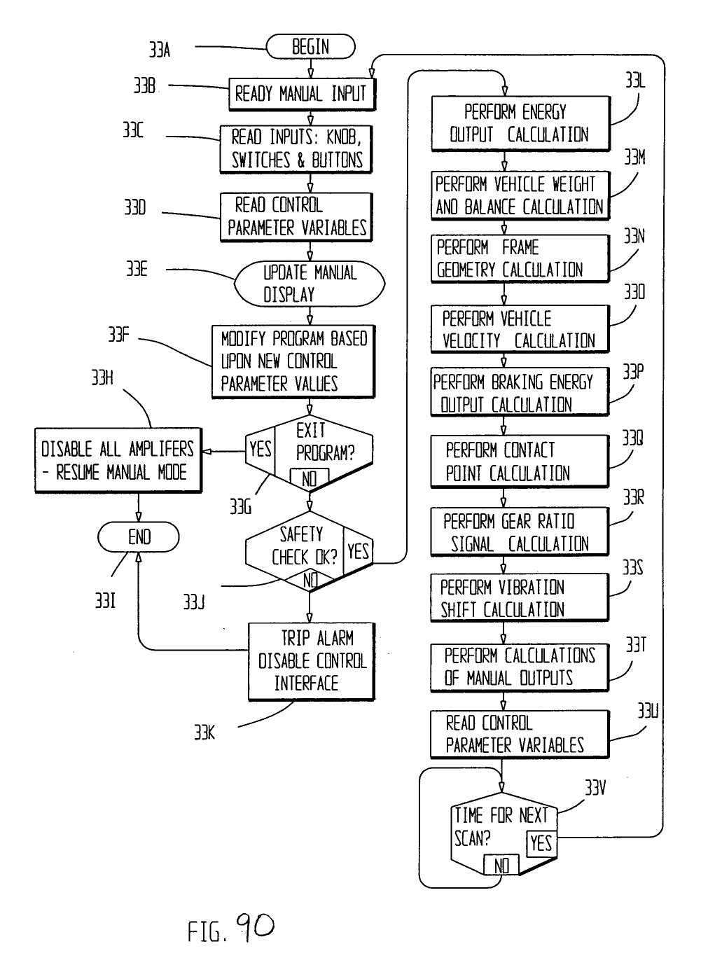

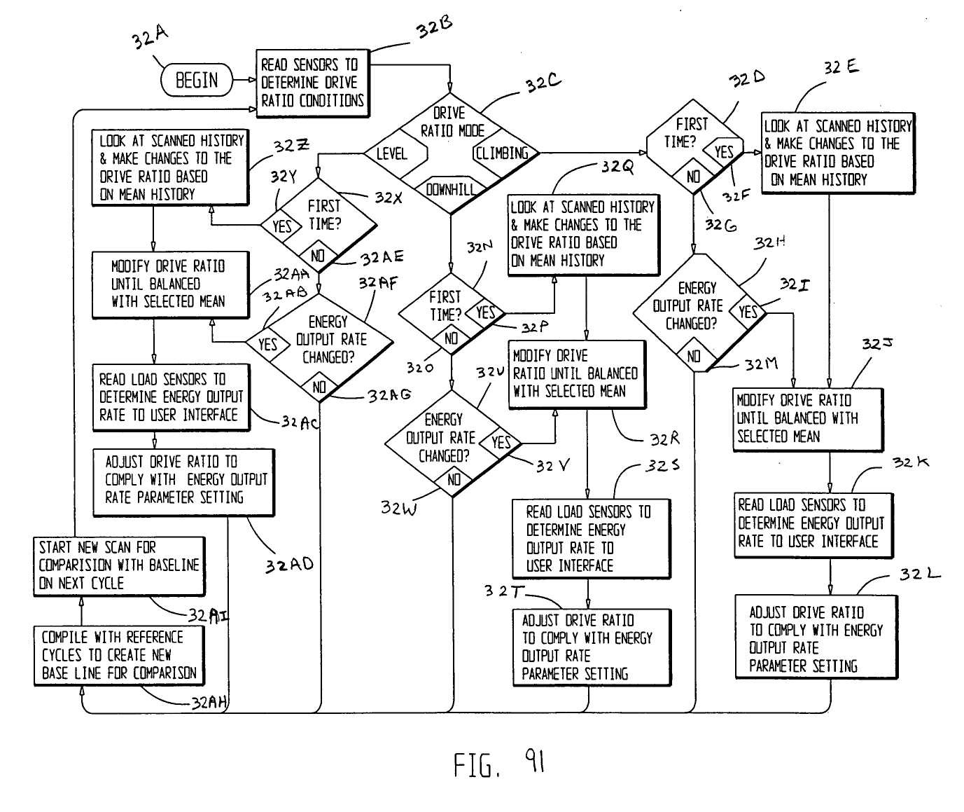

Parameters 116 through 137 for control system parameter table 115 as shown in FIG. 92 are applied singularly or in combination to effect adjustments and control of the transmission ratio change device 145. Parameters may be selected singly or in combination from angle of inclination of human/payload shift parameter 116, weight and balance of vehicle parameter 117, training program system shift parameter 118, terrain and suspension control loops parameter 119, angle of inclination of vehicle parameter 120, length of operation shift parameter 121, energy output control parameter 122, suspension stack height parameter 123, vehicle velocity parameter 124, frame geometry parameter 125, terrain condition parameter 126, contact point shift parameter 127, ride height shift parameter 128, vibration shift parameter 129, braking energy parameter 130, day of week shift parameter 131, interactive shift parameter 132, energy input parameter 133, gear ratio parameter 134, wheel rotating speed parameter 135, vehicle load parameter 136, and user interface parameter 137.

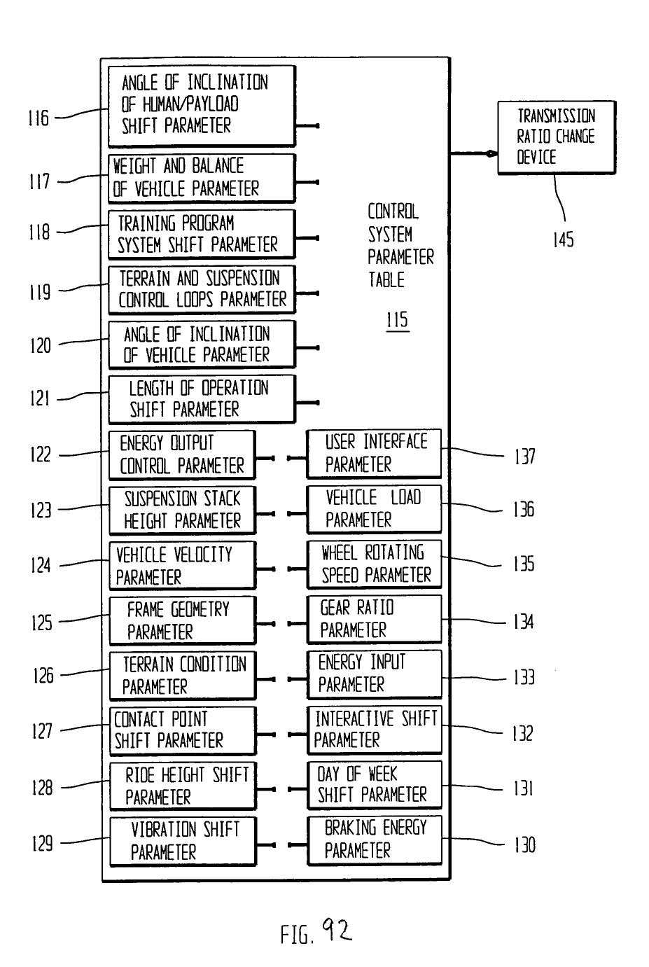

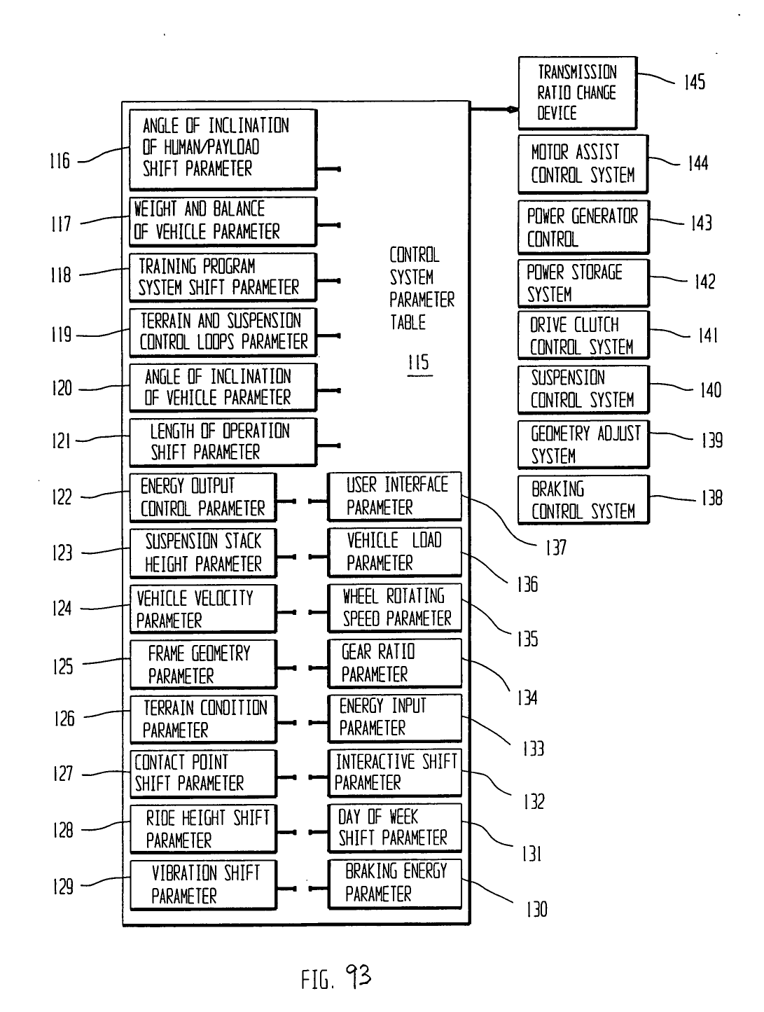

In FIG. 93, the transmission ratio change device 145, motor assist control system 144, power generator control 143, power storage system 142, drive clutch control system 141, suspension control system 140, geometry adjust system 139, and braking control system 138 are typical vehicle systems that benefit from the control system parameters shown in FIG. 92. The transmission ratio change device 145 may be adjusted individually or in combination with the other attached devices and systems to improve the vehicle ride characteristics.

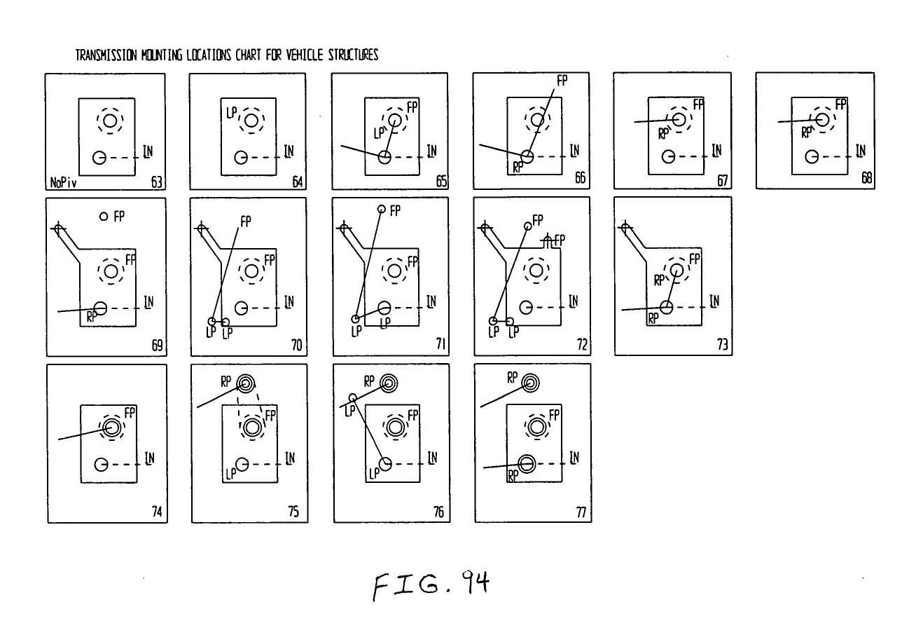

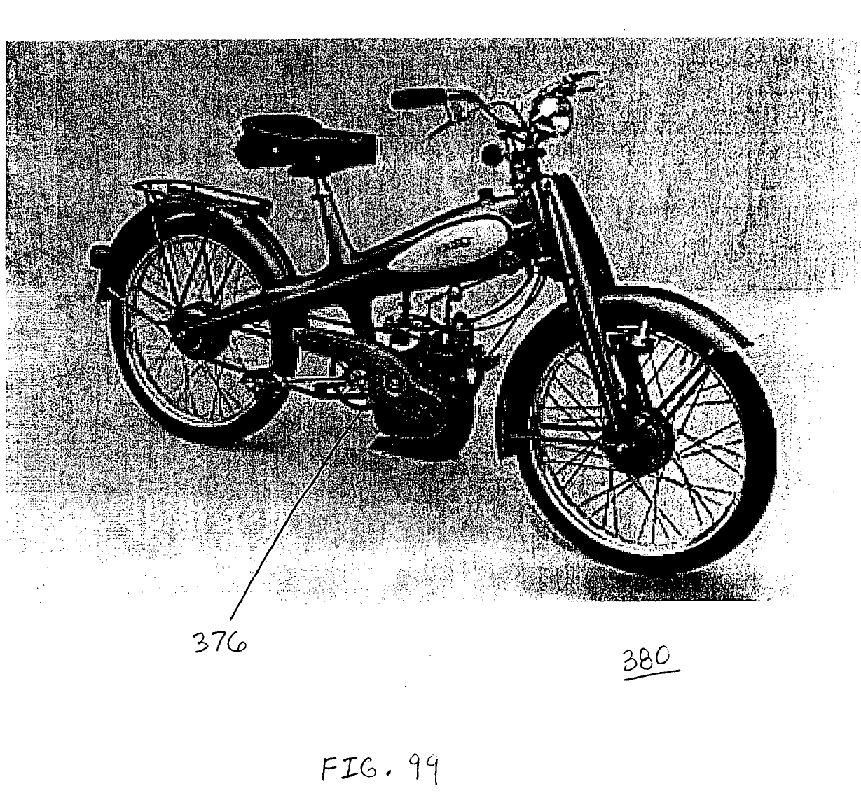

The chart of FIG. 94 graphically displays the versatility of the invention and possible transmission assembly locations on vehicles using various suspension designs. Additional vehicle locations using the novel form of transmission assembly 330 as shown in FIG. 59 are possible and examples are shown in FIGS. 95, 96, 97, and 98. Additional applications for the novel transmission assembly can be shown in FIGS. 99, 100, 101, 102, and 103.

Referring to FIG. 95, transmission assembly 396 is mounted within the framework of bicycle assembly 397. The bicycle assembly 397 structure is that of a front suspension bicycle similar to FIG. 63. The sprocket chain SC transfers the driven output of the transmission assembly 396 from the bicycle front frame down tube DT to the rear wheel. The transmission system 396 is generally of the type disclosed in FIG. 59-A herein.

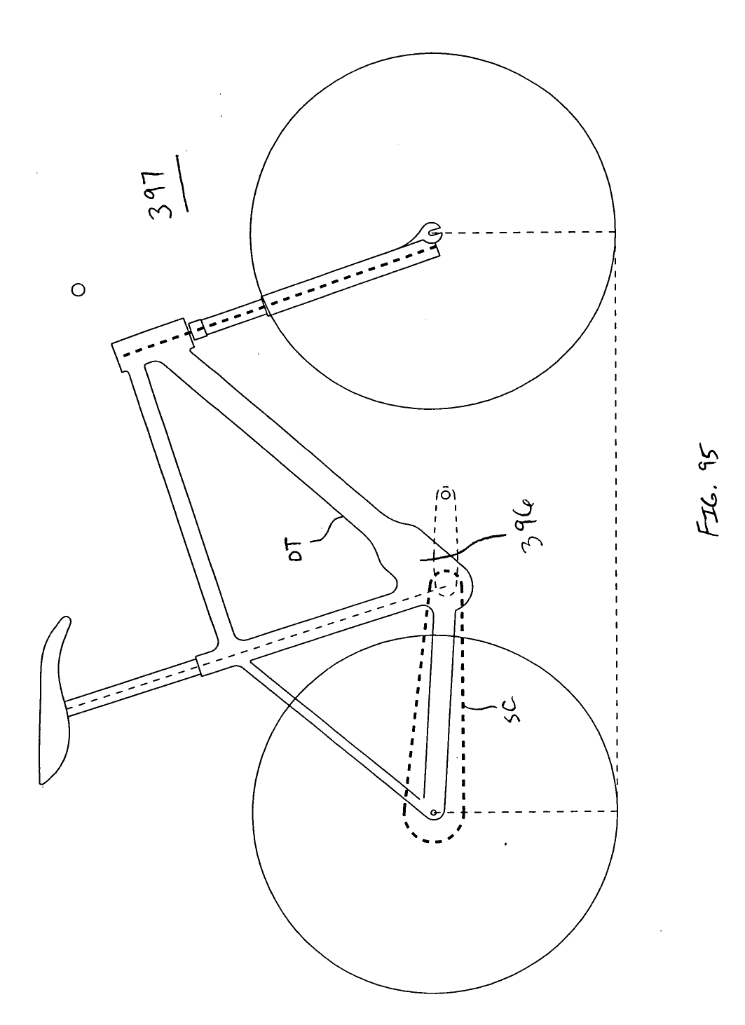

FIG. 96 is an embodiment of a bicycle assembly similar to FIG. 95, except the sprocket chain SC transfers the driven output of the transmission assembly 396 from the bicycle front frame seat tube ST to the rear wheel. The bicycle assembly 399 structure is that of a front suspension bicycle similar to FIG. 63. The transmission system 396 is generally of the type disclosed in FIG. 59-A herein.

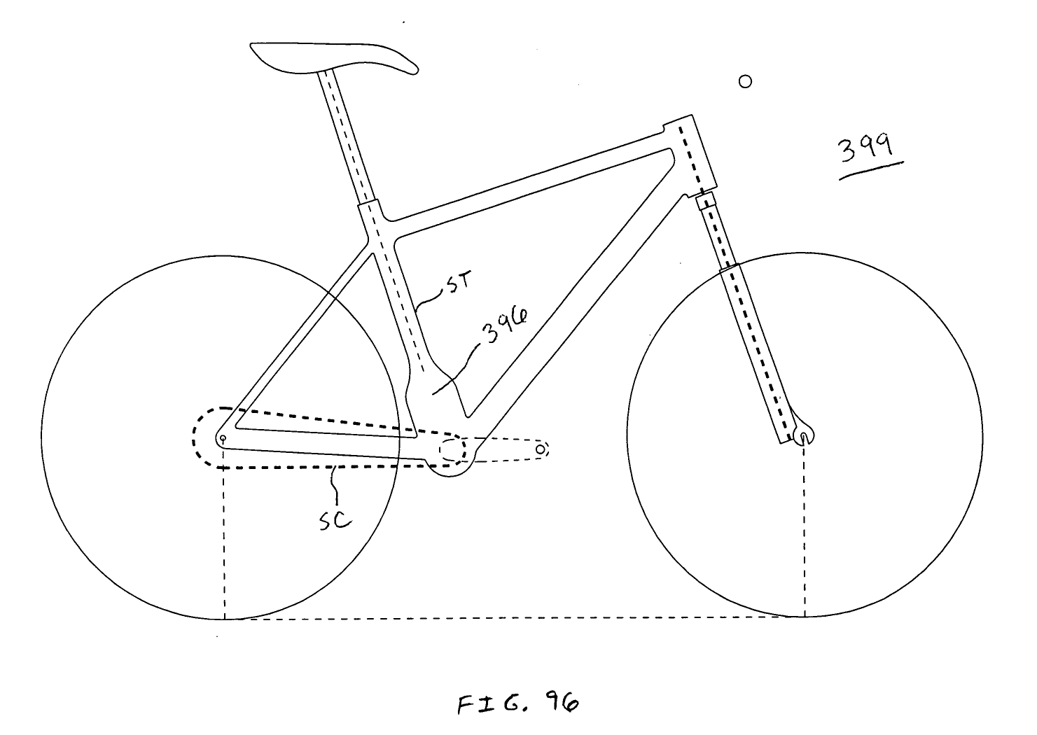

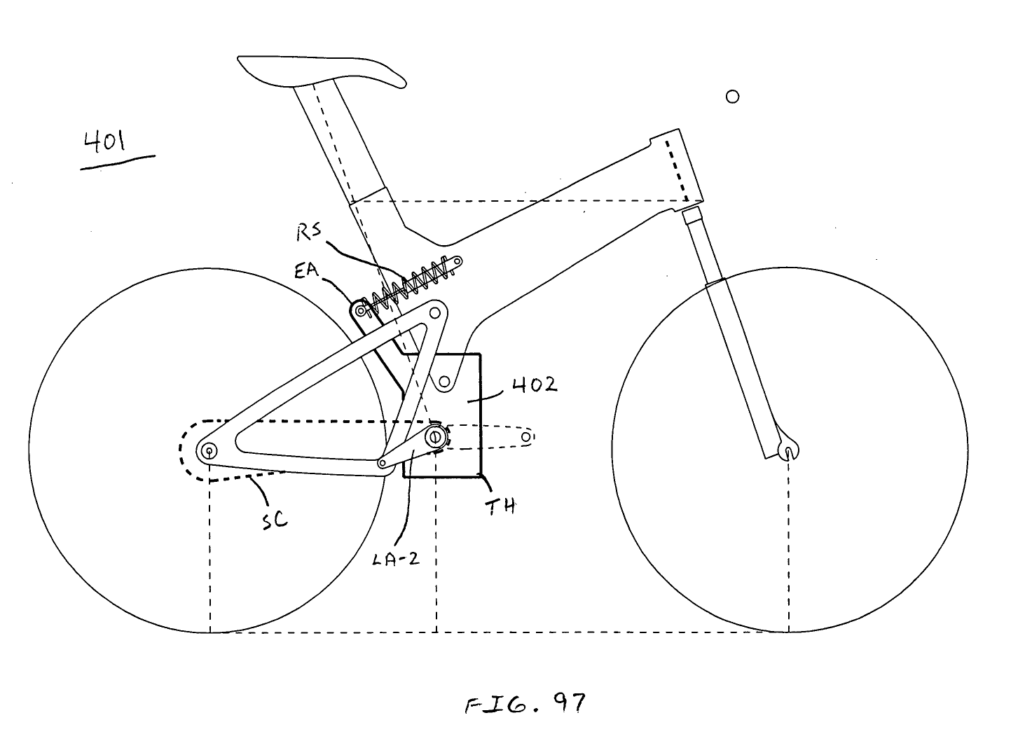

Referring to FIG. 97, transmission assembly 402 is pivotably mounted to the main frame of bicycle assembly 401. The bicycle assembly 401 structure is that of a full suspension bicycle similar to FIG. 71. The sprocket chain SC transfers the driven output of the transmission assembly 402 from the pedal input axis to the rear wheel. The transmission system 402 is generally of the type disclosed in FIG. 59-A herein.

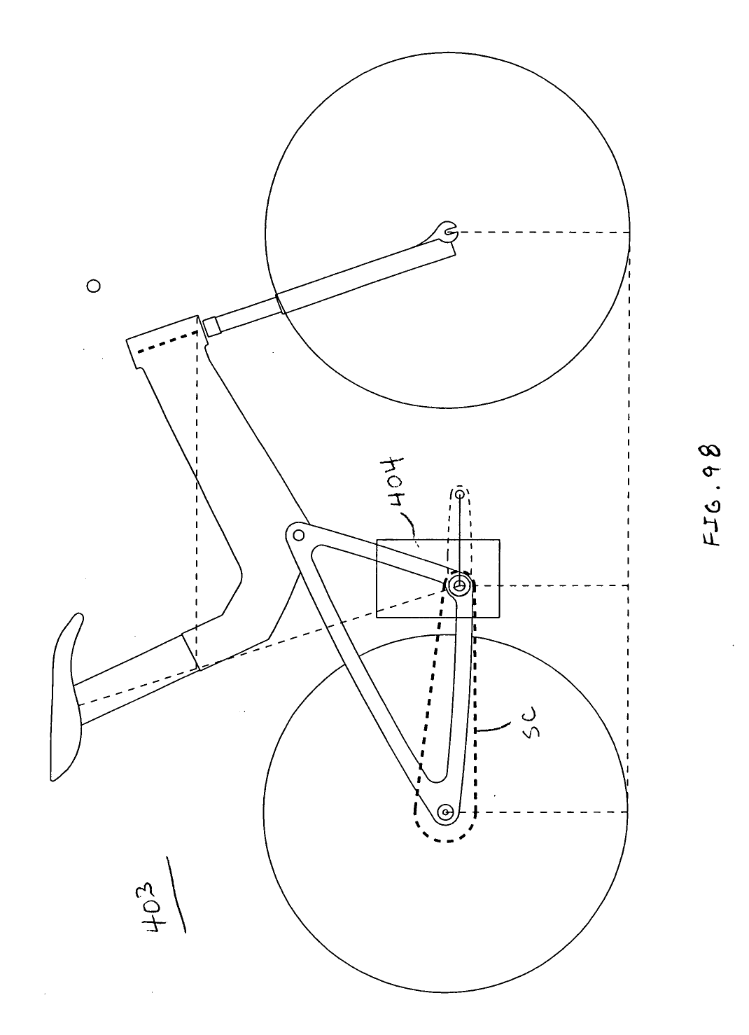

FIG. 98 is an embodiment of a bicycle assembly similar to FIG. 97, except the transmission assembly 404 pivotably mounted to the bicycle rear triangle has a driven output from the pedal input axis that a sprocket chain SC transfers to the rear wheel. The bicycle assembly 403 structure is that of a full suspension bicycle similar to FIG. 66. The transmission system 404 is generally of the type disclosed in FIG. 59-A herein.

FIG. 99 is an embodiment of a moped assembly 380 utilizing a novel transmission system disclosed herein. A moped is a hybrid vehicle that has manual power capability through a pedal assembly combined with an assist motor power assembly. The moped assembly's two power sources are used individually or in combination together as represented in the chart of FIG. 88. Transmission assembly 376 is an embodiment of the transmission assembly of FIG. 56 that is fitted to the moped assembly 380.

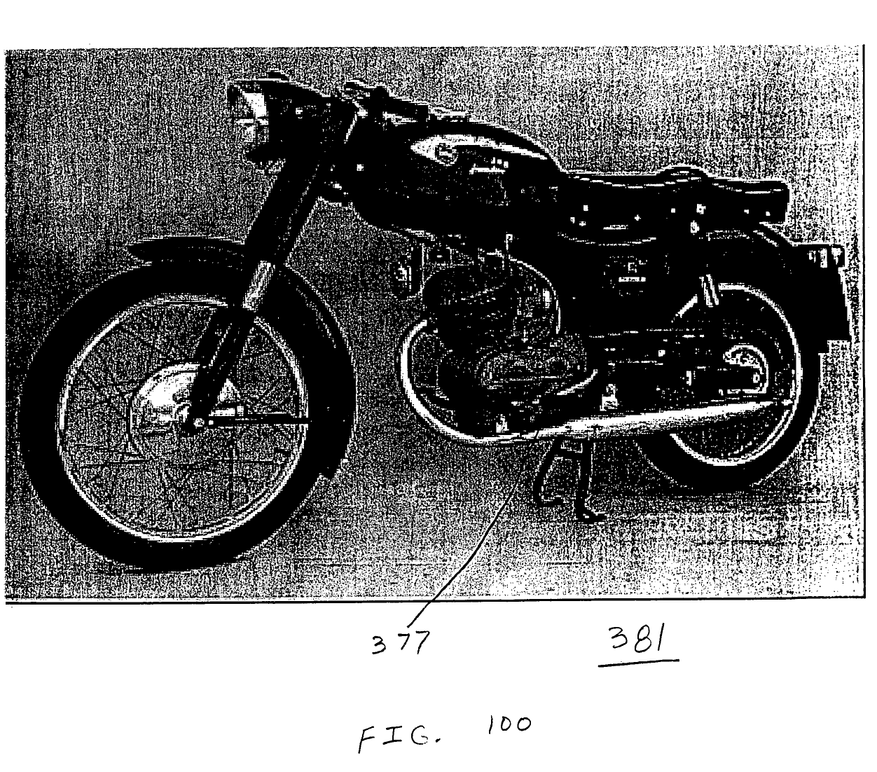

FIG. 100 displays a motorcycle assembly 381 that utilized a transmission assembly 377 of similar form to the transmission assembly disclosed in FIG. 56.

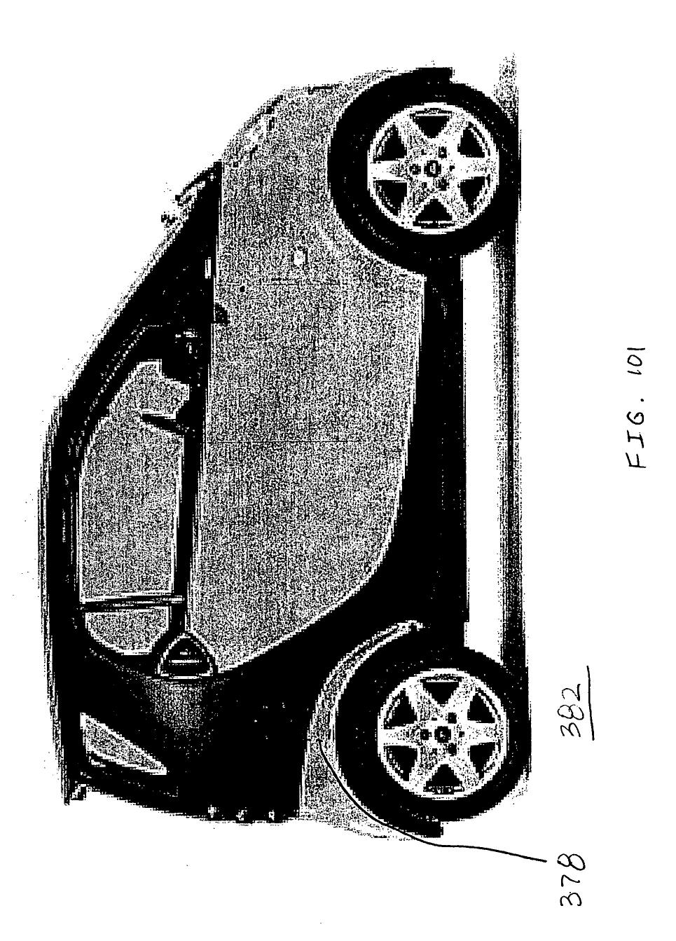

FIG. 101 depicts a vehicle assembly 382 which utilizes transmission assembly 378 of similar form to the transmission assembly disclosed in FIG. 56. The vehicle assembly has two power sources that are used individually or in combination together as represented in the chart of FIG. 88.

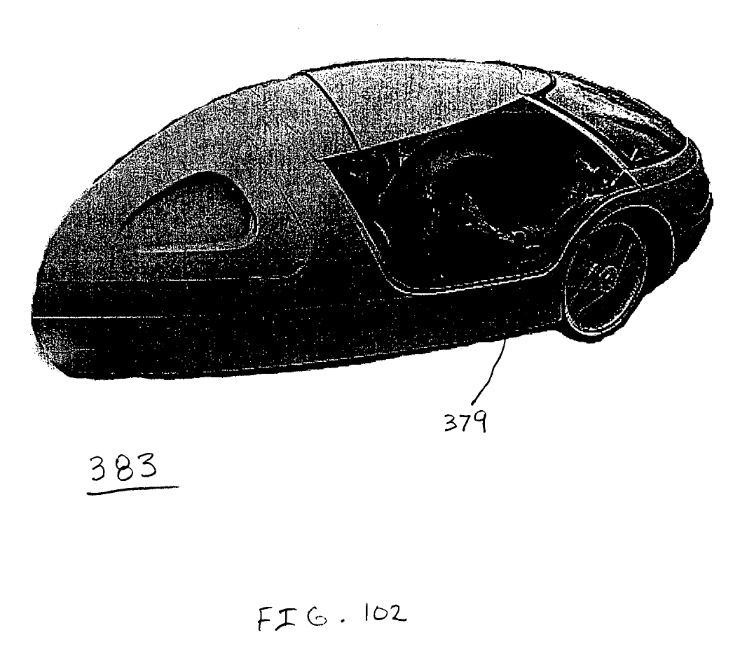

FIG. 102 depicts a three-wheel vehicle assembly 383 which utilizes transmission assembly 379 of similar form to the transmission assembly disclosed in FIG. 56. The three-wheel vehicle assembly has two power sources that are used individually or in combination together as represented in the chart of FIG. 88.

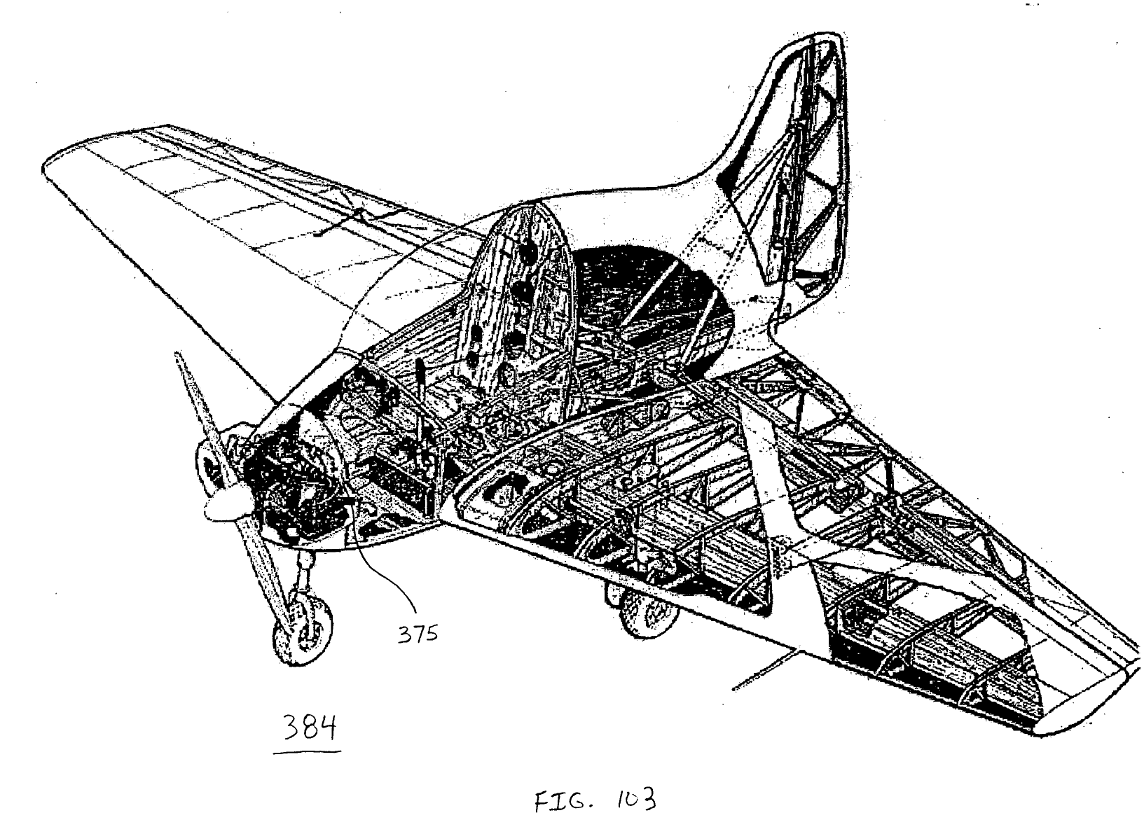

FIG. 103 depicts an air vehicle assembly 384 which utilizes transmission assembly 375 of similar form to the transmission assembly of FIG. 56. The air vehicle assembly has two power sources that are used individually or in combination together as represented in the chart of FIG. 88.

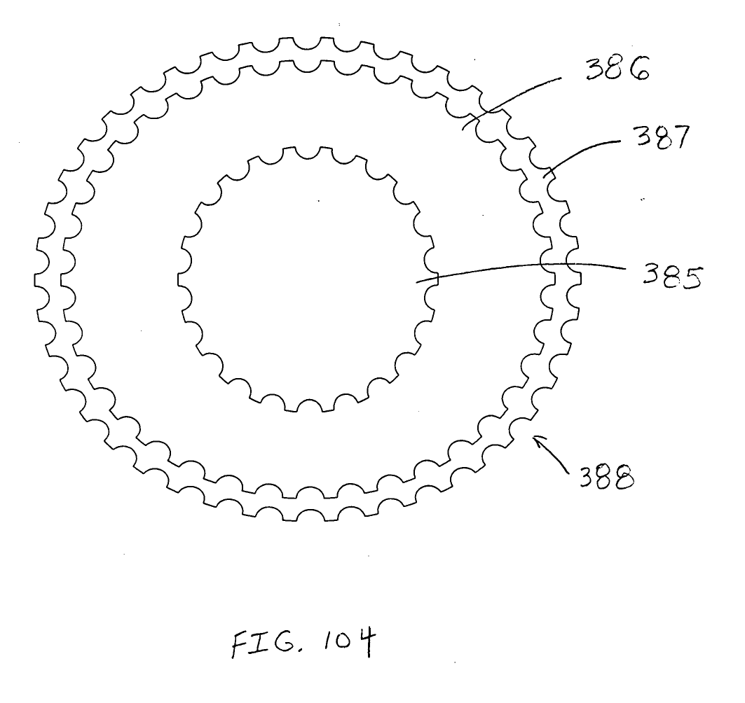

In FIG. 104, elliptical transmission carrier 388 has an elliptical element 387, elliptical element 386, and circular element 385. The elliptical carrier elements have outer diameter profile shapes similar to the transmission carrier 52 of FIG. 2 to engage an endless loop element.

While the invention has been described in relation to preferred embodiments of the invention, it will be appreciated that other embodiments, adaptations and modifications of the invention will be apparent to those skilled in the art.

What is claimed is:

1. A transmission system comprising at least a pair of oppositely oriented drive and driven transmission carriers, each transmission carrier having mounted thereon ratioed drive and driven elements and wherein the carriers' central axes are essentially parallel, an endless drive transfer loop coupling said drive elements on said drive transmission carrier to the driven elements on said driven transmission carrier, a shifter for shifting said endless loop laterally relatively to said transmission carriers so as to provide different drive ratios between said drive elements and said driven elements such that there is a range of progressively increasing or decreasing transmission ratios.

2. The invention defined in claim 1 wherein said drive transmission carrier is constructed as one piece.

3. The invention defined in claim 1 wherein said driven transmission carrier is constructed as one piece.

4. The invention defined in claim 1 wherein said drive transmission carrier is constructed as a multiple piece assembly.

5. The invention defined in claim 1 wherein said driven transmission carrier is constructed as a multiple piece assembly.

6. The invention defined in claim 1 wherein said drive transmission carrier comprises a plurality of fixably mounted drive elements.

7. The invention defined in claim 1 wherein said driven transmission carrier comprises a plurality of fixably mounted driven elements.

8. The invention defined in claim 1 wherein said fixably mounted elements of said drive carrier and said driven carrier have modified gear profiles.

9. The invention defined in claim 1 wherein said fixably mounted elements of said drive carrier have no spacing between the elements.

10. The invention defined in claim 1 wherein said fixably mounted elements of said driven carrier have no spacing between the elements.

11. The invention defined in claim 1 wherein said fixably mounted elements of said drive carrier are spaced unequally apart.

12. The invention defined in claim 1 wherein said fixably mounted elements of said driven carrier are spaced unequally apart.

13. The invention defined in claim 1 wherein said drive carrier is movable along the central drive carrier axis.

14. The invention defined in claim 1 wherein said driven carrier is movable along the central driven carrier axis.

15. The invention defined in claim 1 wherein said fixably mounted elements of said drive carrier and said driven carrier are dissimilar in shape.

16. The invention defined in claim 1 wherein said drive carrier and said driven carrier comprise an equal quantity of fixably mounted drive elements.

17. The invention defined in claim 1 wherein said drive carrier and said driven carrier comprise an unequal quantity of fixably mounted drive elements.

18. The invention defined in claim 1 wherein said drive carrier and said driven carrier each have a generally conical envelope along each carriers' central axis.

19. The invention defined in claim 1 wherein said drive or driven transmission carrier ratios are selected individually or by crossing over groups of elements.

20. The invention defined in claim 1 wherein a crossing over of a plurality of either drive or driven element ratios provides a rapid increase or decrease in transmission ratios.

21. The driven transmission carrier defined in claim 1 wherein driven element ratios are less than, equal to, or greater than the corresponding drive element ratios.

22. The transmission system defined in claim 1 wherein at least one of said drive or driven transmission carriers comprise two or more elements having progressively increasing or decreasing diameters.

23. The transmission system of claim 1 incorporated into devices including material transfer systems, power transfer systems, energy storage systems, and vehicle drive systems.

24. The transmission system of claim 1 incorporated within a vehicle frame.

25. The transmission system of claim 1 attachable externally to a vehicle frame.

26. The transmission system of claim 1 mounted in a wheel assembly.

27. The transmission system of claim 1 wherein said shifter is selected from guide rollers, tension devices, index guides, a magnetic force, mechanical pins, mechanical screws, cam actuator, electrical actuators, hydraulic actuators, pneumatic actuators, and stepping motors.

28. The transmission system of claim 1 wherein said endless loop is comprised of linkages of chain.

29. The transmission system of claim 1 wherein said drive and driven elements have predetermined profiles and said endless loop comprised of said linkages of chain and wherein said linkages of chain are adapted to fit and engage the profiles of said drive and said driven elements, respectively.

30. A stepped gear cluster comprising a generally conical member having a hub, inner and outer lateral faces, said outer face having formed thereon a first and last gear ring and a plurality of gear rings therebetween, there being no space between each succeeding gear ring.

31. The stepped gear cluster defined in claim 30 wherein said generally conical member is constructed as one piece.

32. The stepped gear cluster defined in claim 30 wherein said generally conical member is a multiple piece assembly.

33. A transmission carrier comprising a conical member having a mounting hub, inner and outer lateral faces, said outer lateral face having formed thereon a first and last gear ring and a plurality of gear rings therebetween, there being no space between each succeeding gear ring.

34. The transmission carrier defined in claim 33 wherein said conical member is constructed as one piece.

35. The transmission carrier defined in claim 33 wherein said conical member is a multiple piece assembly.

36. A compact transmission device comprising:
(a) a drive carrier comprising a plurality of fixably coaxially mounted drive elements, said drive carrier having a generally conical envelope extending along the central axis;
(b) a driven carrier comprising a plurality of fixably coaxially mounted driven elements, said driven carrier having a generally conical envelope along the central axis;
(c) said driven carrier having a rotational axis positioned essentially parallel to said drive carrier rotational axis;
(d) said driven carrier having said rotational axis within a distance of two times the sum of the radii of the largest said drive and driven elements from said drive central axis,
(e) an endless connecting element rotatably coupling said drive element to said driven element; and
(f) means to shift said endless connecting element relatively laterally so as to effect a change in the rotational ratio between said drive carrier and said driven carrier.

37. A lightweight transmission system comprising:
a pair of transmission carriers defined in claim 33,
an input drive shaft, means mounting one of said pair of transmission carriers on said input drive shaft,
an output driven shaft and means mounting a second one of said pair of transmission carriers on said output driven shaft,
a flexible drive coupling loop engaging in driving relationship with said pair of transmission carriers, and
means to shift said flexible drive coupling loop so as to effect a change in the drive ratios between said input drive shaft and said output driven shaft.

38. A transmission method comprising:
providing a pair of oppositely oriented drive and driven transmission gear clusters, each transmission gear cluster having mounted thereon ratioed drive and driven gear elements and wherein the gear clusters' central axes are essentially parallel, an endless drive transfer chain coupling said drive elements on said drive transmission gear cluster to the driven elements on said driven transmission gear cluster, and
sequentially shifting said endless drive transfer chain relatively laterally of said transmission gear clusters so as to provide different drive ratios between said drive gear elements and said driven gear elements such that changes in said transmission ratios are substantially uniform.

39. A vehicle transmission system for vehicles shiftable between motive powers comprising:
a pair of transmission carriers,
an input drive shaft, a torque reducer mechanism connected to said input drive shaft, means mounting one of said pair of transmission carriers on said input drive shaft,
an output driven shaft and means mounting a second one of said pair of transmission carriers on said output driven shaft,
a flexible drive coupling loop engaging in driving relationship with said pair of transmission carriers, and
means to shift said flexible drive coupling loop so as to effect a change in the drive ratios between said input drive shaft and said output driven shaft, said torque reducer mechanism balancing rotational input speed to said transmission carriers when switching between motive power.

40. A vehicle transmission system for vehicles shiftable between motive powers as claimed in claim 39 wherein said torque reducer mechanism is a planetary gearing set.

41. A vehicle transmission system for vehicles shiftable between motive powers comprising:
a pair of transmission carriers,
an input drive shaft, a rotational velocity control mechanism connected to said input drive shaft, means mounting one of said pair of transmission carriers on said input drive shaft,
an output driven shaft and means mounting a second one of said pair of transmission carriers on said output driven shaft,
a flexible drive coupling loop engaging in driving relationship with said pair of transmission carriers, and
means to shift said flexible drive coupling loop so as to effect a change in the drive ratios between said input drive shaft and said output driven shaft, said rotational velocity control mechanism balancing rotational input speed to said transmission carriers when switching between motive power.

42. A transmission method comprising:
providing a pair of oppositely oriented drive and driven transmission gear clusters, each transmission gear cluster having mounted thereon ratioed drive and driven gear elements and wherein the gear clusters' central axes are essentially parallel,
an endless drive transfer chain coupling said drive elements on said drive transmission gear cluster to said driven elements on said driven transmission gear cluster,
a pin carrier shift mechanism for shifting of said flexible drive coupling loop so as to effect a change in the drive ratios between said drive gear elements and said driven gear elements, and
sequentially shifting said endless drive transfer chain relatively laterally of said transmission gear clusters so as to provide different drive ratios between said drive gear elements and said driven gear elements such that changes in said transmission ratios are substantially uniform.

43. A transmission method comprising:
providing a pair of oppositely oriented drive and driven transmission gear clusters, each transmission gear cluster having mounted thereon ratioed drive and driven gear elements and wherein the gear clusters' central axes are essentially parallel,
at least one of transmission clusters having a laterally moveable section of said drive transmission gear cluster and driven transmission gear cluster,
an endless drive transfer chain coupling said drive elements on said drive transmission gear cluster to the driven elements on said driven transmission gear cluster, and
moving said moveable section to sequentially shift said endless drive transfer chain relatively laterally of said transmission gear clusters so as to provide different drive ratios between said drive gear elements and said driven gear elements such that changes in said transmission ratios are substantially uniform.

44. A transmission method comprising:
providing a pair of oppositely oriented drive and driven transmission gear clusters, each transmission gear cluster having mounted thereon ratioed drive and driven gear elements and wherein the gear clusters' central axes are essentially parallel,
providing an endless drive transfer chain coupling said drive elements on said drive transmission gear cluster to the driven elements on said driven transmission gear cluster,
providing an endless drive transfer chain coupling control device, and
sequentially shifting said endless drive transfer chain relatively laterally of said transmission gear clusters so as to provide different drive ratios between said drive gear elements and said driven gear elements such that changes in said transmission ratios are substantially uniform.

45. A transmission system for a vehicle comprising, oppositely oriented drive and driven transmission carriers, each transmission carrier having mounted thereon ratioed drive and ratioed driven elements, respectively, and wherein said carriers have central rotary axes which are essentially parallel, an endless drive transfer chain coupling said drive elements on said drive transmission carrier to the driven elements on said driven transmission carrier, a shifter mechanism for sequentially shifting said endless drive transfer chain laterally relatively to said transmission carriers so as to provide different drive ratios between said drive elements and said driven elements such that the gear ratio range is progressively increasing or decreasing transmission ratios.

46. The transmission system defined in claim 45 wherein said shifter mechanism includes means for axially shifting at least one of said transmission carriers.

47. The transmission system defined in claim 45 wherein said shifter mechanism includes a plurality of shift pins movably mounted on at least one of said transmission carriers and means for selectively moving at least one said pins to engage and initiate movement of said drive transfer chain to a next succeeding drive ratio.

48. The transmission system defined in claim 45 wherein said shifter mechanism includes a moveable chain guide interposed between said drive and driven transmission carriers.

49. The transmission system defined in claim 45 wherein said shifter mechanism includes means for axially shifting at least one of said transmission carriers and a plurality of shift pins movably mounted on at least one of said transmission carriers and means for selectively moving at least one said pins to engage and initiate movement of said drive transfer chain to a next succeeding drive ratio.

50. The transmission system defined in claim 45 wherein said shifter mechanism includes means for axially moving at least one of said transmission carriers and a moveable chain guide interposed between said drive and driven transmission carriers.

51. The transmission system defined in claim 45 wherein said shifter mechanism includes means for axially moving at least one of said transmission carriers, a plurality of shift pins movably mounted on at least one of said transmission carriers and means for selectively moving said at least one transmission carrier in conjunction with at least one of said pins to engage and initiate movement of said drive transfer chain to a next succeeding drive ratio.

52. The transmission system defined in claim 51 wherein said shifter mechanism includes a moveable chain guide interposed between said drive and driven transmission carriers.

53. A transmission method comprising:
providing a pair of oppositely oriented drive and driven transmission gear clusters, each transmission gear cluster having mounted thereon ratioed drive and driven gear elements and wherein the gear clusters' central axes are essentially parallel, and an endless drive transfer chain coupling said drive elements on said drive transmission gear cluster to the driven elements on said driven transmission gear cluster, and shifting said endless drive transfer chain relatively laterally of said transmission gear clusters so as to provide different drive ratios between said drive gear elements and said driven gear elements such that changes in said transmission ratios are timed to synchronize with the frequency of the gear cluster rotation.
